(19) United States
(12) Patent Application Publication
(10) Pub. No.: US 2023/0039870 A1
(43) Pub. Date: Feb. 9, 2023

(54) LIGHT GUIDE AND VIRTUAL IMAGE DISPLAY DEVICE

(71) Applicants: Susumu MOMMA, Kanagawa (JP); Naoki NAKAMURA, Saitama (JP); Masahiro ITOH, Kanagawa (JP); Yoshifumi SUDOH, Kanagawa (JP); Shigenobu HIRANO, Kanagawa (JP); Yasuo KATANO, Kanagawa (JP)

(72) Inventors: Susumu MOMMA, Kanagawa (JP); Naoki NAKAMURA, Saitama (JP); Masahiro ITOH, Kanagawa (JP); Yoshifumi SUDOH, Kanagawa (JP); Shigenobu HIRANO, Kanagawa (JP); Yasuo KATANO, Kanagawa (JP)

(21) Appl. No.: 17/876,543

(22) Filed: Jul. 29, 2022

(30) Foreign Application Priority Data
Jul. 30, 2021 (JP) 2021-125858
Jun. 24, 2022 (JP) 2022-101468

(51) Int. Cl. G02B 6/42; G02B 27/01

(52) U.S. Cl. CPC G02B 6/4214; G02B 6/42; G02B 27/0172; G02B 2027/0118; G02B 2027/0178

(57) ABSTRACT

A light guide includes: a light guide board configured to allow light incident on an optical entrance to propagate through the light guide board, the light guide board including: the optical entrance; a first face; and at least one partial reflection layer within the light guide board and tilted to the first face. The at least one partial reflection layer is configured to reflect a part of light incident on the at least one partial reflection layer at an incident angle of greater than or equal to a critical angle θᵣ to allow the reflected light to exit the light guide board through the first surface while transmitting therethrough a remainder of the light incident on the at least one partial reflection layer. Formula below is satisfied: θᵣ=sin⁻¹(n₂/n₁) where θᵣ is the critical angle; n₁ is a refractive index of the light guide board; and n₂ is a refractive index of the at least one partial reflection layer.

### CROSS-REFERENCE TO RELATED APPLICATIONS

This patent application is based on and claims priority pursuant to 35 U.S.C. § 119(a) to Japanese Patent Application No. 2021-125858, filed on Jul. 30, 2021 and Japanese Patent Application No. 2022-101468, filed on Jun. 24, 2022, in the Japan Patent Office, the entire disclosure of which is hereby incorporated by reference herein.

### BACKGROUND

### Technical Field

Embodiments of the present disclosure relate to a light guide and a virtual image display device.

### Related Art

Virtual image display devices have been developed to enlarge images displayed on image displays and display enlarged images for users' observation.

A virtual image display device, for example, allows light (i.e., image light, or light containing image information) from an image display element to enter a light guide and guides the light through the light guide, emitting the guided light containing image information toward an observer, or a user. This allows the observer to observer an enlarged virtual image formed with the emitted light.

### SUMMARY

An embodiment provides a light guide includes: a light guide board configured to allow light incident on an optical entrance to propagate through the light guide board, the light guide board including: the optical entrance; a first face; and at least one partial reflection layer within the light guide board and tilted to the first face. The at least one partial reflection layer is configured to reflect a part of light incident on the at least one partial reflection layer at an incident angle of greater than or equal to a critical angle θᵣ to allow the reflected light to exit the light guide board through the first surface, while transmitting therethrough a remainder of the light incident on the at least one partial reflection layer. Formula below is satisfied:

θᵣ=sin⁻¹(n₂/n₁)

where

θᵣ is the critical angle;

n₁ is a refractive index of the light guide board; and

n₂ is a refractive index of the at least one partial reflection layer.

Another embodiment provides a virtual image display device includes the above-described light guide; an image display element configured to display an image; and an optical system configured to propagate light containing information on the image from the image display element to the light guide.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of the configuration of a head-mounted display (HMD) as an example of a virtual image display device according to an embodiment of the present disclosure;

FIG. 2A is an illustration of a HMD a user is wearing, according to an embodiment of the present disclosure;

FIG. 2B is a schematic diagram of a head-mounted display worn by a user according to another embodiment of the present disclosure;

FIG. 2C is an illustration of a HMD a user is wearing, according to still another embodiment of the present disclosure;

FIG. 3 is an illustration of the configuration of a light guide according to a first embodiment;

FIG. 4 is another illustration of the configuration of the light guide according to the first embodiment;

FIG. 5 is a schematic view of the light guide according to the first embodiment;

FIG. 6 is a graph of the relation between the reflectance for each angle of view and the thickness of the partial reflection layer, to describe the light guiding according to the first embodiment;

FIG. 7 is a graph of a luminance distribution within an eye box, used to describe the light guiding according to the first embodiment;

FIG. 8 is an illustration of luminance images at the positions within the eye box, used to describe the light guiding according to the first embodiment;

FIG. 9 is an illustration for describing a method of setting the thickness of each partial reflection layer, according to the first embodiment;

FIG. 10 is another illustration for describing a method of setting the thickness of each partial reflection layer, according to the first embodiment;

FIG. 11 is still another illustration for describing a method of setting the thickness of each partial reflection layer, according to the first embodiment;

FIG. 12A is a graph of the relation between reflectance for each angle of view and the thickness of the partial reflection layer, according to Comparative Example 1;

FIG. 12B is another graph of the relation between reflectance for each angle of view and the thickness of the partial reflection layer, according to Comparative Example 1;

FIG. 12C is still another graph of the relation between reflectance for each angle of view and the thickness of the partial reflection layer, according to Comparative Example 1;

FIG. 13 is yet another graph of the relation between reflectance for each angle of view and the thickness of the partial reflection layer, according to Comparative Example 1;

FIG. 14 is a graph of the relation between incident angle on a partial reflection layer and reflectance of the partial reflection layer, according to Comparative Example 1;

FIG. 15A is a graph of the thickness of each partial reflection layer according to Comparative Example 1;

FIG. 15B is another graph of the thickness of each partial reflection layer according to Comparative Example 1;

FIG. 16A is a diagram of a luminance distribution within an eye box according to Comparative Example 1;

FIG. 16B is another diagram of a luminance distribution within the eye box according to Comparative Example 1;

FIG. 17A is an illustration of luminance images of the respective positions within an eye box according to Comparative Example 1;

FIG. 17B is another illustration of luminance images of the respective positions within the eye box according to Comparative Example 1;

FIG. 18A is a graph of the relation between reflectance for each angle of view and the thickness of the partial reflection layer, according to the first embodiment;

FIG. 18B is another graph of the relation between reflectance for each angle of view and the thickness of the partial reflection layer, according to the first embodiment;

FIG. 18C is still another graph of the relation between reflectance for each angle of view and the thickness of the partial reflection layer, according to the first embodiment;

FIG. 19 is a graph of the relation between reflectance for each angle of view and the thickness of the partial reflection layer, according to the first embodiment;

FIG. 20 is a graph of the relation between incident angle on a partial reflection layer and reflectance of the partial reflection layer, according to the first embodiment;

FIG. 21A is a graph of the thickness of each partial reflection layer first embodiment;

FIG. 21B is another graph of the thickness of each partial reflection layer first embodiment;

FIG. 22A is a diagram of a luminance distribution within an eye box according to the first embodiment;

FIG. 22B is another diagram of a luminance distribution within the eye box according to the first embodiment;

FIG. 23A is an illustration of luminance images of the respective positions within an eye box according to the first embodiment;

FIG. 23B is another illustration of luminance images of the respective positions within the eye box according to the first embodiment;

FIG. 24A is a graph of the relation between reflectance for each angle of view and the thickness of the partial reflection layer, according to a second embodiment;

FIG. 24B is another graph of the relation between reflectance for each angle of view and the thickness of the partial reflection layer, according to the second embodiment;

FIG. 24C is still another graph of the relation between reflectance for each angle of view and the thickness of the partial reflection layer, according to the second embodiment;

FIG. 25 is a graph of the relation between reflectance for each angle of view and the thickness of the partial reflection layer, according to the second embodiment;

FIG. 26 is a graph of the relation between incident angle on a partial reflection layer and reflectance of the partial reflection layer, according to the second embodiment;

FIG. 27A is a graph of the thickness of each partial reflection layer according to the second embodiment;

FIG. 27B is another graph of the thickness of each partial reflection layer according to the second embodiment;

FIG. 28A is a diagram of a luminance distribution within an eye box according to the second embodiment;

FIG. 28B is another diagram of a luminance distribution within the eye box according to the second embodiment;

FIG. 29A is an illustration of luminance images of the respective positions within the eye box according to the second embodiment;

FIG. 29B is another illustration of luminance images of the respective positions within the eye box according to the second embodiment;

FIG. 30A is a graph of the relation between reflectance for each angle of view and the thickness of the partial reflection layer, according to a third embodiment;

FIG. 30B is another graph of the relation between reflectance for each angle of view and the thickness of the partial reflection layer, according to the third embodiment;

FIG. 30C is still another graph of the relation between reflectance for each angle of view and the thickness of the partial reflection layer, according to the third embodiment;

FIG. 31 is a graph of the relation between reflectance for each angle of view and the thickness of the partial reflection layer, according to the third embodiment;

FIG. 32 is a graph of the relation between incident angle on a partial reflection layer and reflectance of the partial reflection layer, according to the third embodiment;

FIG. 33A is a graph of the thickness of each partial reflection layer according to the third embodiment;

FIG. 33B is another graph of the thickness of each partial reflection layer according to the third embodiment;

FIG. 34A is a diagram of a luminance distribution within an eye box according to the third embodiment;

FIG. 34B is another diagram of a luminance distribution within the eye box according to the third embodiment;

FIG. 35A is an illustration of luminance images of the respective positions within an eye box according to the third embodiment;

FIG. 35B is another illustration of luminance images of the respective positions within the eye box according to the third embodiment;

FIG. 36A is a diagram of a luminance distribution within the eye box according to the third embodiment;

FIG. 36B is another diagram of a luminance distribution within the eye box according to the third embodiment;

FIG. 37A is an illustration of luminance images of the respective positions within the eye box according to the third embodiment;

FIG. 37B is another illustration of luminance images of the respective positions within the eye box according to the third embodiment;

FIG. 38A is a graph of the moving average of the thickness of the partial reflection layer according to Comparative Example 1;

FIG. 38B is a graph of the moving average of the thickness of the partial reflection layer according to the first embodiment;

FIG. 38C is a graph of the moving average of the thickness of the partial reflection layer according to the second embodiment;

FIG. 38D is a graph of the moving average of the thickness of the partial reflection layer according to the third embodiment;

FIG. 39 is a graph of the relation between reflectance for each angle of view and the thickness of the partial reflection layer, according to a fourth embodiment;

FIG. 40 is an enlarged view of a light guide including an adhesive layer;

FIG. 41 is a collection of graphs of the relation between the refractive index of an adhesive layer and the reflectance of light having each angle of view at the interface between the light guide board and the adhesive layer;

FIG. 42 is an illustration of the light rays having the angles of view converging at a position of 11.7 mm in the eye box, according to a fifth embodiment.

FIG. 43 is a graph of the relation between reflectance for each angle of view and the thickness of the partial reflection layer, according to the fifth embodiment;

FIG. 44 is an illustration of the light rays having the angles of view converging at a position of 11.7 mm in the eye box, according to a reference embodiment.

FIG. 45 is a graph of the relation between reflectance for each angle of view and the thickness of the partial reflection layer, according to a reference embodiment;

FIG. 46 is an illustration of the configuration of the light guide according to a modification of the first embodiment;

FIG. 47 is an illustration of the configuration of the light guide according to a modification of the second embodiment;

FIG. 48 is an illustration of the light guide according to the first embodiment;

FIG. 49 is another illustration of the light guide according to the first embodiment;

FIG. 50A is an illustration of the light guide according to the sixth embodiment;

FIG. 50B is another illustration of the light guide according to the sixth embodiment;

FIG. 50C is an illustration of a reflecting surface of the light guide according to the sixth embodiment;

FIG. 51 is a graph of the thickness of each partial reflection layer according to the sixth embodiment;

FIG. 52 is another graph of the thickness of each partial reflection layer according to the sixth embodiment;

FIG. 53 is a ray tracing diagram of light rays having a vertical angle of view of +10.12° incident on the reflecting surface, according to the sixth embodiment;

FIG. 54 is a ray tracing diagram of light rays having a vertical angle of view of 0° incident on the reflecting surface, according to the sixth embodiment;

FIG. 55 is a ray tracing diagram of light rays having a vertical angle of view of −10.12° incident on the reflecting surface, according to the sixth embodiment;

FIG. 56 is a graph of the relation between incident angle on a partial reflection layer and reflectance of the partial reflection layer, according to the sixth embodiment;

FIG. 57 is an illustration of the behavior of light rays incident on a partial reflection layer, for the horizontal angle of view of −17.6°, according to the sixth embodiment;

FIG. 58 is an illustration of the behavior of light rays incident on a partial reflection layer, for the horizontal angle of view of 0°, according to the sixth embodiment;

FIG. 59 is an illustration of the behavior of light rays incident on a partial reflection layer, for the horizontal angle of view of +17.6°, according to the sixth embodiment;

FIG. 60 is another graph of the relation between incident angle on a partial reflection layer and reflectance of the partial reflection layer, according to the sixth embodiment;

FIG. 61A is an illustration of the light guide according to the seventh embodiment;

FIG. 61B is an illustration of the light guide according to the seventh embodiment;

FIG. 62 is an illustration for describing a method of manufacturing the light guide according to the seventh embodiment;

FIG. 63 is another illustration for describing a method of manufacturing the light guide according to the seventh embodiment;

FIG. 64 is a graph in which the average values of radiances at the positions in a virtual image at each eye-box position are plotted for each wavelength, according to the third embodiment;

FIG. 65 is a graph of an average luminance distribution obtained by correcting the luminance distribution in FIG. 64;

FIG. 66 is an illustration of a light guide according to an eighth embodiment;

FIG. 67 is a graph of the relation between reflectance for each angle of view and the thickness of the partial reflection layer, according to the eighth embodiment;

FIG. 68A is a graph of a luminance distribution within the eye box according to the eighth embodiment;

FIG. 68B is another graph of a luminance distribution within the eye box according to the eighth embodiment;

FIG. 68C is still another graph of a luminance distribution within the eye box according to the eighth embodiment;

FIG. 69 is a graph in which the average values of radiances at the positions in a virtual image at each eye-box position are plotted for each wavelength, according to the eighth embodiment;

FIG. 70 is a graph of an average luminance distribution obtained by correcting the luminance distribution in FIG. 69;

FIG. 71 is a diagram of correction coefficients according to the eighth embodiment;

FIG. 72 is a collection of diagrams of a luminance distribution after correction with the correction coefficients in FIG. 71;

FIG. 73 is an illustration of a light guide board according to a ninth embodiment;

FIG. 74 is an illustration of the vicinity of an optical entrance of the light guide board in FIG. 73;

FIG. 75 is a graph of the thickness of each partial reflection layer according to the ninth embodiment;

FIG. 76 is another graph of the thickness of each partial reflection layer according to the ninth embodiment;

FIG. 77A is a graph of an illuminance distribution within the eye box according to the ninth embodiment;

FIG. 77B is another graph of an illuminance distribution within the eye box according to the ninth embodiment;

FIG. 77C is still another graph of an illuminance distribution within the eye box according to the ninth embodiment;

FIG. 78 is a graph in which the average values of illuminance at the positions in a virtual image at each eye-box position are plotted for each wavelength, according to the ninth embodiment;

FIG. 79 is a graph of an average illuminance distribution obtained by correcting the illuminance distribution in FIG. 78;

FIG. 80 is a diagram of correction coefficients according to the ninth embodiment;

FIG. 81 is a collection of diagrams of an illuminance distribution after correction with the correction coefficients in FIG. 80;

FIG. 82A is a graph of the relation between incident angle on a partial reflection layer and reflectance of the partial reflection layer, according to an embodiment;

FIG. 82B is a graph of the relation between incident angle on a partial reflection layer and reflectance of the partial reflection layer, according to an embodiment;

FIG. 83A is a diagram of a cases in which light rays corresponding to angles of view in the positive direction reflect off the reflecting surface twice and thus change their propagation angles for propagating through the light guide board;

FIG. 83B is another diagram of a cases in which light rays corresponding to angles of view in the positive direction reflect off the reflecting surface twice and thus change their propagation angles for propagating through the light guide board;

FIG. 84A is another diagram of a cases in which light rays corresponding to angles of view in the negative direction reflect off the reflecting surface twice and thus change their propagation angles for propagating through the light guide board;

FIG. 84B is another diagram of a cases in which light rays corresponding to angles of view in the negative direction reflect off the reflecting surface twice and thus change their propagation angles for propagating through the light guide board;

FIG. 85 is a graph of the relation between the angle of view of the image light and the angle of view of flare light resulting from twice-reflection on the reflecting surface;

FIG. 86 is an illustration for describing how to reduce the effects of flare light on image quality.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. As used herein, the singular forms “a,” “an,” and “the” are intended to include the plural forms as well, unless the context clearly indicates otherwise.

With an increase in the luminance of an image display element, for example, a virtual image display device achieves a higher luminance of a virtual image to be observed by an observer. However, such an increase in luminance consumes a lot of power. Desired luminances of virtual images may be increased or maintained to increase the light use efficiency of the light guide instead.

At least one embodiment of the present disclosure achieves a higher light use efficiency of a light guide and a virtual image display device incorporating the light guide.

Hereinafter, a light guide member and a virtual image display device according to an embodiment of the invention will be described with reference to the drawings. In the following description, common or corresponding elements are denoted by the same or similar reference signs, and redundant description is appropriately simplified or omitted.

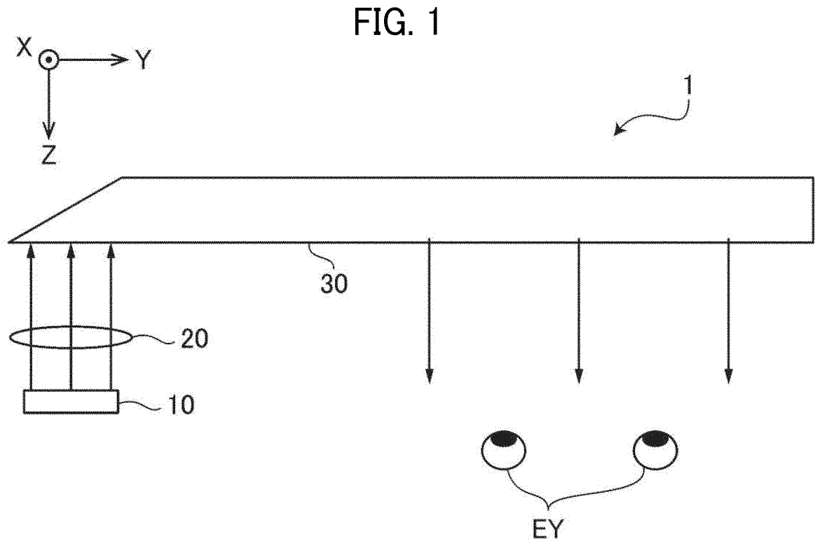

FIG. 1 is a diagram of the configuration of an HMD 1 as an example of a virtual image display device according to an embodiment of the present disclosure. As illustrated in FIG. 1, the HMD 1 includes an image display element 10, a propagation optical system 20, and a light guide 30. In FIG. 1, the eyes of a wearer wearing the HMD 1 is indicated by a symbol EY.

The image display element 10 displays an image to be recognized as a virtual image. Examples of the image display element 10 include an organic light emitting diode (OLED) array, a laser diode (LD) array, a light emitting diode (LED) array, micro electro mechanical systems (MEMS), and a digital micromirror device (DMD).

Light (i.e., light containing image information, or image light) emitted from each pixel of the image display element 10 enters the propagation optical system 20. The propagation optical system 20 propagates the image light from the image display element 10 to the light guide 30.

The light guide 30 guides the image light entered from the propagation optical system 20 and emits the image light to the outside of the light guide 30 toward the eye EY for displaying of a virtual image. The wearer can observe an enlarged virtual image formed with the image light emitted from the light guide 30.

In the following description, a first horizontal direction in which the image display element 10, the propagation optical system 20, and the light guide 30 are arranged is defined as a Z-direction, a second horizontal direction orthogonal to the Z-direction is defined as a Y-direction, and a vertical direction orthogonal to each of the Y-direction and the Z-direction is defined as an X-direction. The X-direction, the Y-direction, and the Z-direction orthogonal to each other form a right-handed system. The term “direction” is used for convenience to describe the relative position between the components, and does not indicate an absolute direction. Depending on the angle of the HMD 1, for example, the Z-direction may not be the horizontal direction and may be the vertical direction.

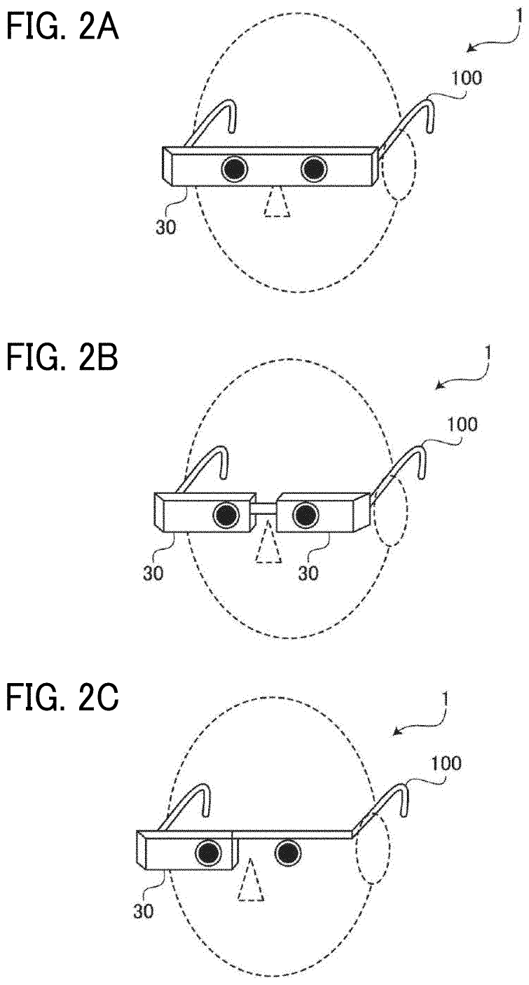

FIGS. 2A to 2C are diagrams of the HMD 1 worn by the user. The HMD 1 illustrated in FIGS. 2A to 2C may be referred to as smart glasses.

The HMD 1 illustrated in FIG. 2A is a binocular head-mounted display, and has a configuration in which a single light guide 30 having a length corresponding to the width of the face of the user is fixed to a frame 100. The light guide 30 forms an eye box in a region including both the left and right eyes. The image display element 10 and the propagation optical system 20 are built in, for example, temples of the frame 100. Instead of the frame 100 being fixed to each end of the light guide 30, the frame 100 may cover the upper edge or the lower edge of the light guide 30.

The HMD 1 in FIG. 2B is also a binocular head-mounted display having a pair of head-mounted displays corresponding to the left eye and the right eye, each of which is fixed to the frame 100. The light guide 30 corresponding to the right eye forms an eye box in a region including the right eye. The light guide 30 corresponding to the left eye forms an eye box in a region including the left eye.

The HMD 1 in FIG. 2C is a monocular head-mounted display with a single head-mounted display corresponding to the right eye, which is fixed to the frame 100. In another example, the monocular head-mounted display may have a single head-mounted display corresponding to the left eye, which is fixed to the frame 100.

The propagation optical system 30 according to an embodiment is not limited to an HMD, and is applicable in other virtual image display devices. Another virtual image display device is, for example, a head-up display (HUD).

### Embodiment 1

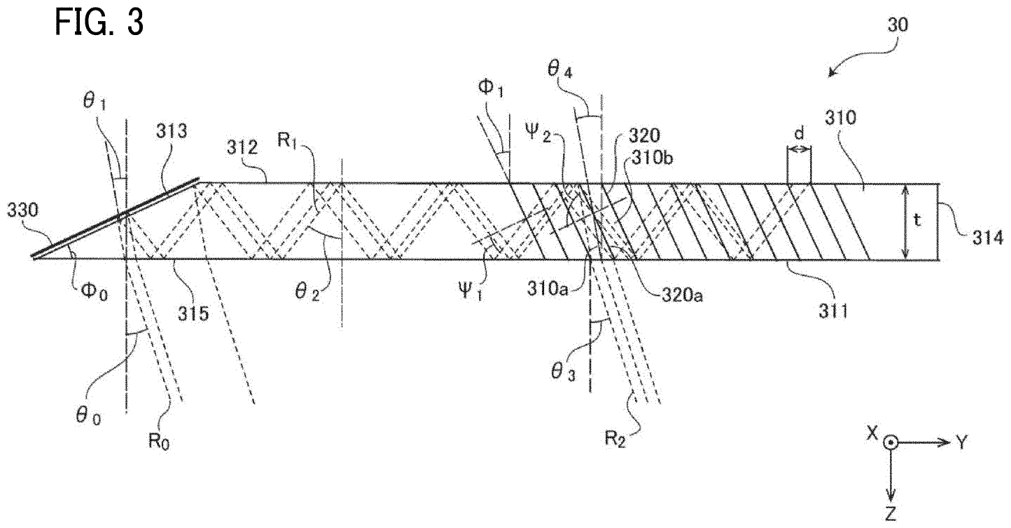

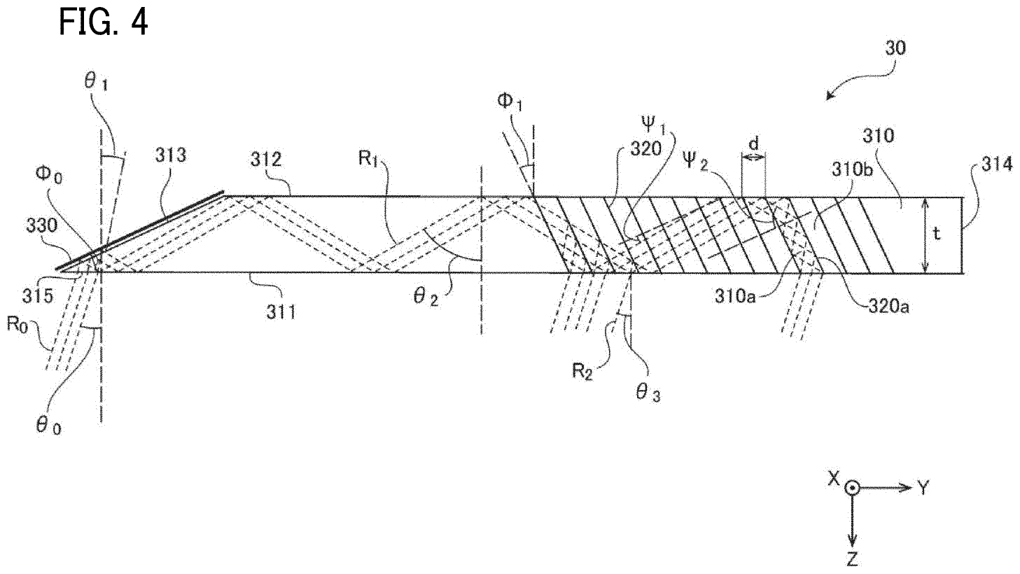

FIGS. 3 and 4 are illustrations of the light guide 30 according to Example 1. As illustrated in FIGS. 3 and 4, the light guide 30 includes a light guide board 310, a partial reflection layer 320, and an external mirror 330.

The light guide board 310 is composed of a high transparent material to allow the user to see through the light guide board 310, or the light guide 30. Further, the light guide board 310 is composed of synthetic resin such as plastic to enable a reduction in weight.

The light guide board 310 has a first surface 311 and a second surface 312 parallel to each other. The first surface 311 is a surface (i.e., a rear surface) closer to the wearer (the user) of the HMD 1 than the other surface (i.e., a front surface) when viewed from the wearer. The second surface 312 is a surface (i.e., the front surface) further from the wearer (the user) of the HMD 1 than the other surface (i.e., the rear surface) when viewed from the wearer. The distance t between the first surface 311 and the second surface 312 refers to the thickness of the light guide board 310.

The light guide board 310 has a first edge face 313 at the −Y-side of the light guide board 310 and a second edge face 314 at the +Y-side of the light guide board 310. The first edge face 313 connecting the first surface 311 and the second surface 312 at the −Y-side of the light guide board 310 is slanted with respect to the first surface 311 and the second surface 312. Specifically, the first edge face 313 and the first surface 311 form an angle Φ₀. The second edge face 314 connecting the first surface 311 and the second surface 312 at the +Y-side of the light guide board 310 is orthogonal to the first surface 311 and the second surface 312. In such a configuration, the light guide board 310 forms an asymmetrical trapezoidal shape in a plan view.

The −Y-side edge of the first surface 311 forms an optical entrance 315 that allows the image light from the propagation optical system 20 to enter the light guide 30.

FIG. 3 is an optical path diagram of light incident on the optical entrance 315 (the first surface 311) at a positive angle. FIG. 4 is an optical path diagram of light incident on the optical entrance 315 at a negative angle.

The image light, or a light beam R₀ incident from the propagation optical system 20 is incident on the optical entrance 315 (the first surface 311) at an incident angle θ₀. The light beam R₀ incident on the optical entrance 315 is refracted at an angle θ₁ and passes through the first edge face 313 to exit the light guide board 310.

The external mirror 330 is adjacent to the first edge face 313 and has a reflecting surface parallel to the first edge face 313. In other words, the external mirror 330 has a reflecting surface that forms an angle (o with the first surface 311. The reflecting surface of the external mirror 330 may have surface contact with the first edge face 313 to prevent the light beam R₀ from substantially exiting the light guide board 310.

The light beam R₀ transmitted through the first edge face 313 reflects off the external mirror 330 and passes through the first edge face 313 again to enter the light guide board 310. Among the light rays that have entered the light guide board 310 through the first edge face 313, a light ray R₁ satisfying the total reflection conditions is guided through the light guide board 310 in the +Y-direction while repeatedly totally reflecting off the first surface 311 and the second surface 312 at an incident angle θ₂. The incident angle θ₂ is greater than or equal to the critical angle at the first surface 311 and the second surface 312.

The partial reflection layer 320 is an optical thin film of a single layer inside the light guide board 310. The partial reflective layer 320 is tilted at an angle Φ₁ with respect to the normal to the first surface 311 (and the second surface 312) inside the light guide board 310. Notably, the partial reflection layer 320 is not limited to a single layer. The partial reflection layer 320 may be an optical thin film composed of multiple layers.

Multiple partial reflection layers 320 are disposed inside the light guide board 310. The multiple partial reflection layers 320 each are oriented in the same direction. In other words, the multiple partial reflection layers 320 are arranged in parallel to each other. The multiple partial reflection layers 320 are arranged side by side in the Y-direction at an interval d. In some examples, some of the partial reflection layers 320 may be disposed in a direction non-parallel to other partial reflection layers 320.

The light ray R₁ is incident on the partial reflection layer 320 at an incident angle Ψ₁ or an incident angle Ψ₂. The incident angle Ψ₂, which is larger than the incident angle Ψ₁, is equal to or larger than the critical angle θᵣ or close to the critical angle θᵣ (but smaller than the critical angle θᵣ) at the partial reflection layer 320. The critical angle θᵣ is derived by formula (1) below where n₁ is the refractive index of the light guide board 310, and n₂ is the refractive index of the partial reflection layer 320. In the present specification, unless otherwise specified, the refractive index refer to a refractive index for light having a wavelength of 550 nm.

θᵣ=sin⁻¹(n₂/n₁) (1)

Most of the light ray R₁ incident on the partial reflection layer 320 at a small incident angle Ψ₁ passes through the partial reflection layer 320. In contrast, a part of the light ray R₁ incident on the partial reflection layer 320 at the incident angle Ψ₂ greater than the critical angle θᵣ reflects off and the remainder of the light ray R₁ passes through the partial reflection layer 320. Specifically, a part of evanescent light entering the partial reflection layer 320 passes through the partial reflection layer 320.

As described above, the partial reflection layer 320 reflects a part of light incident on the partial reflection layer 320 at the incident angle Ψ₂ greater than or equal to the critical angle θᵣ to let the part of the light out of the partial reflection layer 320 through the first surface 311 while allowing the remainder of the incident light to pass through the partial reflection layer 320. Among the light rays incident on the partial reflection layer 320 at the incident angle Ψ₂ and reflected thereby, a light ray R₂ incident on the first surface 311 passes through the first surface 311 to exit the light guide board 310 at an exit angle θ₃. The exit angle θ₃ is equal to the incident angle θ₀ at which light is incident on the optical entrance 315 (the first surface 311).

The partial reflective layer 320 is a thin film to allow a part of light incident thereon at the incident angle Ψ₂ greater than of equal to the critical angle θᵣ to pass through the partial reflection layer 320. The partial reflection layer 320 is, for example, thinner than the center wavelength λ of light guided through the partial reflection layer 320.

For convenience, a partial reflection layer 320a is illustrated as one of the multiple partial reflection layers 320 in FIG. 3. Further, the light guide board 310 includes a portion 310a adjacent to the −Y-side of the partial reflection layer 320a and a portion 310b adjacent to the +Y-side of the partial reflection layer 320a. The partial reflection layer 320a composed of a thin film thinner than or equal to the center wavelength λ prevents a part of evanescent light entering the partial reflection layer 320a from being reflected back into the light guide board 310 (i.e., the portion 310a) and allows the evanescent light to pass through the partial reflection layer 320a to enter the portion 310b (or be extracted in the portion 310b). Thus, a part of evanescent light passes through the partial reflection layer 320 and further proceeds through the light guide board 310.

The amount of evanescent light extracted in the portion 310b depends on the distance between the portion 310a and the portion 310b (i.e., the thickness of the partial reflection layer 320a). Specifically, as the partial reflection layer 320a is thinner, more evanescent light is extracted in the portion 310b. In other words, with a decrease in the thickness of the partial reflection layer 320a, the transmissivity of light incident on the partial reflection layer 320a increases and the reflectivity of light incident on the partial reflection layer 320a decreases. In other words, as the thickness of the partial reflection layer 320a increases, the transmissivity of the light incident on the partial reflection layer 320a decreases and the reflectivity increases. Changing the thickness of the partial reflection layer 320a adjusts the reflectivity and transmissivity of light incident on the partial reflection layer 320a.

Further, as the incident angle Ψ₂, which is equal to or greater than the critical angle θᵣ, is smaller, the length of the evanescent light entering the partial reflection layer 320a increases. This causes more evanescent light to enter the portion 310b (to be extracted in the portion 310b). In other words, with a decrease in the incident angle Ψ₂, the transmissivity of light incident on the partial reflection layer 320a increases and the reflectivity of light incident on the partial reflection layer 320a decreases. With an increase in the incident angle Ψ₂, the transmissivity of light incident on the partial reflection layer 320a decreases and the reflectivity of light incident on the partial reflection layer 320a increases.

As will be described later, the incident angle Ψ₂ corresponding to an angle of view closer to −18° is smaller, and the incident angle Ψ₂ corresponding to an angle of view closer to +18° is larger. In such a configuration, light incident on the partial reflection layer 320a at the incident angle Ψ₂ corresponding to an angle of view closer to −18° has a lower reflectance, and light incident on the partial reflection layer 320a at the incident angle Ψ₂ corresponding to an angle of view closer to +18° has a higher reflectance.

Although the partial reflection layer 320a is described above as an example, the same applies to another partial reflection layer of the multiple partial reflection layers 320 (i.e., a part of evanescent light passes through another partial reflection layer for the same reason.

A case where the incident angle Ψ₂ is close to the critical angle θᵣ, but smaller than the critical angle θᵣ) will be described. With the incident angle Ψ₂ close to the critical angle θᵣ, the reflectance of the light incident on the partial reflective layer 320a at the incident angle Ψ₂ is large. To deal with this situation, for example, forming the partial reflection layer 320a to have the thickness less than or equal to the center wavelength λ can change or adjust the reflectivity and transmissivity of light incident on the partial reflection layer 320a in a wide range.

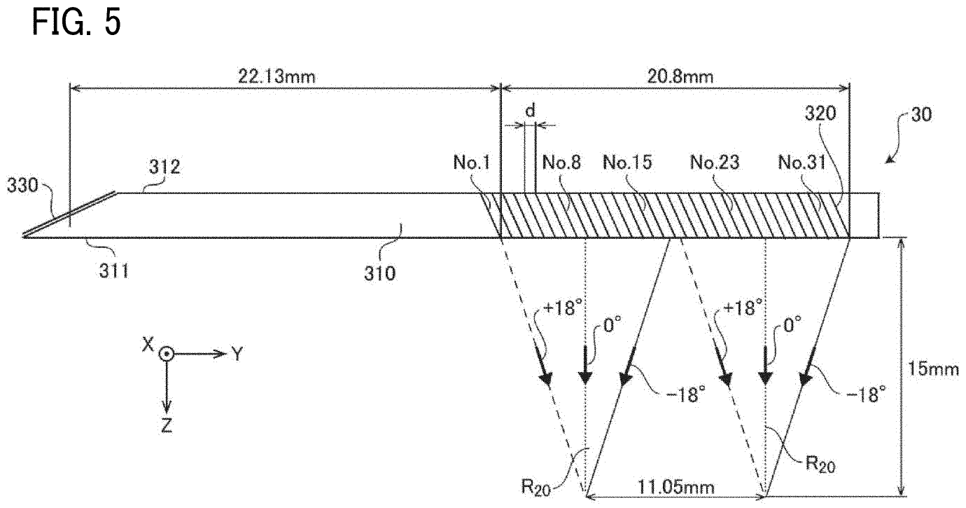

In other words, the light guide 30 is configured to allow an incident angle θc of light (light corresponding to a light ray R₂₀ in FIG. 5) incident on the partial reflection layer 320 (a light ray R₂₀ (a part) of the incident light is to reflect off the partial reflection layer 320 in a direction normal to the first surface 311) to be greater than or equal to the critical angle θᵣ and also allow the partial reflection layer 320 to have a thickness appropriate to achieve intended performance. This achieves a higher light use efficiency and thus allows a reflectance satisfying a desired angle range with reference to the center of angle of view (i.e., allows a desired brightness of image light reaching the eye box).

The reflectance of the light beam R₁ incident on the partial reflection layer 320 at a small incident angle Ψ₁ is small.

In this case, most of the light reflected by the partial reflection layer 320 after hitting the partial reflection layer 320 at the incident angle Ψ₁ is directed in the +Y-direction or proceeds in the reverse direction (i.e., the −Y-direction) to exit the light guide board 310 through, for example, the optical entrance 315. Such reflected light is not substantially observed as flare by the wearer (the user).

In the first embodiment, the light guide board 310 has a refraction index n₁ of 1.642 and a depth t of 2.5 mm. The angle (Do between the first surface 311 and each of the first edge face 313 and the external mirror 330 is 24.25°. The angle Φ₁ between the partial reflection layer 320 and the normal to the first surface 311 (and the second surface 312) is also 24.25°.

In FIG. 3, the refraction angle θ₁ is 10.85° when the incident angle θ₀ of the light beam R₀ incident on the first surface 311 is 18°. The critical angle at the first surface 311 and the second surface 312 is 37.52°. The light ray R₁ entered into the light guide board 310 through the first edge face 313 is incident on each of the first edge face 313 and the second surface 312 at an incident angle θ₂ of 37.65°, which is greater than the critical angle of 37.52°. In such a configuration, the light ray R₁ is guided through the light guide board 310 in the +Y-direction while repeatedly totally reflecting off each of the first surface 311 and the second surface 312 at the incident angle θ₂. The incident angle Ψ₁ of the light ray R₁ on the partial reflection layer 320 is 28.1°. The incident angle Ψ₂ of the light ray R₁ on the partial reflection layer 320 is 76.6°. The exit angle θ₃ of the light ray R₂ exiting the light guide board 310 through the first surface 311 is 18°, which is equal to the incident angle θ₀.

In FIG. 4, the refraction angle θ1 is −10.85° when the incident angle θ₀ of the light ray R₀ incident on the first surface 311 is −18°. The incident angle θ₂ is 59.35°, which is greater than the critical angle of 37.52°. In such a configuration, the light ray R₁ is guided through the light guide board 310 in the +Y-direction while repeatedly totally reflecting off each of the first surface 311 and the second surface 312 at the incident angle θ₂. The incident angle Ψ₂ of the light ray R₁ on the partial reflection layer 320 is 6.4°. The incident angle Ψ₂ of the light ray R₁ on the partial reflection layer 320 is 54.9°. The exit angle θ₃ of the light ray R₂ exiting the light guide board 310 through the first surface 311 is −18°, which is equal to the incident angle θ₀.

The light guide 30 features the following.

The light guide 30 includes the optical entrance 315, the light guide board 310, and at least one partial reflection layer 320. The light guide board 310 guides therethrough light incident on the optical entrance 315. At least one partial reflection layer 320 is tilted to the first surface 311 inside the light guide board 310.

The partial reflection layer 320 reflects a part of light incident on the partial reflection layer 320 at the incident angle greater than or equal to the critical angle θᵣ to let the part of the light out of the partial reflection layer 320 through the first surface 311 while allowing the remainder of the incident light to pass through the partial reflection layer 320. The critical angle θᵣ is derived by formula (1) below where n₁ is the refractive index of the light guide board 310, and n₂ is the refractive index of the partial reflection layer 320.

θᵣ=sin⁻¹(n₂/n₁) (1)

Such a light guide 30 enables light incident on the partial reflection layer 320 at an incident angle greater than or equal to the critical angle θᵣ to have a reflectivity appropriate to achieve the intended performance. This achieves a higher light use efficiency of the light guide 30 and a desired luminance of a virtual image (i.e., a desired brightness of the image light reaching the eye box). In some examples, the light guide 30 according to an embodiment allows light ray R₁, in which S-polarized light is mixed with P-polarized light, guided through the light guide board 310 to have a reflectance for each of the S-polarized light and the P-polarized light appropriate to achieve the intended performance. Using both the S-polarized light and the P-polarized light achieves a higher light use efficiency of the light guide.

A typical light guide includes a dielectric multilayer film corresponding to the partial reflection layer 320 of the present embodiment. In the typical light guide, the brightness of image light reaching the eyes of the wearer is obtained by setting an appropriate reflectance of light rays incident on the dielectric multilayer film. However, for example, a higher reflectance of light incident on the dielectric multilayer film at a greater incident angle increases flare. To handle the increase in flare, an appropriate reflectance of light incident on the dielectric multilayer film at a small incident angle is to be set while reducing the reflectance of light incident on the dielectric multilayer film at a large incident angle.

For example, a dielectric multilayer film of 25 to 30 layers each having a thickness of approximately 3 μm is used to obtain such characteristics. However, the film forming process becomes complicated, thus resulting in an increase in cost.

Further, the elastic energy of the dielectric multilayer film increases in proportion to the thickness (film thickness) of the dielectric multilayer film. With an increase in the elastic energy of the dielectric multilayer film, the increased elastic energy causes the light guide board including the dielectric multilayer film to easily deform, and the internal stress of the dielectric multilayer film causes the dielectric multilayer film to easily break. Such a deformation of the light guide board changes the reflection angle of light rays being guided through the light guide board, and thus causes flare and ghost or reduces the resolution. Further, if the dielectric multilayer film cracks, light scattering at the crack turns flare.

To avoid such inconvenience, an appropriate material is to be selected to reduce the difference in thermal expansion coefficient between the dielectric multilayer film and the light guide board. In other words, the materials of the dielectric multilayer film and the light guide board that can be used are greatly restricted.

In addition, MgF₂ or AlF₂, which is usually used in the dielectric multilayer film, is to be deposited on the light guide board at high temperatures of 200° C. or higher. For this reason, forming a film on a plastic material having a low glass transition temperature is difficult. Since a plastic material is difficult to use as the material of the light guide board, reducing the weight of the light guide board is also difficult. With an increase in the weight of the light guide board, the load on the nose of the wearer (the user) increases. For this reason, the wearer has difficulties wearing the HMD 1 for a long time.

In view of such weight-related issues, the light guide 30 according to an embodiment is configured to satisfy formula (2) where θ_{c} denotes an incident angle, which is greater than or equal to the critical angle θᵣ, of light (light corresponding to the light ray R₂₀ in FIG. 5 that reflects off the partial reflection layer 320 in a direction normal to the first surface 311 to exit the light guide board 310) incident on the partial reflection layer 320; R denotes a reflectance of light incident on the partial reflection layer 320 at the incident angle θ_{c}, normalized to values of 0 to 1 (i.e., the reflectance of 100% is normalized to 1); λ (m) denotes the center wavelength of light (image light); and h (m) denotes the thickness of the partial reflection layer 320.

$$\frac{log ( F ( 0.02 ) + \sqrt{{F ( 0.02 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \leq h \leq \frac{log ( F ( 0.9 ) + \sqrt{{F ( 0.9 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \qquad Formula ( 2 )$$

$$where$$

$$F ( R ) = 0.5 * ( \frac{( cos ( Φ {n}_{12} - Φ {n}_{23} ) - R \cdot cos ( Φ {n}_{12} + Φ {n}_{23} ) )}{( R - 1 )} + \frac{( cos ( Φ {h}_{12} - Φ {h}_{23} ) - R \cdot cos ( Φ {h}_{12} + Φ {h}_{23} ) )}{( R - 1 )} )$$

$$Φ {n}_{12} = - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {n}_{23} = π - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {h}_{12} = - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

$$Φ {h}_{23} = π - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

Such a light guide 30 enables light incident on the partial reflection layer 320 at an incident angle greater than or equal to the critical angle θᵣ to have a reflectivity appropriate to achieve the intended performance. This achieves a higher light use efficiency for the above-described reasons.

Further, such a thin partial reflection layer 320 (for example, a single layer) is less costly than the dielectric multilayer film.

Further, the thin partial reflection layer 320 involves a low elastic energy and thus achieves a higher accuracy of the flatness of the partial reflection layer 320. This also prevents deformation of the light guide board 310 due to the elastic energy of the partial reflection layer 320 and reduces the breakage of the partial reflection layer 320 due to the internal stress of the partial reflection layer 320. Thus, the occurrence of flare and ghost and a reduction in resolution can be prevented or reduced. The configuration of an embodiment involves less restriction in selecting the materials of the light guide board 310 and the partial reflection layer 320 than the comparative example.

In this example, the partial reflection layer 320 of a thin single layer film is possible to form on a plastic material having a low glass transition temperature. Such a plastic material for the light guide board 310 allows a reduction in the weight of the light guide board 310. With a decrease in the weight of the light guide board 310, the load on the nose of the wearer (the user) decreases. For this reason, the wearer can continue wearing the HMD 1 for a long time without getting fatigued.

The partial reflection layer 320 is composed of a thin layer an allows reflection of a part of light incident thereon at an angle greater than or equal to the critical angle θᵣ and transmission of another part of the light therethrough. This reduces a variation in reflectance due to changes in film thickness and increases robustness of the light guide 30.

The light guide board 310 includes multiple partial reflection layers 320 arranged in parallel with each other at certain intervals d. However, the multiple partial reflection layers 320 adjacent to each other may not be arranged in parallel with each other at the same interval d. In some examples, the interval between the partial reflection layers 320 adjacent to each other may be appropriately adjusted for each position in the Y-direction in the light guide board 310.

The multiple partial reflection layers 320 allows a wider eye box.

As described above, in some examples, some of the partial reflection layers 320 may be arranged in a direction non-parallel to other partial reflection layers 320.

Among the multiple partial reflection layers 320, for example, a certain partial reflection layer (a first partial reflection layer) is thicker than another partial reflection layer (a second partial reflection layer) closer than the first partial reflection layer to the optical entrance 315.

While passing through the light guide 30 in the +Y-direction from the optical entrance 315 (adjacent to the −Y-side edge of the light guide 30), the light beam R₁ is repeatedly reflected by each partial reflection layer 320 and thus exit through the first surface 311. In this configuration, the amount of the light ray R₁ passing through the light guide board 310 gradually decreases. With each partial reflection layer 320 having the same reflectance for the light ray R₁, light (a light ray R₂) reflected by a partial reflection layer 320 farther from the optical entrance 315 in the +Y-direction has a lower intensity.

As the thickness of the partial reflection layer 320 increases, the reflectance of light incident on the partial reflection layer 320 increases.

The second partial reflection layer, which is farther from the optical entrance 315 than the first partial reflection layer, is thicker than the first partial reflection layer. This configuration allows correction of the difference in intensity of light reflected by the partial reflection layer between the first partial reflection layer and the second partial reflection layer. Such a correction of the intensity difference allows a substantially uniform luminance of a virtual image within the eye box.

More preferably, among the multiple partial reflection layers 320, a partial reflection layer 320 farther from the optical entrance 315 is thicker. This configuration allows a higher reflectance of the light ray R₁ on a partial reflection layer 320 as the partial reflection layer 320 is farther from the optical entrance 315. This further allows a uniform intensity of light at each angle of view reaching a corresponding position within the eye box and thus achieves a uniform luminance of a virtual image over the eye box as a whole.

In addition, when the pupil diameter in the eye box is defined as 2 Nmm (for example, 3 mm), a partial reflection layer 320 within a range of ±Nmm (for example, ±1.5 mm) corresponding to the eye box, may be thicker as the partial reflection layer 320 is farther from the optical entrance 315.

In some examples, the multiple partial reflection layers 320 each may reflect incident light at an angle of ±θ₃ₘₐₓ with reference to the normal to the first surface 311 within a plane perpendicular to each of the first surface 311 and the partial reflection layer 320 (i.e., within the YZ plane). In this case, formula (3) is satisfied where d denotes an interval between adjacent partial reflection layers 320 in a direction (i.e., the Y-direction) parallel to the first surface 311 within the YZ plane; Φ₁ denotes an angle between the partial reflection layer 320 and the normal to each of the first surface 311 and the second surface 312 within the YZ plane; and t denotes the interval (or the distance) between the first surface 311 and the second surface 312. The angle θ₃ₘₐₓ indicates an exit angle θ₃ of the light ray R₂ corresponding to the maximum angle of view.

$$d \leq t ( tan ( {Φ}_{1} ) - tan ( {sin}^{- 1} ( \frac{1}{{n}_{1}} sin {θ}_{3 max} ) ) ) \qquad Formula ( 3 )$$

An angle θ₄ is given by formula (4) where θ₄ denotes an angle between the light ray R₁ reflected by the normal to the first surface 311 and the partial reflection layer 320 after striking the partial reflection layer 320 at the incident angle Ψ₂; and θ₄ₘₐₓ denotes a maximum incident angle θ₄ of the light ray R₀ incident on the optical entrance 315.

$${θ}_{4 max} = {sin}^{- 1} ( \frac{1}{{n}_{1}} sin {θ}_{3 max} ) \qquad Formula ( 4 )$$

With the interval d (between the adjacent partial reflection layers 320) satisfying formula (3) (i.e., the interval d is less than or equal to the value of the right side of formula (3)), the light rays of the respective angles of view, including the light ray R₂, reflected by the partial reflection layer 320a overlap with the light rays of the respective angles of view reflected by another partial reflection layer 320 adjacent to the partial reflection layer 320a, thus exiting the light guide 30 through the first surface 311. Under the conditions that satisfies formula (3), the light rays of the respective angles of view exit the light guide 30 through the first surface 311 without being separated from each other in the ±Y-directions. This allows a reduction in unevenness of the luminance of a virtual image and thus achieves a higher resolution of the virtual image. The interval d between the partial reflection layers 320 may be adjusted for each position of the light guide board 310 in the +Y-directions as appropriate within a range that satisfies formula (3).

In FIG. 3, the angle θ₄ₘₐₓ is 10.85°. When this value is substituted into formula (3), 0.65 mm is derived as the interval d between the partial reflection layers 320.

The thickness of the partial reflection layer 320 is, for example, equal to or less than the center wavelength λ of light incident on the partial reflection layer 320. Such a partial reflection layer 320 having a thickness less than or equal to the center wavelength λ enables light incident on the partial reflection layer 320 at an incident angle greater than or equal to the critical angle θᵣ to have a reflectance appropriate to achieve the intended performance. This achieves a higher light use efficiency for the above-described reasons.

As described above, the manufacturing cost is reduced. The partial reflection layer 320 with a low elastic energy achieves a higher accuracy of the flatness of the partial reflection layer 320 and also reduces deformation of the light guide board 310 due to the elastic energy of the partial reflection layer 320, thus reducing the breakage of the partial reflection layer 320 due to the internal stress of the partial reflection layer 320. Thus, the occurrence of flare and ghost and a reduction in resolution can be prevented or reduced. The configuration of an embodiment involves less restriction in selecting the materials of the light guide board 310 and the partial reflection layer 320 than the comparative example.

In this example, the partial reflection layer 320 of a thin single layer film is possible to form on a plastic material having a low glass transition temperature. Such a plastic material for the light guide board 310 allows a reduction in the weight of the light guide board 310.

The partial reflection layer 320 allows reflection of a part of light incident thereon at an angle greater than or equal to the critical angle θᵣ and transmission of another part of the light therethrough. This reduces a variation in reflectivity due to changes in film thickness and increases robustness of the light guide 30.

As described below, a certain layer (an adhesive layer or a primer layer) may be disposed on or over the partial reflection layer 320. With the certain layer having a refractive index n₃, for example, formula (5) is satisfied.

|n₃−n₁|<0.015 (5)

Satisfying formula (5) reduces the effects (e.g., a variation in the reflectance of the light ray R₂ from the partial reflection layer 320 after striking the partial reflection layer 320 at approximately critical angle θᵣ).

With a thicker certain layer, the angle at which the light ray R₂ exits the light guide board 310 through the first surface 311 changes. This may cause ghost or reduce resolution. In view of this, the certain layer is set to, for example, 10 μm or less. With such a certain layer, the occurrence of ghost or a reduction in resolution is prevented or reduced.

The light rays exiting the light guide board 310 through the first surface 311 have undergone entering the partial reflection layer 320 at an incident angle greater than the critical angle θᵣ and reflection thereon. In this case, the reflectance of light from the partial reflection layer 320 can be controlled in a wide range for all angles of view.

This allows a further uniform luminance of a virtual image within each angle of view.

The light guide board 310 may be composed of synthetic resin such as plastic, for example. The light guide board 310 composed of such resin is lightweight. With a decrease in the weight of the light guide board 310, the load on the nose of the wearer (the user) decreases. For this reason, the wearer can continue wearing the HMD 1 for a long time without getting fatigued.

The light guide board 310 may have a third surface adjacent to the optical entrance 315.

The third surface is, for example, the first edge face 313, which is the −Y-side edge of the light guide board 310. The light guide 30 may include an external mirror 330 having a reflecting surface parallel to the third surface. In this case, light entering the optical entrance 315 strikes the first edge face 313 and then reflects off the external mirror 330, passing through the light guide board 310.

Further, the light guide board 310 may include a reflective portion that reflects light entered into the optical entrance 315 to allow the light to pass through the light guide board 310. The reflective portion is, for example, the first edge face 313 coated with a reflective film. The reflective film is, for example, an aluminum coating film. In this case, the light entering the optical entrance 315 is reflected by the first edge face 313 and then passes through the light guide board 310. This configuration eliminates the use of the external mirror 330 and allows a reduction in the size of the light guide 30.

In contrast, the configuration incorporating the external mirror 330 eliminates the process of coating (e.g., vapor deposition) the first edge face 313 with a metal film such as an aluminum coating film. Therefore, the step of metal film coating is not required. Such an elimination of the process of coating the first edge face 313 with a metal film prevents deformation of the light guide board 310 due to the stress or thermal effects during the formation of the film. For this reason, it is possible to avoid occurrence of problems such as occurrence of flare or ghost and reduction in resolution due to the deformation of the light guide board 310. Note that the external mirror 330 may be included in an example of a “reflection portion” that reflects light incident on the optical entrance 315 so as to be guided inside the light guide board 310.

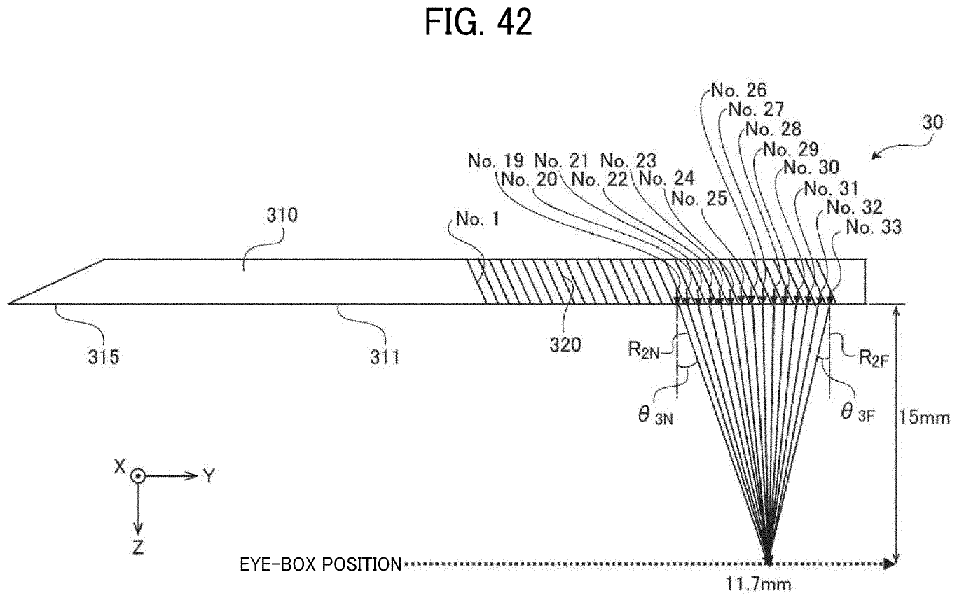

Among the light rays exiting the light guide board 310 from the respective positions on the first surface 311 to reach the eyes (the eye box) of the observer (the wearer or the user), a first light ray R_{2N} in FIG. 42 exits the light guide board 310 from a position closest to the optical entrance 315 toward the eyes. A second light ray R_{2F} in FIG. 42 exists the light guide board 310 from a position farthest from the optical entrance 315 toward the eyes. A first angle θ_{3N} in FIG. 42 between the first light ray R_{2N} and the normal to the first surface 311 may be different from a second angle θ_{3F} in FIG. 42 between the second light ray R_{2F} and the normal to the first surface 311. Preferably, the first angle θ_{3N} is greater than the second angle θ_{3F}.

For example, the first angle θ_{3N} corresponding to the maximum angle of view in the positive direction is greater than the second angle θ_{3F} corresponding to the maximum angle of view in the negative direction. This configuration allows enlargement of the angle of view satisfying the image quality and a reduction in light intensity differences between the angles of view.

FIG. 5 is a schematic view of a light guide 30 according to a first embodiment that allows an eye box of ±4 mm in the ±Y directions with a horizontal angle of view of ±18° (i.e., an angle of view in the +Y directions) at a position 15 mm away from the first surface 311 in the +Z-direction.

The light guide 30 according to the first embodiment includes 33 partial reflection layers 320 (No. 1 to No. 33). The partial reflection layer 320 of No. 1 is oriented at an angle Φ₁ (24.25°) with reference to the normal to each of the first surface 311 and the second surface 312 from a position on the first surface 311, which is 22.13 mm away from the center of the external mirror 330. The partial reflection layers 320 of No. 1 to No. 33 are arranged with an interval d of 0.65 mm. In this arrangement, the interval (distance) between the partial reflection layer 320 of No. 1 and the partial reflection layer 320 of No. 33 is 20.8 mm. This allows light rays with all the horizontal angles of view to reach a range of 11.05 mm extending in the horizontal direction at a position 15 mm away from the first surface 311 in the +Z-direction. The pupil diameter of the eye of the wearer is assumed to be 3 mm.

In this configuration, the light ray R₂ exits the first surface 311 after striking the partial reflection layer 320 at the incident angle Ψ₂ and reflecting thereof. Hereinafter, the reflectance of the light ray R₁ corresponding to the light ray R₂ striking the partial reflection layer 320 at the incident angle Ψ₂ is referred to as image-light reflectance.

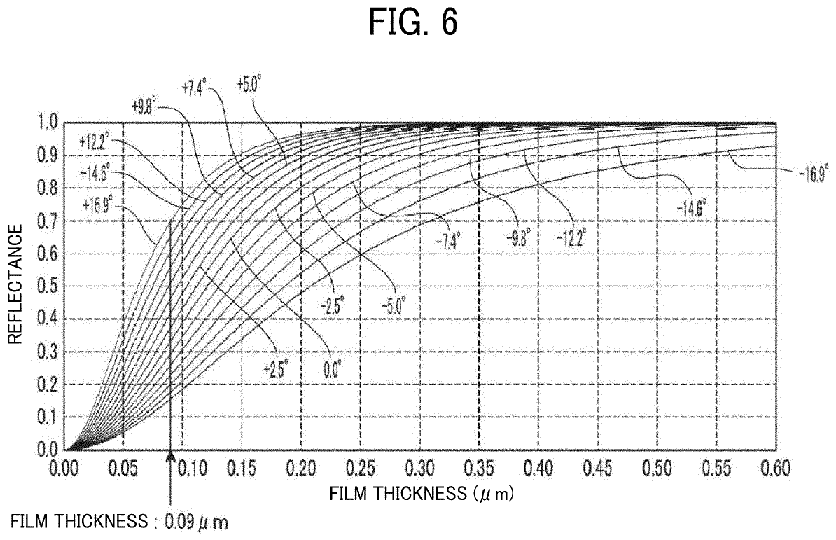

FIGS. 6 to 11 are illustrations of the light guide 30 according to the first embodiment.

FIG. 6 is a graph of the relation between the thickness of the partial reflection layer 320 and an image-light reflectance for each angle of view in a range of −16.9° to +16.9°. In FIG. 6, the light guide 30 has the configuration in FIG. 5 with the light guide board 310 having a refractive index n₁ of 1.642 and the partial reflection layer 320 having a refractive index n₂ of 1.34. The image light is assumed to be light in which S-polarized light and P-polarized light are uniformly mixed and whose center wavelength λ is 550 nm. In FIG. 6, the vertical axis represents the reflectance (normalized by 1), and the horizontal axis represents the film thickness (μm) of the partial reflection layer 320.

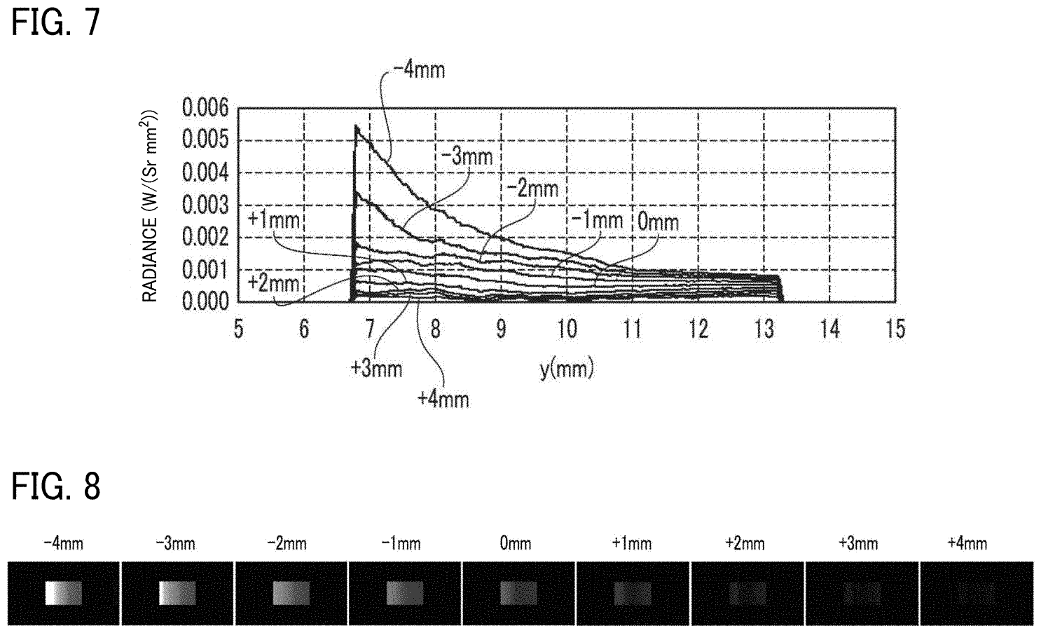

FIG. 7 is a graph of a simulated luminance distribution of light rays converging onto positions ±4 mm from the center of the eye box with a certain width in the horizontal direction (the Y-direction), using ray tracing software in the light guide 30 in FIG. 6. In FIG. 7, the vertical axis represents radiance (Wsr⁻¹ mm⁻²), and the horizontal axis represents position y (mm) of a virtual image in the horizontal direction (the Y-direction) with an ideal lens having an effective diameter of 3 mm and a focal length of 10 mm, located at each position, ±4 mm from the center of the eye box, within the eye box.

FIG. 8 is an illustration of a luminance image for each position within the eye box with the luminance distribution in FIG. 7, simulated using the ray tracing software.

With each of the partial reflection layers 320 of No. 1 to No. 33 having a thickness of 0.09 μm, for example, the image-light reflectance corresponding to an angle of view of +16.9° is 0.7, whereas the image-light reflectance corresponding to −16.9° is 0.155. This means that the image-light reflectance greatly differs between the angle of view of +16.9° and the angle of view of −16.9° (see FIG. 6). As described above, with an increasing angle of view in the positive direction, the incident angle Ψ₂ increases, and the amount of evanescent light passing through the partial reflection layer 320 decreases. For this reason, the former image-light reflectance corresponding to the angle of view of +16.9° is higher than the latter image-light reflectance for the angle of view of −16.9°.

Further, since the amount of light ray R₁ passing through the light guide board 310 gradually decreases in the +Y-direction, the luminance (radiance) increases toward the optical entrance 315 in the −Y-direction (i.e., the luminance decreases in a direction away from the optical entrance 315, or in the +Y-direction)(see FIG. 7).

In FIG. 8, the luminance of a luminance image at each position in the eye box increases with an angle of view closer to +180 and decreases with an angle of view closer to −18°. The luminance of a luminance image corresponding to a position closer to the optical entrance 315 increases as a whole, and the luminance of a luminance image as a whole corresponding to a position farther from the optical entrance 315 decreases as a whole.

In the first embodiment, the thickness of each of the partial reflection layers 320 of No. 1 to No. 33 is set to reduce differences in luminance between the angles of view of the luminance images or between the positions within the eye box.

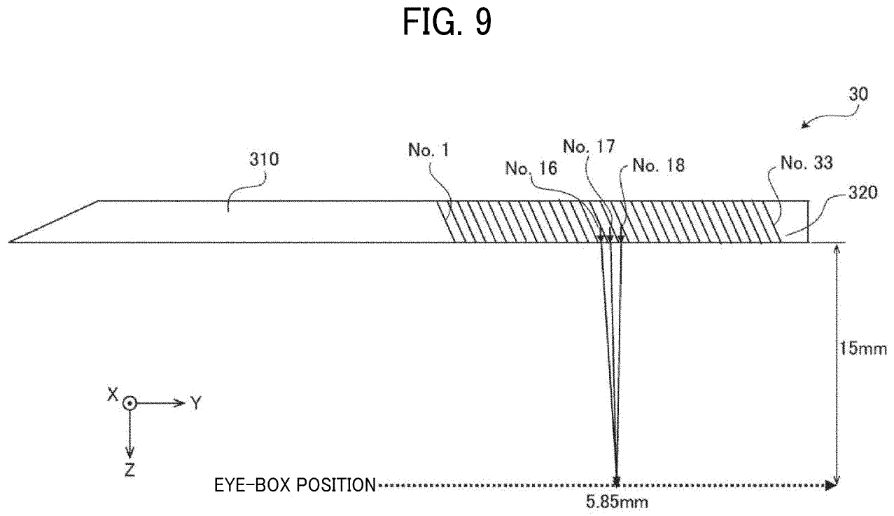

In FIG. 9, light reaching the center of a luminance image at a position of 5.85 mm (from the center of the eye box) within the eye box includes a light ray with an angle of view of +5° after reflecting off the partial reflection layer 320 of No. 16, a light ray with an angle of 0° after reflecting off the partial reflection layer 320 of No. 17, and a light ray with an angle of view of −5° after reflecting off the partial reflection layer 320 of No. 18. Setting the thicknesses of the partial reflection layers 320 of No. 16 to No. 18 to adjust the image-light reflectances of the partial reflection layers 320 of No. 16 to No. 18 allows the light rays with these angles of view to have substantially the same intensity.

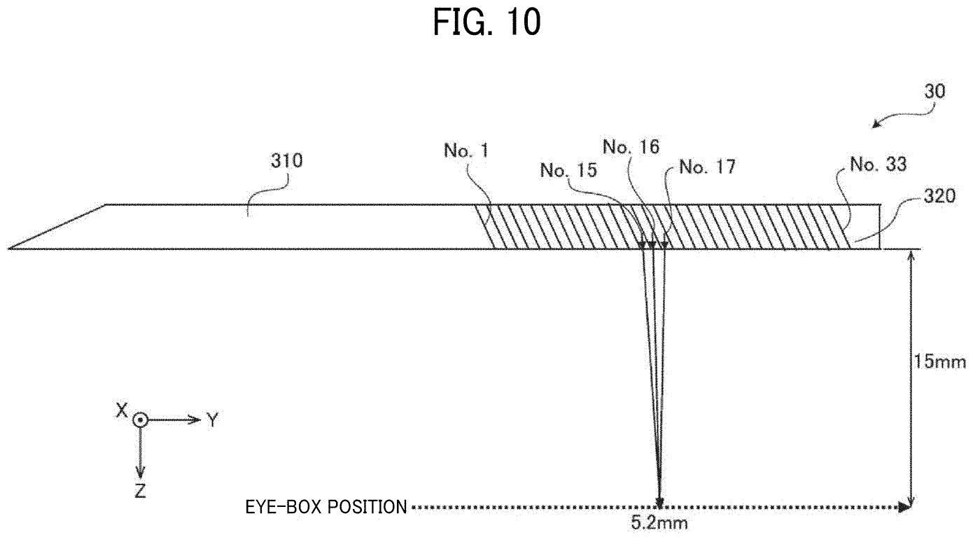

In FIG. 10, light reaching the center of a luminance image at a position of 5.2 mm (from the center of the eye box) within the eye box includes a light ray with an angle of view of +5° after reflecting off the partial reflection layer 320 of No. 15, a light ray with an angle of 0° after reflecting off the partial reflection layer 320 of No. 16, and a light ray with an angle of view of −5° after reflecting off the partial reflection layer 320 of No. 17. Since the thicknesses of the partial reflection layers 320 of No. 16 and No. 17 are already set, the average of the image-light reflectances of No. 16 and No. 17 is calculated. The thickness of the partial reflection layer 320 of No. 15 (in other words, the image-light reflectance of the partial reflection layer 320 of No. 15) is set to allow the image-light reflectance of the partial reflection layer 320 of No. 15 to be substantially equal to the calculated average. In the similar manner as described above, the thicknesses of the partial reflection layers 320 of No. 18 to No. 6 are set.

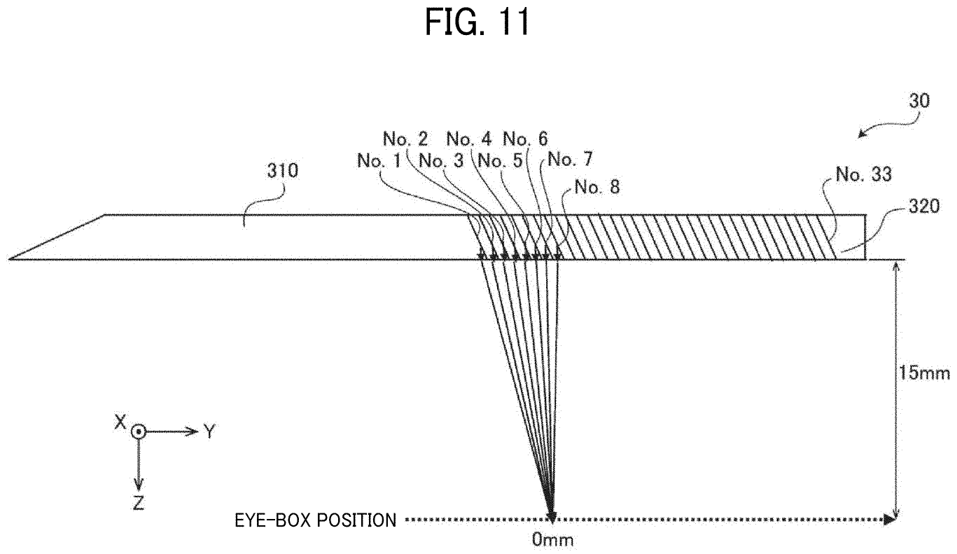

The thicknesses of the partial reflection layers 320 of No. 1 to No. 5 (in other words, the image-light reflectances of the partial reflection layers 320 of No. 1 to No. 5) are set to allow an image-light reflectance corresponding to each of the partial reflection layers 320 of No. 1 to No. 5 to be substantially equal to the average of the image-light reflectances of the partial reflection layers 320 of No. 6 to No. 8, from which light rays reach the position of 0 mm within the eye box (see FIG. 11).

The thickness of each of the partial reflection layers 320 of No. 19 to No. 33 are also set in the same manner as in the partial reflection layers 320 of No. 1 to No. 18.

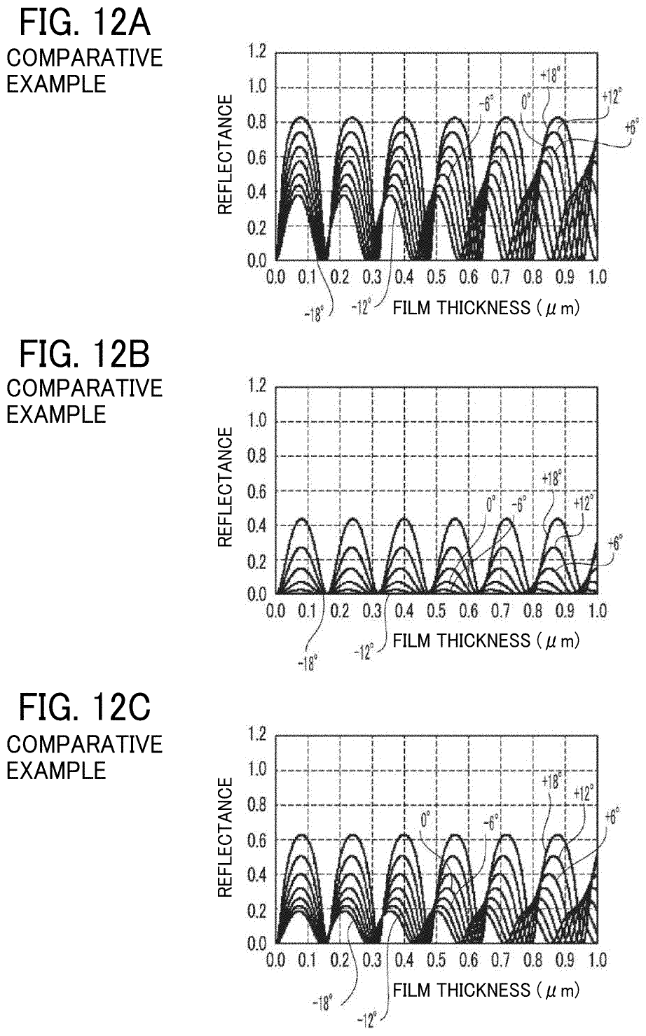

FIGS. 12A to 12C are graphs of the characteristics of a light guide according to Comparative Example 1. FIGS. 12A to 12C are graphs of the relation between the thickness of the partial reflection layer 320 and an image-light reflectance for each angle of view in a range of −18° to +18°. In FIGS. 12A to 12C according to Comparative Example 1, the light guide 30 in FIG. 5 is used with the light guide board 310 having a refractive index n₁ of 1.642 and a partial reflection layer having a refractive index n₂ of 2.35. FIG. 12A is a graph of the characteristics of image light, which is S-polarized light having a central wavelength λ of 550 nm. FIG. 12B is a graph of the characteristics of image light, which is P-polarized light having a central wavelength λ of 550 nm. FIG. 12C is a graph of the characteristics of image light, in which S-polarized light and P-polarized light each having a center wavelength λ of 550 nm are uniformly mixed. In each of FIGS. 12A to 12C, the vertical axis represents the reflectance (normalized by 1), and the horizontal axis represents the thickness (μm) of a partial reflection layer, according to Comparative Example 1. The light guide board according to Comparative Example 1 is composed of, for example, OKP (registered trademark)−1 (Osaka Gas Chemical Co., Ltd.). The partial reflection layer according to Comparative Example 1 is a single-layer deposited film of TiO₂.

In Comparative Example 1, the refraction index n₂ of the partial reflection layer is higher than the refraction index n₁ of the light guide board. As illustrated in FIGS. 12A to 12C according to Comparative Example 1, the image-light reflectance corresponding to each angle of view periodically changes with the thickness of the partial reflection layer. This cycle, or period decreases with an increasing angle of view in the negative direction and increases with an increasing angle of view in the positive direction. Further, the peak of the image-light reflectance differs for each angle of view. The image-light reflectance decreases as a whole with an increasing angle of view in the negative direction and increases as a whole with an increasing angle of view in the positive direction. For the angle of view of −18°, P-polarized light as the image light has an image-light reflectance of close to 0 irrespective of the thickness of the partial reflection layer. By contrast, the S-polarized light as the image light has a maximum image-light reflectance of approximately 35%.

The inventors of the present application have found through studies that as the refractive index n₂ increases relative to the refractive index n₁, the cycle of change in the image-light reflectance with the thickness of the partial reflection layer decreases, and its peak value increases. In other words, as the refractive index n₂ increases relative to the refractive index n₁, the variation in image-light reflectance due to change in the thickness of the partial reflection layer increases, which means a low robustness with respect to the variation in the thickness of the partial reflection layer.

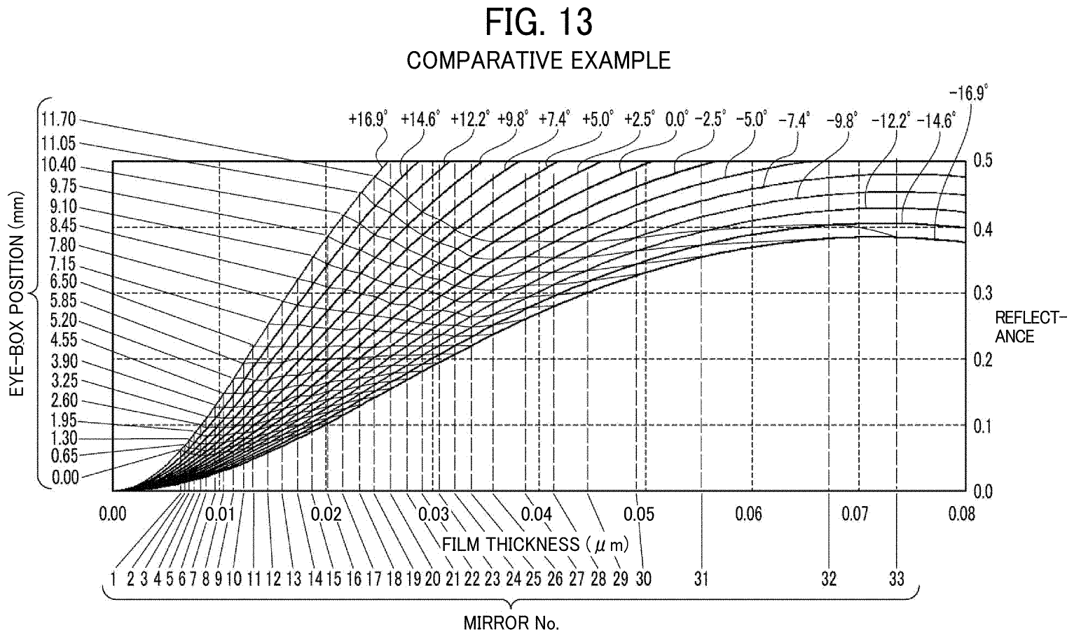

FIG. 13 is a graph of the relation between the thickness of the partial reflection layer and an image-light reflectance for each angle of view in a range of −16.9° to +16.9°, according to Comparative Example 1. The image light is S-polarized light having a central wavelength λ of 550 nm. In FIG. 13, the vertical axis represents the reflectance (normalized by 1), and the horizontal axis represents the film thickness (μm) of the partial reflection layer. FIG. 13 also presents the thickness of each of the partial reflection layers of No. 1 to No. 33 and the image-light reflectance of each of the light rays with the angles of view reaching the respective positions in a range of 0 mm to 11.7 mm within the eye box.

With the partial reflection layers of No. 1 to No. 33 having the thicknesses as presented in FIG. 13, differences in image-light reflectance between the light rays with the angles of view reaching the respective positions in the eye box is reduced unlike with the partial reflection layers have the same thickness. In FIG. 13, an intersection point between a line of a certain position within the eye box and a line of an angle of view represents an image-light reflectance for an angle of view corresponding to the certain position within the eye box.

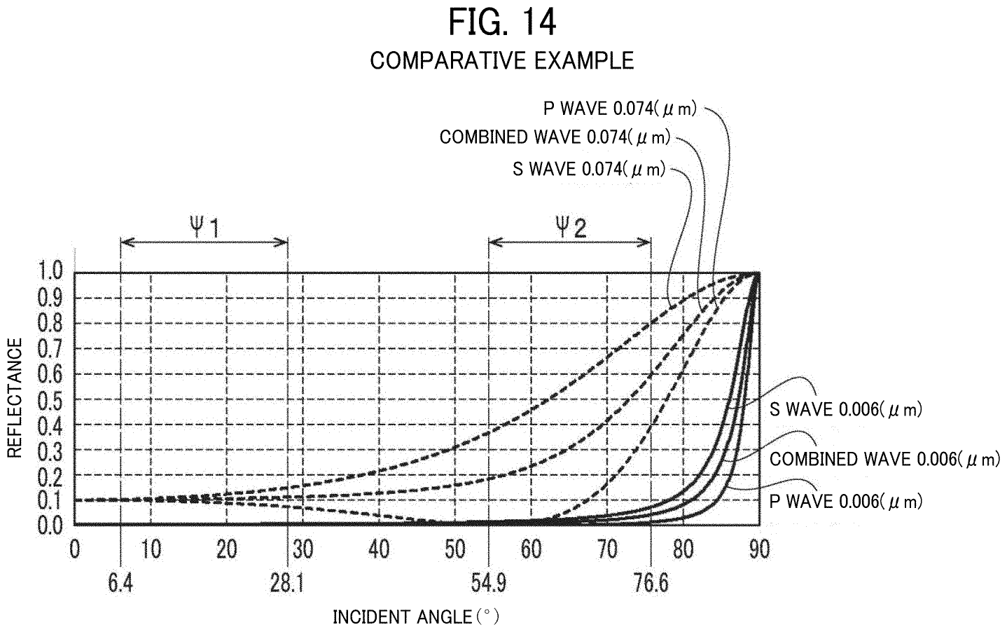

FIG. 14 is a graph of the relation between incident angle (°) on the partial reflection layer and reflectance (normalized by 1) thereof, according to Comparative Example 1. FIG. 14 presents reflectance of each of the p-wave, the s-wave, and the combined wave, in which the p-wave is combined with the s-wave, incident on a partial reflection layer of No. 1 having a minimum thickness of 0.006 μm and reflectance of each of the p-wave, the s-wave, and the combined wave of the p-wave and the s-wave, incident on a partial reflection layer of No. 33 having a maximum thickness of 0.074 μm. In FIG. 14, the incident angle Ψ₂ at which light with an angle of view of −18° has been incident on the partial reflection layer is 54.9°. Further, the incident angle Ψ₂ at which light with an angle of view of +180 has been incident on the partial reflection layer is 76.6°.

In Comparative Example 1, for the angle of view of −18°, P-polarized light as the image light has an image-light reflectance of close to 0 irrespective of the thickness of the partial reflection layer, and the mixed light (of the S-polarized light and the P-polarized light) serving as the image light has a low image-light reflectance irrespective of the thickness of the partial reflection layer. For these reasons, such image light (i.e., the P-polarized light or the mixed light of the S-polarized light and the P-polarized light) fails to reduce differences in image-light reflectance between the light rays with the angles of view by increasing the thickness of the partial reflection layer. In Comparative Example 1, only S-polarized light can be used as image light to reduce a difference in image-light reflectance between the light rays with the angles of view. However, the light use efficiency is low with the use of the S-polarized light alone.

As presented in FIG. 14, for the S-polarized light, the image-light reflectance corresponding to the angle of view of −18° can be increased to some extent by changing the thickness of the partial reflection layer from 0.006 μm to 0.074 μm. This allows a reduction in a difference in intensity between the light rays with the angles of view reaching the respective position within the eye box unlike with the partial reflection layers have the same thickness.

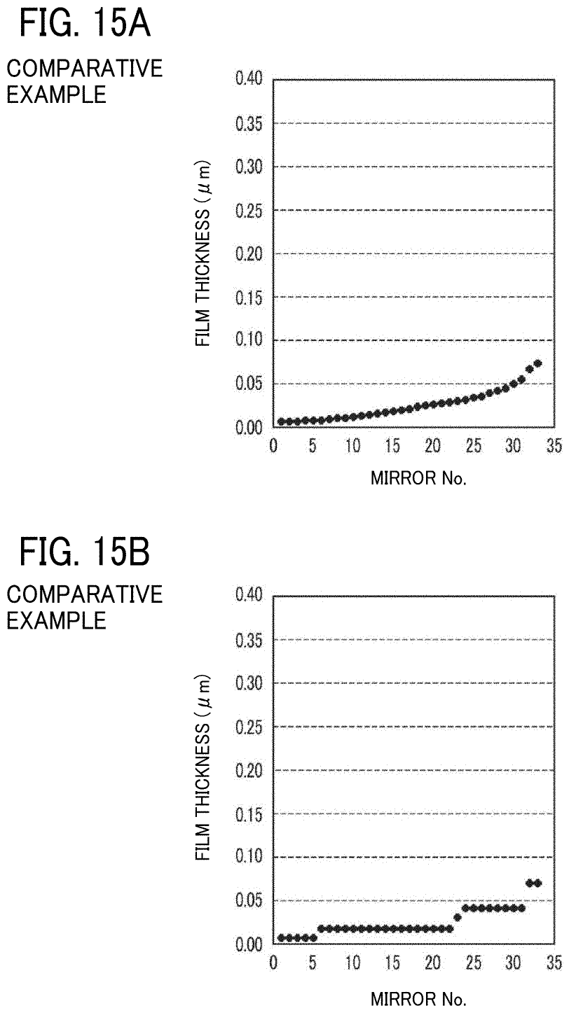

FIG. 15A is a graph in which the thicknesses of the partial reflection layers of No. 1 to No. 33 in FIG. 13 are plotted. In FIG. 15A, the vertical axis represents the thickness (μm) of the partial reflection layer, and the horizontal axis represents the number (mirror No.) of the partial reflection layer.

The partial reflection layers of No. 1 to No. 33 are difficult to set the thickness with an accuracy of several nanometers pitch as presented in FIG. 15A. For this reason, the thicknesses of the partial reflection layers of No. 1 to No. 33 may be set at pitches equal to or greater than 10 nm. Similarly to FIG. 15A, FIG. 15B is a graph in which the thicknesses of the partial reflection layers of No. 1 to No. 33 according to Comparative Example 1 are set with pitches equal to or greater than 10 nm.

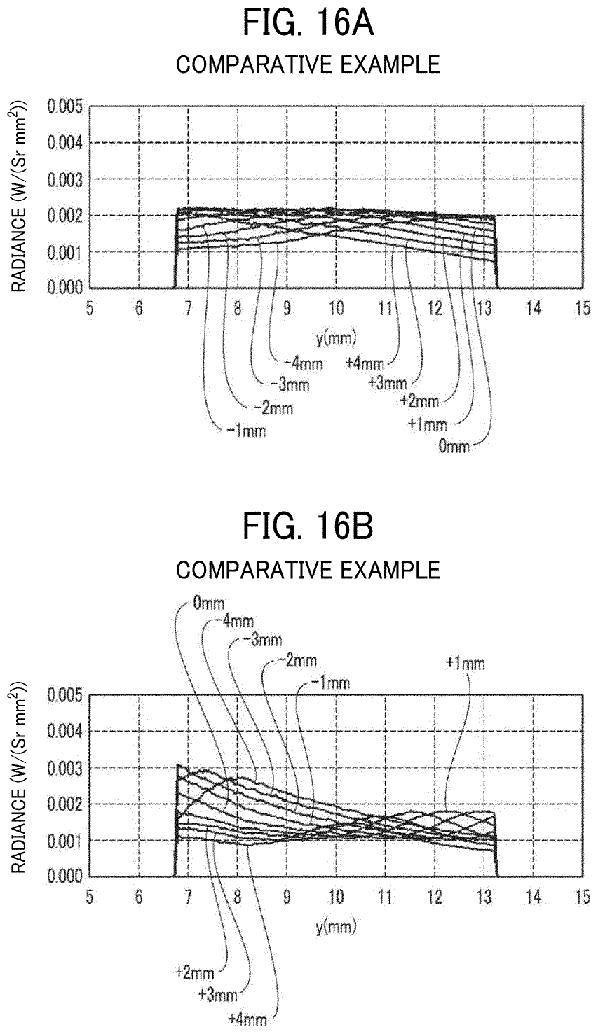

FIGS. 16A and 16B are graphs of a simulated luminance distribution of light rays converging onto positions ±4 mm from the center of the eye box with a certain width in the horizontal direction (the Y-direction), using ray tracing software. In FIGS. 16A and 16B, the vertical axis represents radiance (Wsr⁻¹ mm⁻²), and the horizontal axis represents position y (mm) of a virtual image in the horizontal direction (the Y-direction) with an ideal lens having an effective diameter of 3 mm and a focal length of 10 mm, located at each position, ±4 mm from the center of the eye box, within the eye box. FIG. 16A is a graph of simulation results when the partial reflection layers of No. 1 to No. 33 have the thicknesses as presented in FIG. 15A, according to Comparative Example 1. FIG. 16B is a graph of simulation results when the partial reflection layers of No. 1 to No. 33 have the thicknesses as presented in FIG. 15B, according to Comparative Example 1. The pupil diameter of the eye of the wearer is assumed to be 3 mm.

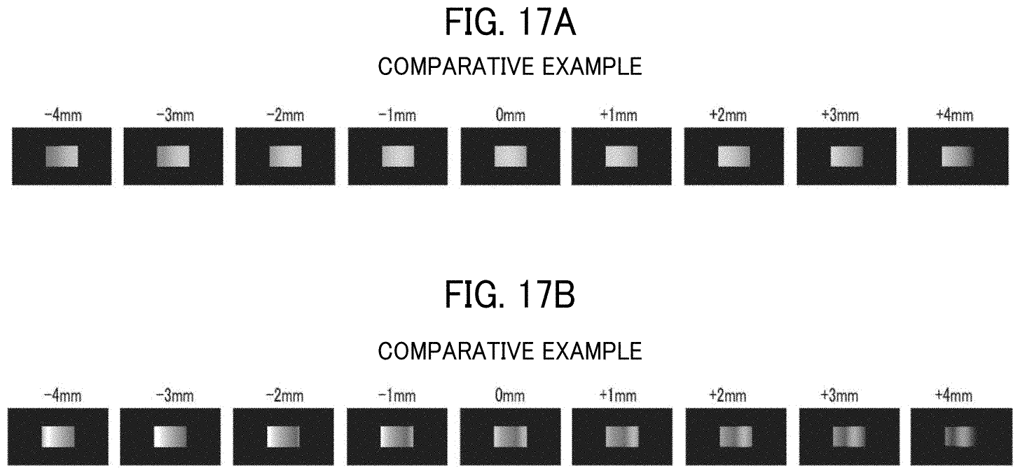

FIG. 17A is an illustration of a luminance image for each position within the eye box with the luminance distribution in FIG. 16A, simulated using the ray tracing software. FIG. 17B is an illustration of a luminance image for each position within the eye box with the luminance distribution in FIG. 16B, simulated using the ray tracing software.

FIG. 17A allows a certain degree of uniformity in luminance, whereas FIG. 17B causes a significant change in luminance and thus an unevenness of luminance in streaks of an unacceptable level.

To deal with such situations, the first embodiment allows a part of light entering the partial reflection layer 320 at an incident angle greater than or equal to the critical angle θᵣ to reflect off the partial reflection layer 320 to exit the light guide board 310 through the first surface 311 and also allows the remainder (evanescent light) of the light entering the partial reflection layer 320 to pass through the partial reflection layer 320, with the partial reflection layer 320 having a refractive index n₂ lower than the refractive index n₁ of the light guide board 310. This configuration provides an image-light reflectance of each partial reflection layer 320, which is appropriate to perform the intended performance and thus increase the light use efficiency.

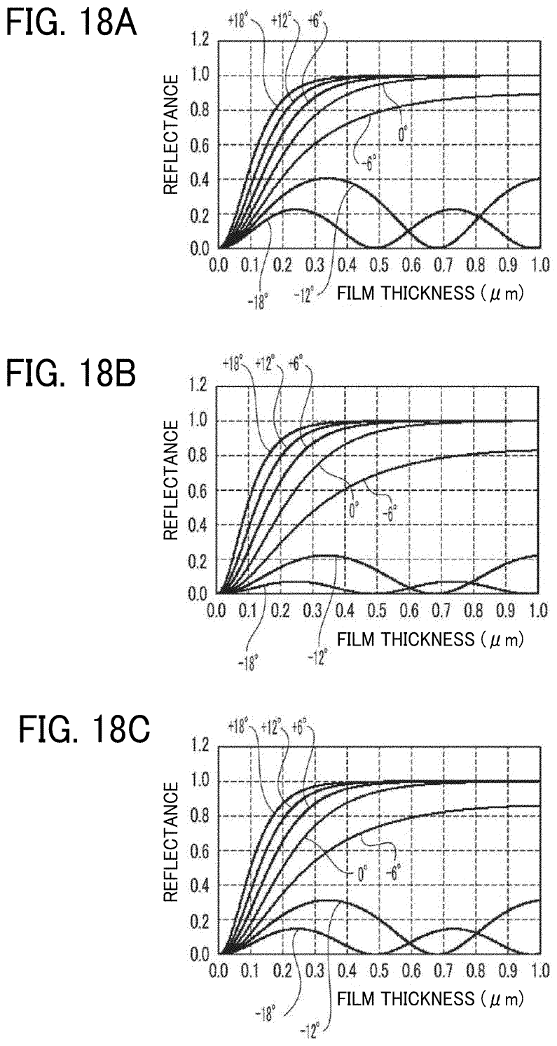

FIGS. 18A to 18C are graphs of the characteristics of the light guide 30 according to the first embodiment. Similar to FIGS. 12A to 12C, FIGS. 18A to 18C are graphs of the relation between the thickness of the partial reflection layer 320 and an image-light reflectance for each angle of view in a range of −18° to +18°. In the first embodiment, the light guide board 310 has a refractive index n₁ of 1.642, and the partial reflection layer 320 has a refractive index n₂ of 1.457. FIG. 18A is a graph of the characteristics of image light, which is S-polarized light having a central wavelength λ of 550 nm. FIG. 18B is a graph of the characteristics of image light, which is P-polarized light having a central wavelength λ of 550 nm. FIG. 18C is a graph of the characteristics of image light, in which S-polarized light and P-polarized light each having a center wavelength λ of 550 nm are uniformly mixed. The light guide board 310 according to the first embodiment is composed of, for example, OKP-1 (Osaka Gas Chemical Co., Ltd.). The partial reflection layer 320 according to the first embodiment is a single-layer deposited film of SiO₂.

In Comparative Example 1, as illustrated in FIGS. 12A to 12C, the image-light reflectance periodically changes with the thickness of the partial reflection layer irrespective of the angle of view. In the first embodiment as presented in FIGS. 18A to 18C, however, the image-light reflectance periodically changes with the thickness of the partial reflection layer 320, only for the angles of view of the light ray R₁ that have entered the partial reflection layer 320 at an incident angle of less than the critical angle θᵣ. Further, the cycle, or period of change in image-light reflectance in the first embodiment is longer than that in Comparative Example 1. This means that as the variation in image-light reflectance due to change in the thickness of the partial reflection layer in the first embodiment is smaller than that in Comparative Example 1, robustness with respect to the variation in the thickness of the partial reflection layer is higher that Comparative Example 1.

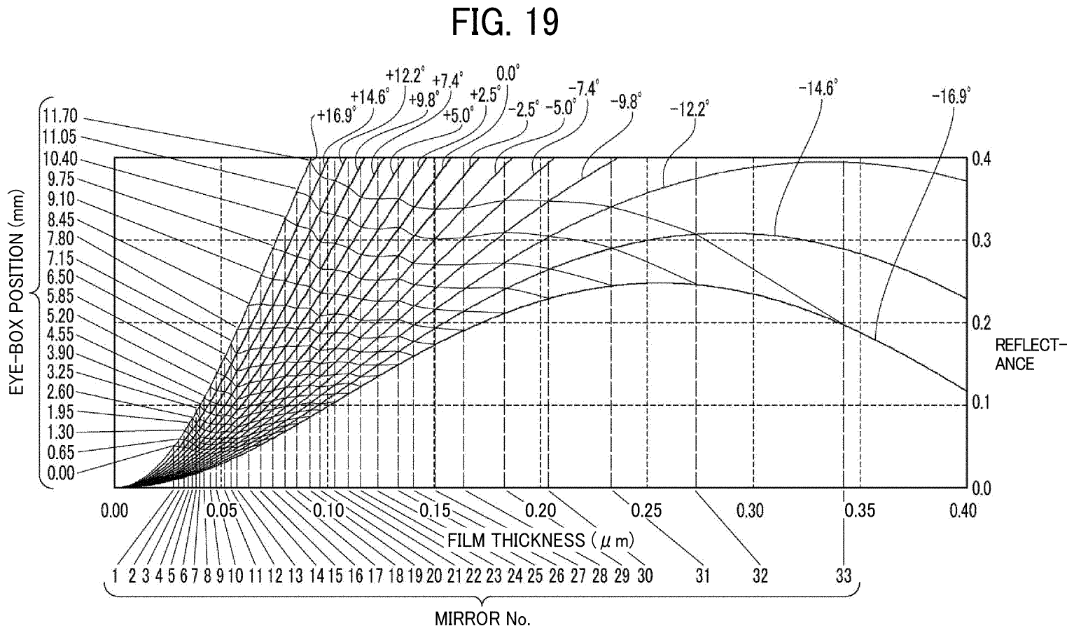

FIG. 19, which is similar to FIG. 13, is a graph of the relation between the thickness of the partial reflection layer 320 and an image-light reflectance for each angle of view in a range of −16.9° to +16.9°, first embodiment. The image light is S-polarized light having a central wavelength λ of 550 nm.

With the partial reflection layers 320 of No. 1 to No. 33 having the thicknesses as presented in FIG. 19, differences in light intensity between the light rays with the angles of view reaching the respective positions in the eye box is reduced unlike with the partial reflection layers 320 have the same thickness. Specifically, with increasing distance to the optical entrance 315, the thickness of the partial reflection layer 320 is increased to reduce a difference in reflectance (image-light reflectance) between the partial reflection layers 320 (e.g., mirror No. 11 to No. 25 at an eye-box position of 6.50 mm) at which light rays with the angles of view (e.g., angles of view of −16.9° to +16.9°) reaching the same eye-box position (i.e., a position in the eye box) are reflected. Thus, a difference in light intensity between the light rays having the respective angles of view is reduced. This further corrects a reduction in light intensity due to the gradual reduction in the amount of the light ray R₁ passing through the light guide board 310 and thus reduces a difference in luminance at each position within the eye box.

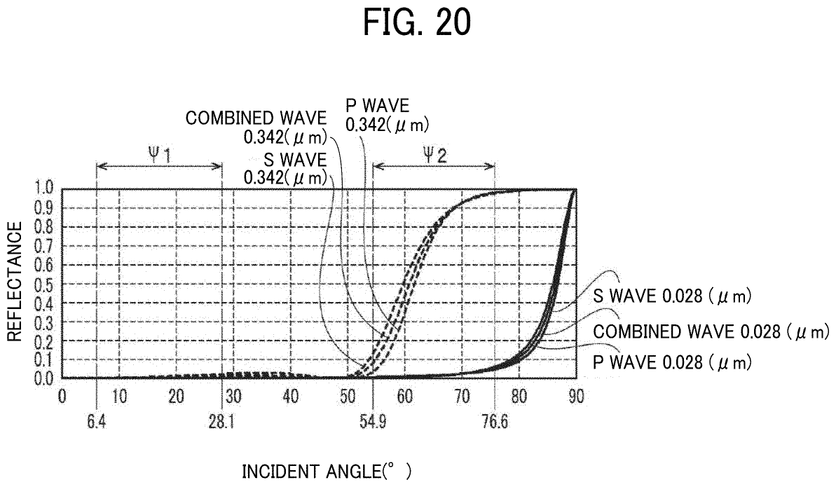

FIG. 20, which is similar to FIG. 14, is a graph of the relation between incident angle (°) on the partial reflection layer 320 and reflectance (normalized by 1) thereof, according to the first embodiment. FIG. 20 presents reflectance of each of the p-wave, the s-wave, and the combined wave thereof, incident on a partial reflection layer 320 of No. 1 having a minimum thickness of 0.028 μm and reflectance of each of the p-wave, the s-wave, and the combined wave, incident on a partial reflection layer 320 of No. 33 having a maximum thickness of 0.342 μm. In FIG. 20, the incident angle Ψ₂ at which light with an angle of view of −18° has struck the partial reflection layer 320 is 54.9°. Further, the incident angle Ψ₂ at which light with an angle of view of +180 has struck the partial reflection layer 320 is 76.6°.

In the first embodiment, the critical angle θᵣ is 62.5°. The incident angle Ψ₂ of a light ray for the angle of view of 0° that has entered the partial reflection layer 320 (i.e., the incident angle Ψ₂ for the light ray R₂₀ that reflects off the partial reflection layer 320 to exit the light guide 30 in a direction normal to the first surface 311) is 65.75°, which is greater than the critical angle θᵣ. As described above, the light use efficiency can be increased by setting the incident angle Ψ₂ of the light ray R₂₀ greater than the critical angle θᵣ and setting the thickness of the partial reflection layer 320 appropriate to perform the intended performance. This further achieves a reduction in a reflectance difference (a difference in image-light reflectance) between the partial reflection layers 320 at which the light rays with the respective angles of view have been reflected before reaching the same eye-box position.

Such a reduction in reflectance difference between the partial reflection layers 320 allows a reduction in the luminance difference within a certain angle range from the center of the angle of view (i.e., a position at each angle of view within a luminance image) and also allows a reduction in the luminance difference at each position within the eye box.

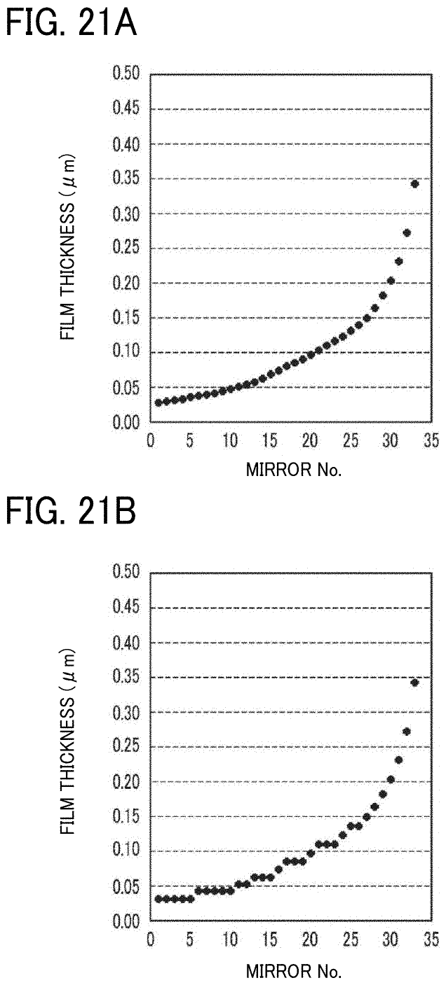

FIG. 21A, which is similar to FIG. 15A, is a graph in which the thicknesses of the partial reflection layers 320 of No. 1 to No. 33 in FIG. 19 are plotted. FIG. 21B, which is similar to FIG. 15B, is a graph in which the thicknesses of the partial reflection layers 320 of No. 1 to No. 33 according to the first embodiment are set with pitches equal to or greater than nm.

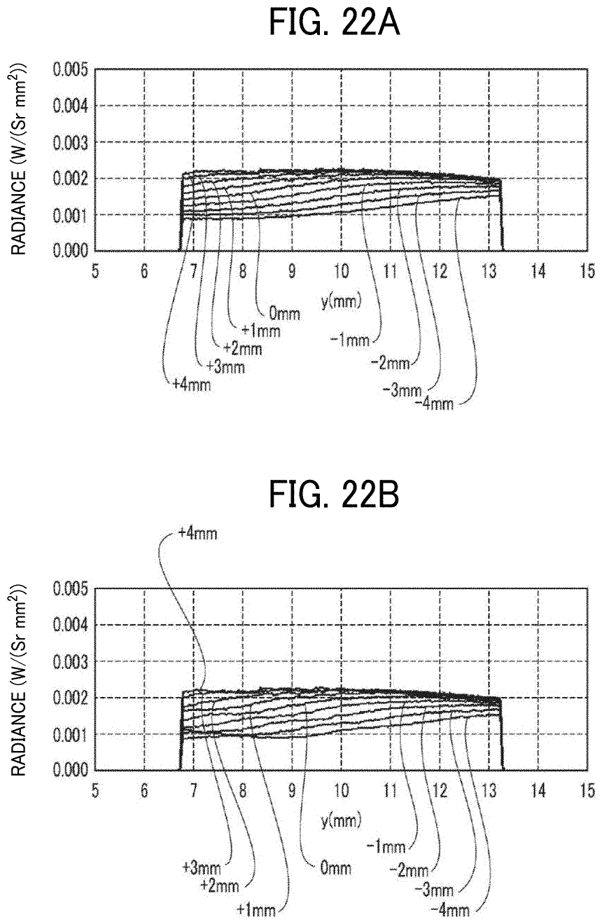

FIGS. 22A and 22B, which are similar to FIGS. 16A and 16B, are graphs of a simulated luminance distribution of light rays converging onto positions ±4 mm from the center of the eye box with a certain width in the horizontal direction (the Y-direction), using ray tracing software. The pupil diameter of the eye of the wearer is assumed to be 3 mm.

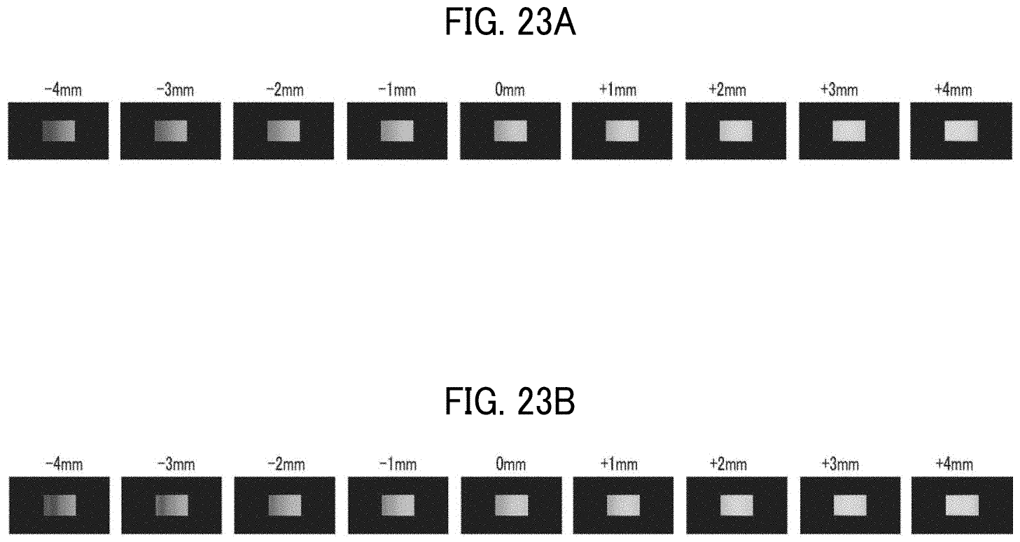

FIG. 23A, which is similar to FIG. 17A, is an illustration of a luminance image for each position within the eye box with the luminance distribution in FIG. 22A, simulated using the ray tracing software. FIG. 23B, which is similar to FIG. 17B, is an illustration of a luminance image for each position within the eye box with the luminance distribution in FIG. 22B, simulated using the ray tracing software.

In FIG. 23A, a luminance image within an eye box farther from the optical entrance 315 has a higher luminance as a whole. In the first embodiment, a luminance sufficient to achieve the intended quality can be obtained at the center position (a position of 0 mm in FIG. 23A) of the eye box by setting the incident angle Ψ₂ of the light ray R₂₀ greater than the critical angle θᵣ and setting the thickness of the partial reflection layer 320 appropriate to perform the intended performance. This allows a luminance image with less uneven luminance and a sufficient amount of luminance at the positions within a range of ±4 mm from the center position of the eye box.

In the first embodiment, as described above, the robustness with respect to the variation in the thickness of the partial reflection layer 320 is high. Such a high robustness allows a luminance image with less uneven luminance and a sufficient amount of luminance, for example, at the positions within a range of ±4 mm from the center position of the eye box, as presented in FIG. 23B, for the partial reflection layers 320 of No. 1 to No. 33 each having a thickness at a pitch equal to or greater than 10 nm.

### Second Embodiment

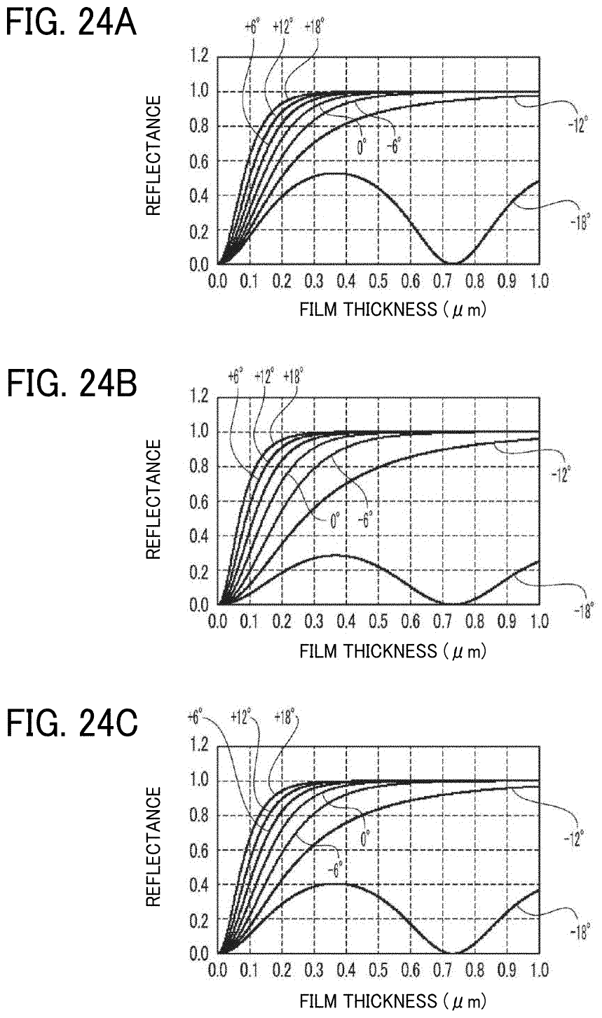

FIGS. 24A to 24C are graphs of the characteristics of the light guide 30 according to the second embodiment. Similar to FIGS. 18A to 18C, FIGS. 24A to 24C are graphs of the relation between the thickness of the partial reflection layer 320 and an image-light reflectance for each angle of view in a range of −18° to +18°. In the second embodiment, the light guide board 310 has a refractive index n₁ of 1.642, and the partial reflection layer 320 has a refractive index n₂ of 1.395. FIG. 24A is a graph of the characteristics of image light, which is S-polarized light having a central wavelength a, of 550 nm. FIG. 24B is a graph of the characteristics of image light, which is P-polarized light having a central wavelength λ of 550 nm. FIG. 24C is a graph of the characteristics of image light, in which S-polarized light and P-polarized light each having a center wavelength a, of 550 nm are uniformly mixed. The light guide board 310 according to the second embodiment is composed of, for example, OKP-1 (Osaka Gas Chemical Co., Ltd.). The partial reflection layer 320 according to the second embodiment is, for example, a single-layer coating film of Poly (22333-pentafluoropropyl methacrylate) manufactured by Merck Co., Ltd., which is a low refractive index polymer.

In the second embodiment as presented in FIGS. 24A to 24C, however, the image-light reflectance periodically changes with the thickness of the partial reflection layer 320, only for the angles of view of the light ray R₁ that have entered the partial reflection layer 320 at an incident angle of less than the critical angle θᵣ. Further, the cycle, or period of change in image-light reflectance in the second embodiment is still longer than that in Comparative Example 1. This means that as the variation in image-light reflectance due to change in the thickness of the partial reflection layer in the second embodiment is smaller than that in Comparative Example 1, robustness with respect to the variation in the thickness of the partial reflection layer is higher that Comparative Example 1.

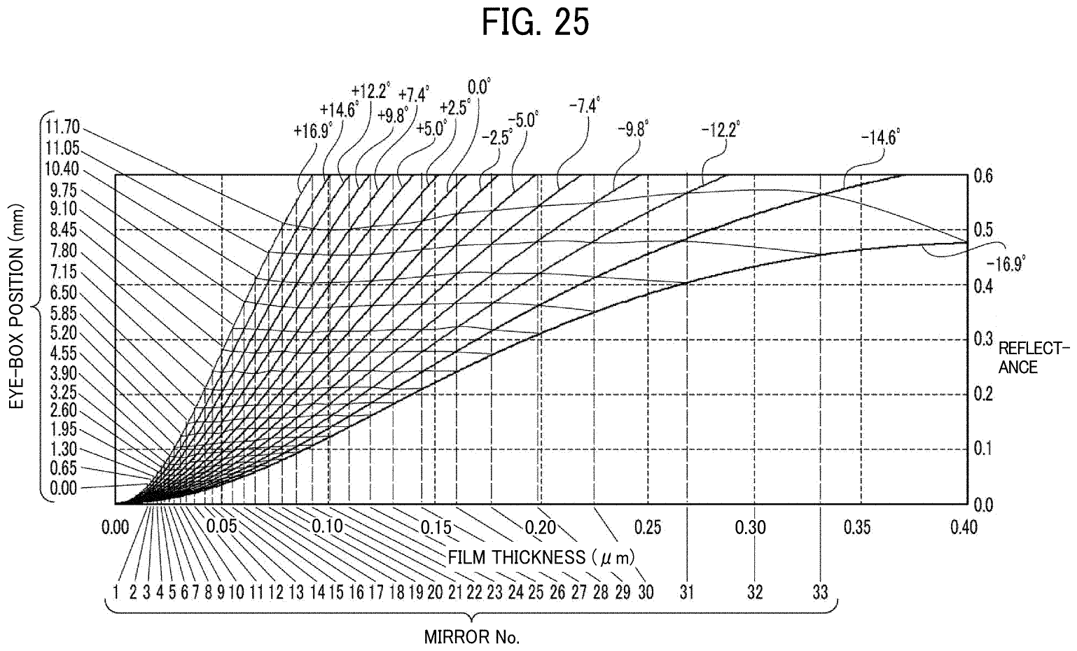

FIG. 25, which is similar to FIG. 19, is a graph of the relation between the thickness of the partial reflection layer 320 and an image-light reflectance for each angle of view in a range of −16.9° to +16.9°, according to the second embodiment. The image light is assumed to be mixed light in which S-polarized light and P-polarized light are uniformly mixed and whose center wavelength λ is 550 nm.

With the partial reflection layers 320 of No. 1 to No. 33 having the thicknesses as presented in FIG. 25, differences in light intensity between the light rays with the angles of view reaching the respective positions in the eye box is reduced unlike with the partial reflection layers 320 have the same thickness. Specifically, with increasing distance to the optical entrance 315, the thickness of the partial reflection layer 320 is increased to reduce a difference in reflectance (image-light reflectance) between the partial reflection layers 320 at which light rays with the angles of view reaching the same eye-box position (i.e., a position in the eye box) are reflected. Thus, a difference in light intensity between the light rays having the respective angles of view is reduced. This further corrects a reduction in light intensity due to the gradual reduction in the amount of the light ray R₁ passing through the light guide board 310 and thus reduces a difference in luminance at each position within the eye box.

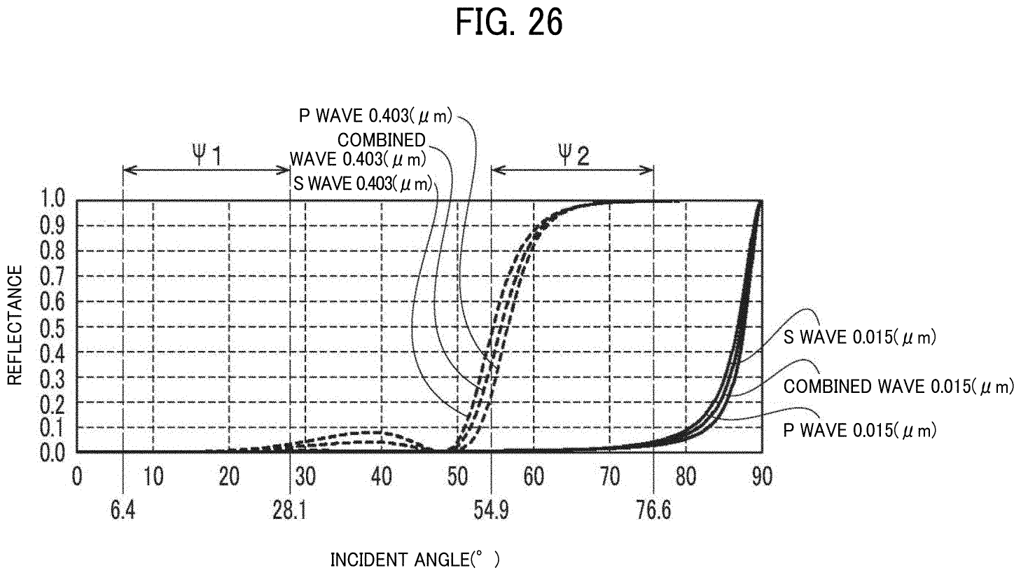

FIG. 26, which is similar to FIG. 20, is a graph of the relation between incident angle (°) on the partial reflection layer 320 and reflectance (normalized by 1) thereof, according to the second embodiment. FIG. 26 presents reflectance of each of the p-wave, the s-wave, and the combined wave thereof, incident on a partial reflection layer 320 of No. 1 having a minimum thickness of 0.015 μm and reflectance of each of the p-wave, the s-wave, and the combined wave, incident on a partial reflection layer 320 of No. 33 having a maximum thickness of 0.403 μm. In FIG. 26, the incident angle Ψ₂ at which light with an angle of view of −18° has been incident on the partial reflection layer 320 is 54.9°. Further, the incident angle Ψ₂ at which light with an angle of view of +18° has struck the partial reflection layer 320 is 76.6°.

In the first embodiment, for the angle of view of −18°, P-polarized light as the image light has a lower image-light reflectance, and the mixed light (of the S-polarized light and the P-polarized light) serving as the image light also has a lower image-light reflectance. For this reason, P-polarized light is not used as image light. In the second embodiment, however, the mixed light of the S-polarized light and the P-polarized light allows a relatively higher image-light reflectance for the angle of view of −18°. In other words, the second embodiment can reduce a difference in light intensity between the light rays having the respective angles of view with the use of the mixed light as image light. Thus, the second embodiment achieves a further increase in light use efficiency.

In the second embodiment, the critical angle θᵣ is 58.17°. The incident angle Ψ₂ at which a light ray corresponding to a light ray having the angle of view of 0° while exiting the light guide 30 entered the partial reflection layer 320 (i.e., the incident angle Ψ₂ corresponding to the light rays R₂₀ having an angle of view of 0° that exits the light guide 30 in a direction normal to the first surface 311) is 65.75°, which is greater than the critical angle θᵣ. As described above, the light use efficiency can be increased by setting the incident angle Ψ₂ of the light ray R₂₀ greater than the critical angle θᵣ and setting the thickness of the partial reflection layer 320 appropriate to perform the intended performance. This further achieves a reduction in a reflectance difference (a difference in image-light reflectance) between the partial reflection layers 320 at which the light rays with the respective angles of view have been reflected before reaching the same eye-box position. Such a reduction in reflectance difference between the partial reflection layers 320 allows a reduction in the luminance difference within a certain angle range from the center of the angle of view (i.e., a position at each angle of view within a luminance image) and also allows a reduction in the luminance difference at each position within the eye box.

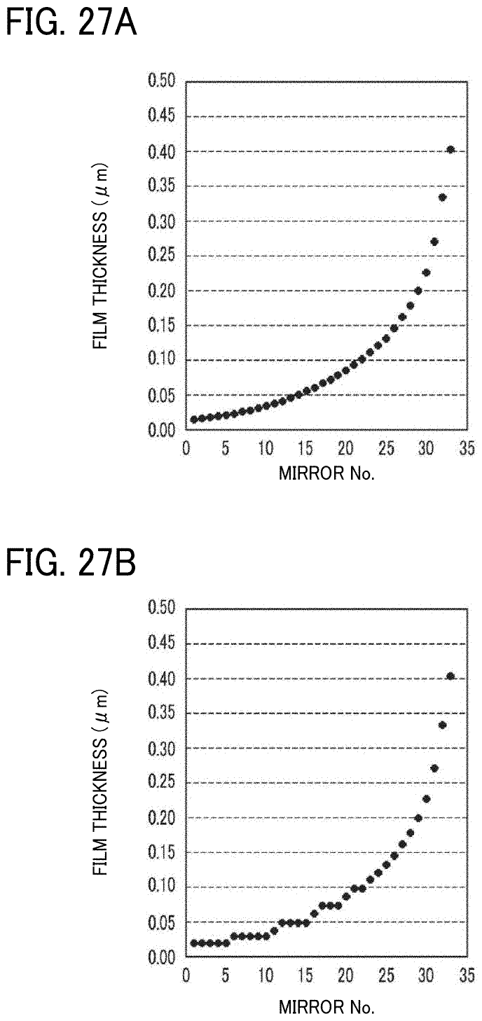

FIG. 27A, which is similar to FIG. 21A, is a graph in which the thicknesses of the partial reflection layers 320 of No. 1 to No. 33 in FIG. 25 are plotted. FIG. 27B, which is similar to FIG. 21B, is a graph in which the thicknesses of the partial reflection layers 320 of No. 1 to No. 33 according to the second embodiment are set with pitches equal to or greater than 10 nm.

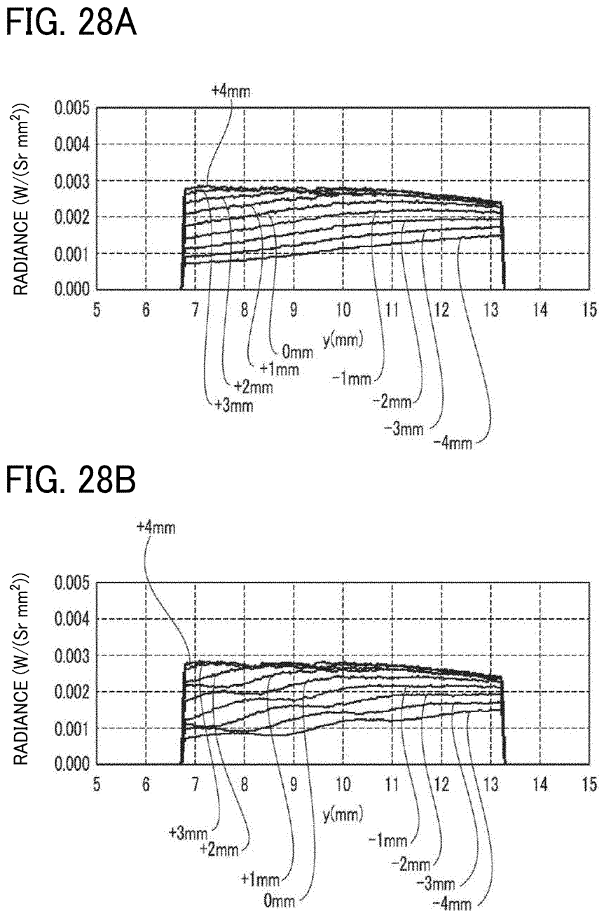

FIGS. 28A and 28B, which are similar to FIGS. 16A and 16B, are graphs of a simulated luminance distribution of light rays converging onto positions ±4 mm from the center of the eye box with a certain width in the horizontal direction (the Y-direction), using ray tracing software. The pupil diameter of the eye of the wearer is assumed to be 3 mm.

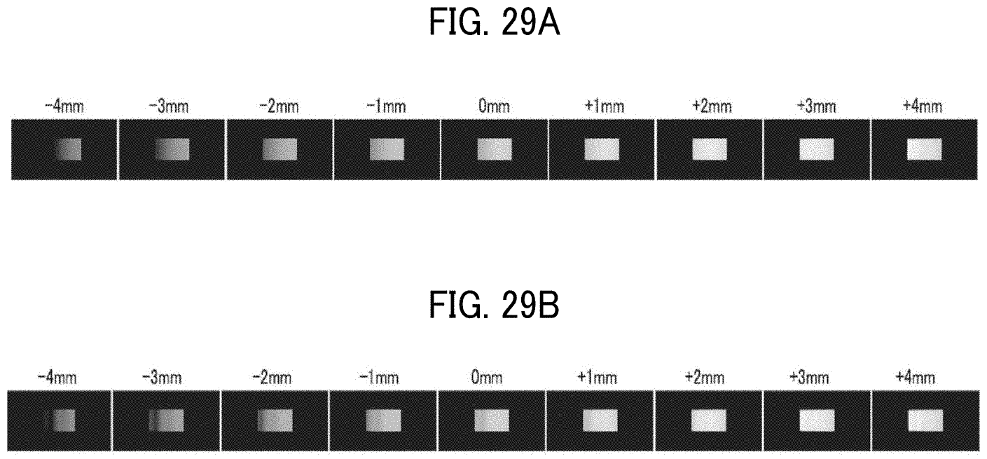

FIG. 29A, which is similar to FIG. 23A, is an illustration of a luminance image for each position within the eye box with the luminance distribution in FIG. 28B, simulated using the ray tracing software. FIG. 29B, which is similar to FIG. 23B, is an illustration of a luminance image for each position within the eye box with the luminance distribution in FIG. 28B, simulated using the ray tracing software.

In FIG. 29A as well, a luminance image within an eye box farther from the optical entrance 315 has a higher luminance as a whole. In the second embodiment as well, a luminance sufficient to achieve the intended quality can be obtained at the center position (a position of 0 mm in FIG. 29A) of the eye box by setting the incident angle Ψ₂ of the light ray R₂₀ greater than the critical angle θᵣ and setting the thickness of the partial reflection layer 320 appropriate to perform the intended performance. This allows a luminance image with less uneven luminance and a sufficient amount of luminance at the positions within a range of ±4 mm from the center position of the eye box.

In the second embodiment, as described above, the robustness with respect to the variation in the thickness of the partial reflection layer 320 is high. Such a high robustness allows a luminance image with less uneven luminance and a sufficient amount of luminance, for example, at the positions within a range of ±4 mm from the center position of the eye box, as presented in FIG. 29B, for the partial reflection layers 320 of No. 2 to No. 33 each having a thickness at a pitch equal to or greater than 10 nm.

In addition to the similar advantageous effects of the first embodiment, the second embodiment can reduce a difference in light intensity between the light rays having the respective angles of view with the use of the mixed light as image light by further lowering the refractive index n₂ of the partial reflection layer 320 relative to the refractive index n₁ of the light guide board 310. The second embodiment using the mixed light achieves a further increase in light use efficiency.

### Third Embodiment

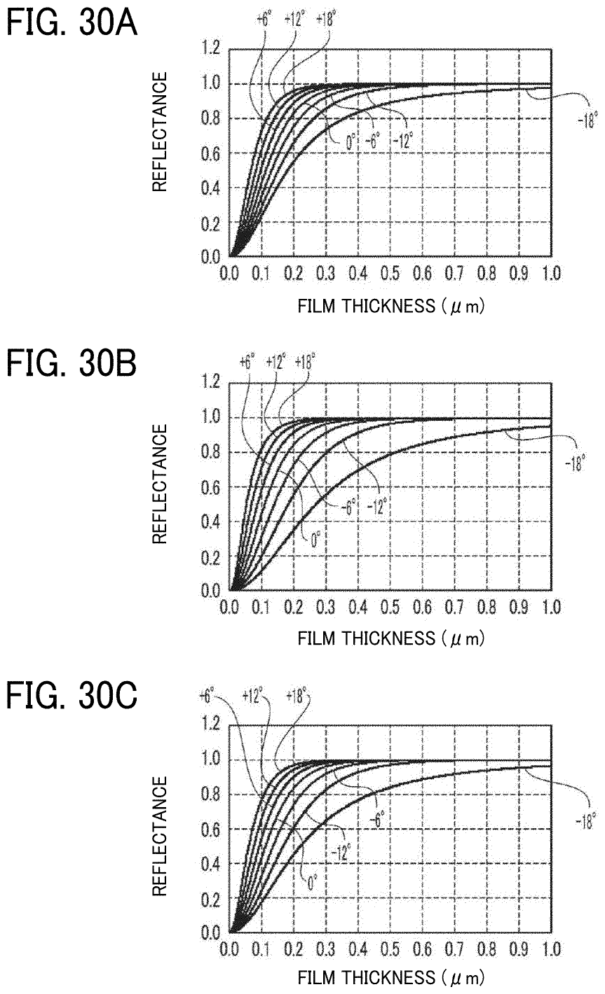

FIGS. 30A to 30C are graphs of the characteristics of the light guide 30 according to the third embodiment. Similar to FIGS. 24A to 24C, FIGS. 30A to 30C are graphs of the relation between the thickness of the partial reflection layer 320 and an image-light reflectance for each angle of view in a range of −18° to +18°. In the third embodiment, the light guide board 310 has a refractive index n₁ of 1.642, and the partial reflection layer 320 has a refractive index n₂ of 1.340. FIG. 30A is a graph of the characteristics of image light, which is S-polarized light having a central wavelength λ of 550 nm. FIG. 30B is a graph of the characteristics of image light, which is P-polarized light having a central wavelength λ of 550 nm. FIG. 30C is a graph of the characteristics of image light, in which S-polarized light and P-polarized light each having a center wavelength λ of 550 nm are uniformly mixed.

The light guide board 310 according to the third embodiment is composed of, for example, OKP-1 (Osaka Gas Chemical Co., Ltd.). The partial reflection layer 320 according to the third embodiment is, for example, a single-layer coating film of porous silica.

In the third embodiment, the incident angles Ψ₂ corresponding to the respective angles of view in a range of −18° to +18° are greater than the critical angle θᵣ. In such a configuration, the image-light reflectance does not periodically change with the thickness of the partial reflection layer for any angle of view in the range of −18° to +18°. The third embodiment facilitates adjustment of the image-light reflectance in the light guide board 310 according to the Y-directional position of a corresponding partial reflection layer 320 and a corresponding angle of view, more than the first embodiment and the second embodiment, by adjusting the thickness of each partial reflection layer 320. This further can reduce luminance differences between the angles of view in a virtual image at the eye-box positions. Such a reduction in luminance differences between the angles of view in a virtual image achieves a higher light use efficiency.

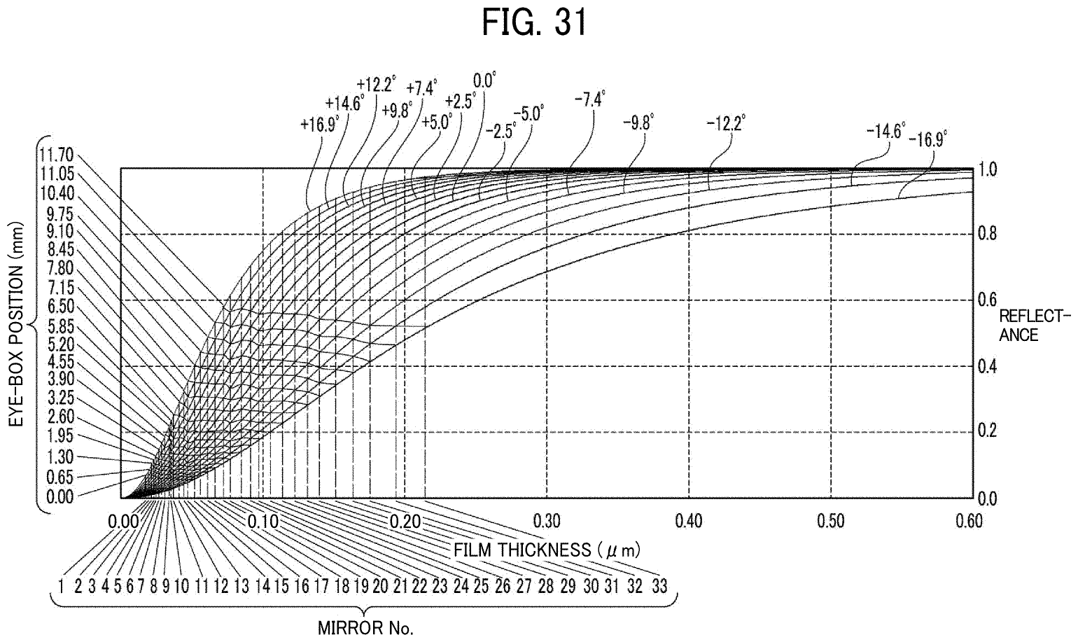

FIG. 31, which is similar to FIG. 25, is a graph of the relation between the thickness of the partial reflection layer 320 and an image-light reflectance for each angle of view in a range of −16.9° to +16.9°, according to the third embodiment. The image light is assumed to be mixed light in which S-polarized light and P-polarized light are uniformly mixed and whose center wavelength λ is 550 nm.

With the partial reflection layers 320 of No. 1 to No. 33 having the thicknesses as presented in FIG. 31, differences in light intensity between the light rays with the angles of view reaching the respective positions in the eye box is reduced unlike with the partial reflection layers 320 have the same thickness. Specifically, with increasing distance to the optical entrance 315, the thickness of the partial reflection layer 320 is increased to reduce a difference in reflectance (image-light reflectance) between the partial reflection layers 320 at which light rays with the angles of view reaching the same eye-box position (i.e., a position in the eye box) are reflected. Thus, a difference in light intensity between the light rays having the respective angles of view is reduced. This further corrects a reduction in light intensity due to the gradual reduction in the amount of the light ray R₁ passing through the light guide board 310 and thus reduces a difference in luminance at each position within the eye box.

In the third embodiment, however, the mixed light of the S-polarized light and the P-polarized light allows a higher image-light reflectance for the angle of view of −18°. In other words, the third embodiment can reduce a difference in light intensity between the light rays having the respective angles of view with the use of the mixed light as image light. Thus, the second embodiment achieves a further increase in light use efficiency.

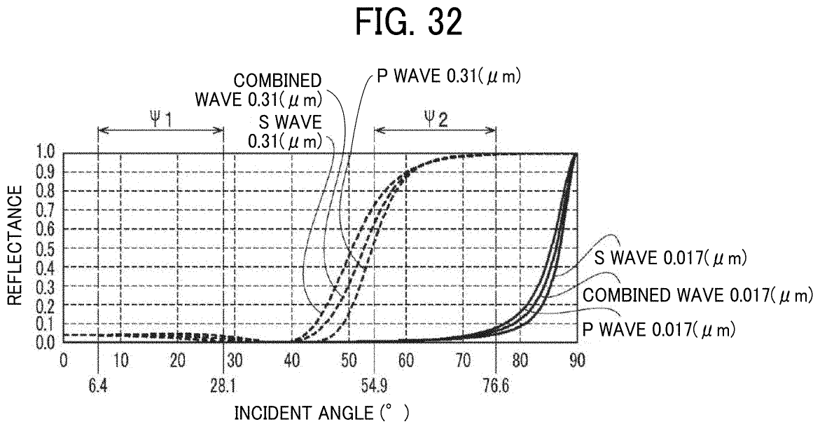

FIG. 32, which is similar to FIG. 26, is a graph of the relation between incident angle (°) on the partial reflection layer 320 and reflectance (normalized by 1) thereof, according to the third embodiment. FIG. 32 presents reflectance of each of the p-wave, the s-wave, and the combined wave thereof, incident on a partial reflection layer 320 of No. 1 having a minimum thickness of 0.017 μm and reflectance of each of the p-wave, the s-wave, and the combined wave, incident on a partial reflection layer 320 of No. 33 having a maximum thickness of 0.31 μm. In FIG. 32, the incident angle Ψ₂ at which light with an angle of view of −18° has been incident on the partial reflection layer 320 is 54.9°. Further, the incident angle Ψ₂ at which light with an angle of view of +18° has struck the partial reflection layer 320 is 76.6°.

In the third embodiment, the critical angle θᵣ is 54.7°. The incident angle Ψ₂ at which a light ray corresponding to a light ray having an angle of view 0° is incident on the partial reflection layer 320 (i.e., the incident angle Ψ₂ corresponding to the light ray R₂₀ having an angle of view of 0°) is 65.75°, which is greater than the critical angle θᵣ. As described above, the light use efficiency can be increased by setting the incident angle Ψ₂ of the light ray R₂₀ greater than the critical angle θᵣ and setting the thickness of the partial reflection layer 320 appropriate to perform the intended performance. This further achieves a reduction in a reflectance difference (a difference in image-light reflectance) between the partial reflection layers 320 at which the light rays with the respective angles of view have been reflected before reaching the same eye-box position. Such a reduction in reflectance difference between the partial reflection layers 320 allows a reduction in the luminance difference within a certain angle range from the center of the angle of view (i.e., a position at each angle of view within a luminance image) and also allows a reduction in the luminance difference at each position within the eye box.

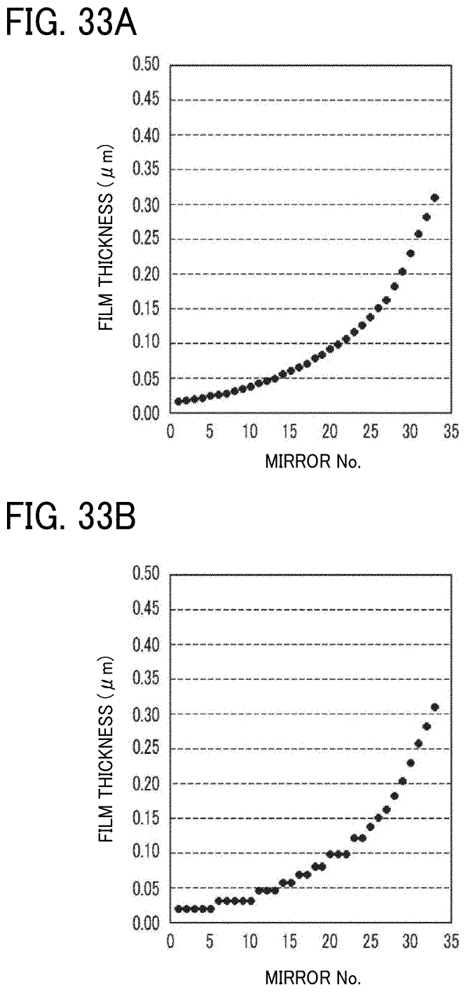

FIG. 33A, which is similar to FIG. 27A, is a graph in which the thicknesses of the partial reflection layers 320 of No. 1 to No. 33 in FIG. 31 are plotted. FIG. 33B, which is similar to FIG. 27B, is a graph in which the thicknesses of the partial reflection layers 320 of No. 1 to No. 33 according to the third embodiment are set with pitches equal to or greater than nm.

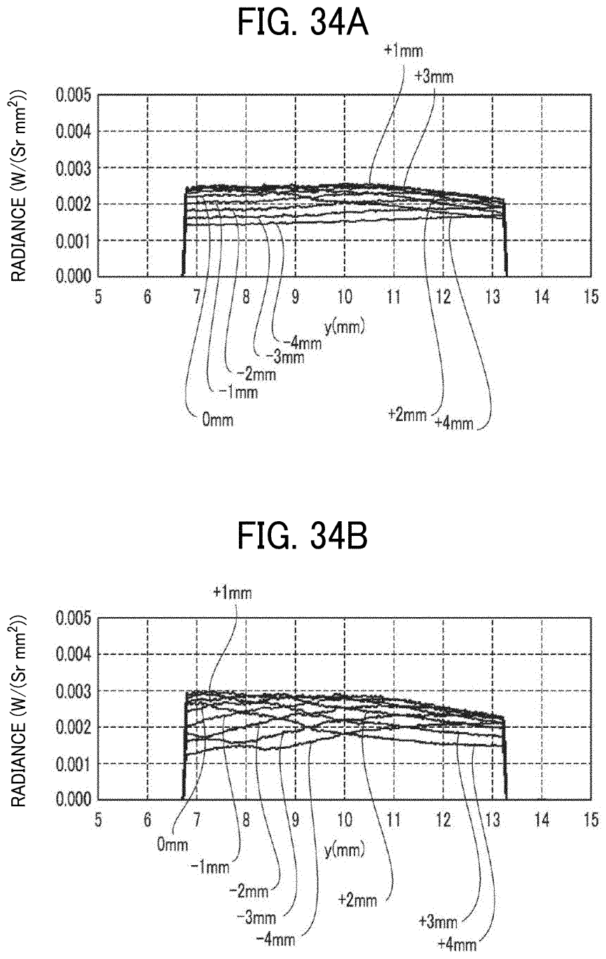

FIGS. 34A and 34B, which are similar to FIGS. 28A and 28B, are graphs of a simulated luminance distribution of light rays converging onto positions ±4 mm from the center of the eye box with a certain width in the horizontal direction (the Y-direction), using ray tracing software. The pupil diameter of the eye of the wearer is assumed to be 3 mm.

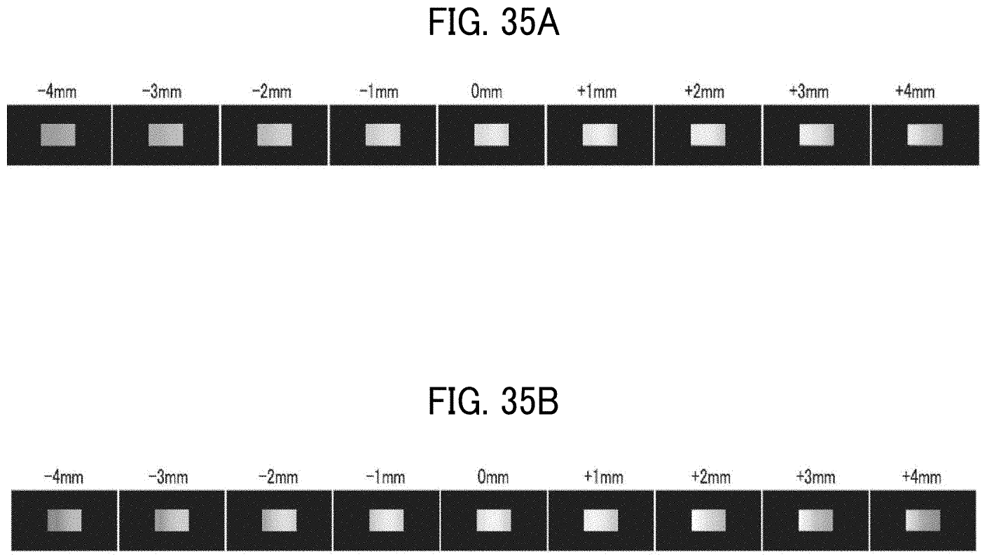

FIG. 35A, which is similar to FIG. 29A, is an illustration of a luminance image for each position within the eye box with the luminance distribution in FIG. 34A, simulated using the ray tracing software. FIG. 35B, which is similar to FIG. 29B, is an illustration of a luminance image for each position within the eye box with the luminance distribution in FIG. 34B, simulated using the ray tracing software.

In FIG. 35A, a luminance image for a position closer to the center position (the position of 0 mm in FIG. 35A) of the eye box has a higher luminance as a whole. In the third embodiment as well, a luminance sufficient to achieve the intended quality can be obtained at the center position of the eye box by setting the incident angle Ψ₂ of the light ray R₂₀ greater than the critical angle θr and setting the thickness of the partial reflection layer 320 appropriate to perform the intended performance. This allows a luminance image with less uneven luminance and a sufficient amount of luminance at the positions within a range of ±4 mm from the center position of the eye box.

In the third embodiment, as described above, the robustness with respect to the variation in the thickness of the partial reflection layer 320 is high. Such a high robustness allows a luminance image with less uneven luminance and a sufficient amount of luminance, for example, at the positions within a range of ±4 mm from the center position of the eye box, as presented in FIG. 35B, for the partial reflection layers 320 of No. 3 to No. 33 each having a thickness at a pitch equal to or greater than 10 nm.

In addition to the similar advantageous effects of the first embodiment, the third embodiment can reduce a difference in light intensity between the light rays having the respective angles of view with the use of the mixed light as image light by further lowering the refractive index n₂ of the partial reflection layer 320 relative to the refractive index n₁ of the light guide board 310. The second embodiment using the mixed light achieves a further increase in light use efficiency.

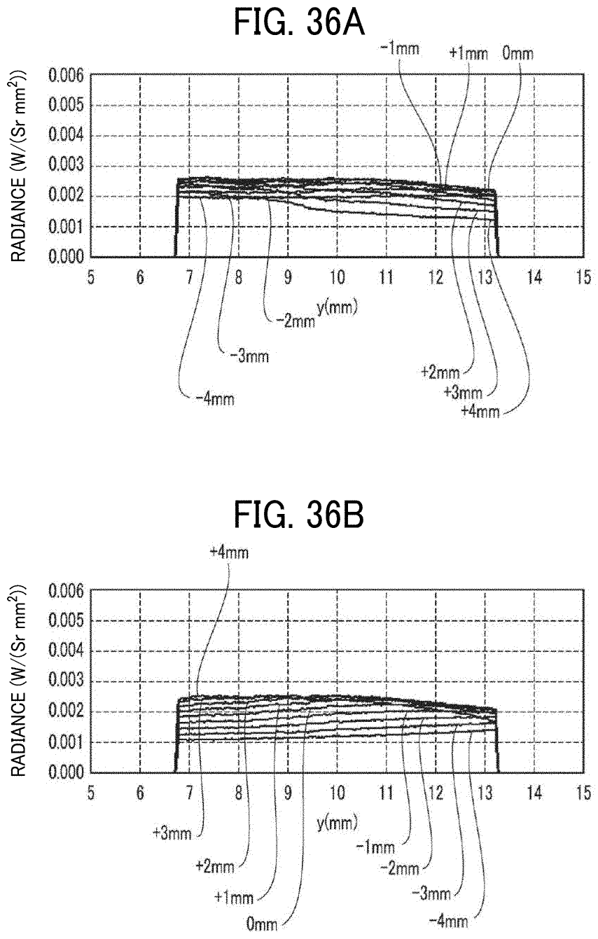

FIG. 36A, which is similar to FIG. 34A, is a graph of simulation results for image light, in which S-polarized light and P-polarized light each having a center wavelength λ of 450 nm are uniformly mixed, according to the third embodiment. FIG. 36B, which is similar to FIG. 34A, is a graph of simulation results for image light, in which S-polarized light and P-polarized light each having a center wavelength λ of 650 nm are uniformly mixed, according to the third embodiment.

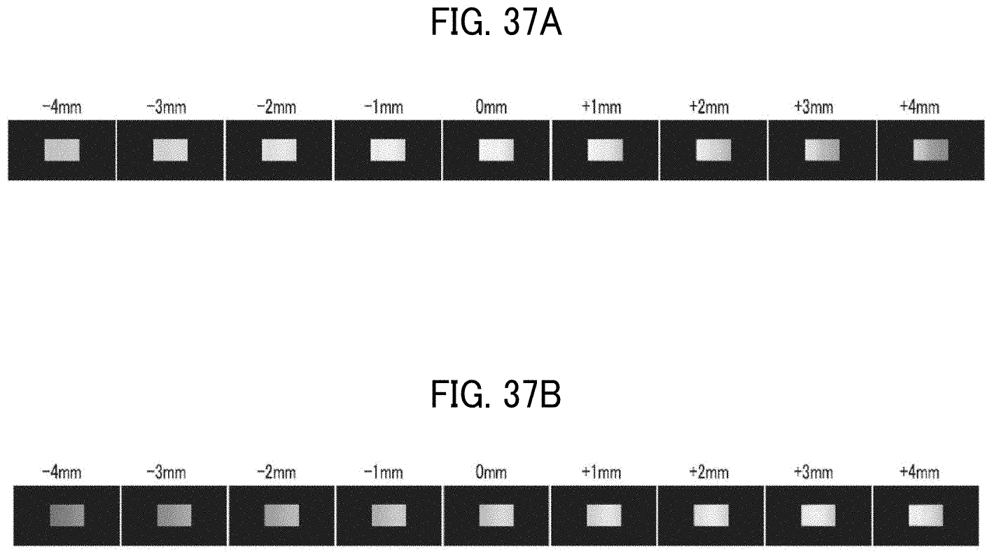

FIG. 37A, which is similar to FIG. 35A, is an illustration of a luminance image for each position within the eye box with the luminance distribution in FIG. 36B, simulated using the ray tracing software. FIG. 37B, which is similar to FIG. 35A, is an illustration of a luminance image for each position within the eye box with the luminance distribution in FIG. 36B, simulated using the ray tracing software.

As illustrated in FIG. 37A, blue light (B light) having a wavelength of 450 nm as the image light allows a luminance image with less uneven luminance and a sufficient amount of luminance at the positions within a range of ±4 mm from the center position (the position of 0 mm in FIG. 37A) of the eye box, similarly to green light (G light) having a wavelength of 550 nm (see FIG. 35A). As presented in FIG. 37B, red light (R light) having a wavelength of 650 nm as the image light allows a luminance image with less uneven luminance and a sufficient amount of luminance at the positions within a range of ±4 mm from the center position of the eye box, similarly to green light (G light) having a wavelength of 550 nm (see FIG. 35A).

The third embodiment allows an RGB (red, green, blue) color image with less uneven luminance and a sufficient amount of luminance at the positions within a range of ±4 mm from the center position of the eye box.

### Supplementary Explanation of Differences Between the First to Third Embodiments and Comparative Example 1

In the brightness of a room such as an office, the pupil diameter of a human is about 3 mm. If the intensity of light at each angle of view falling within the pupil diameter of 3 mm in the eye box is uniform, luminance unevenness (luminance differences) does not occur in the virtual image. For this reason, it can be seen that the occurrence of luminance unevenness can be reduced even when the thickness of the partial reflection layer 320 is set at a pitch of 10 nm or greater if the difference in the moving average of the thickness of the partial reflection layer 320 within the range of ±1.5 mm between the thickness at a pitch of several nanometers and the thickness at a pitch of 10 nm or greater is small.

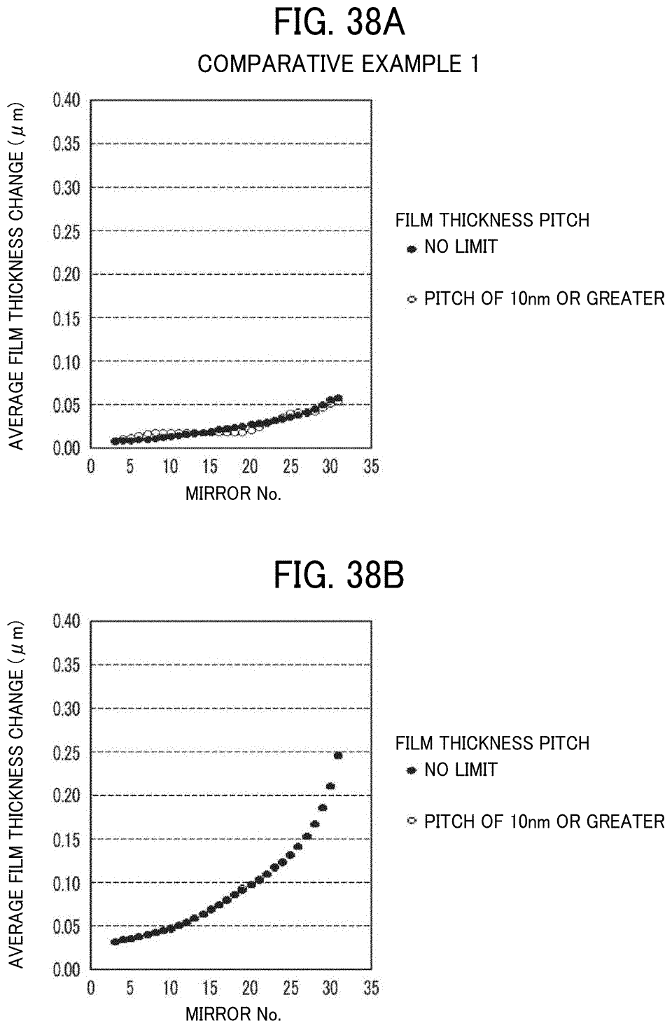

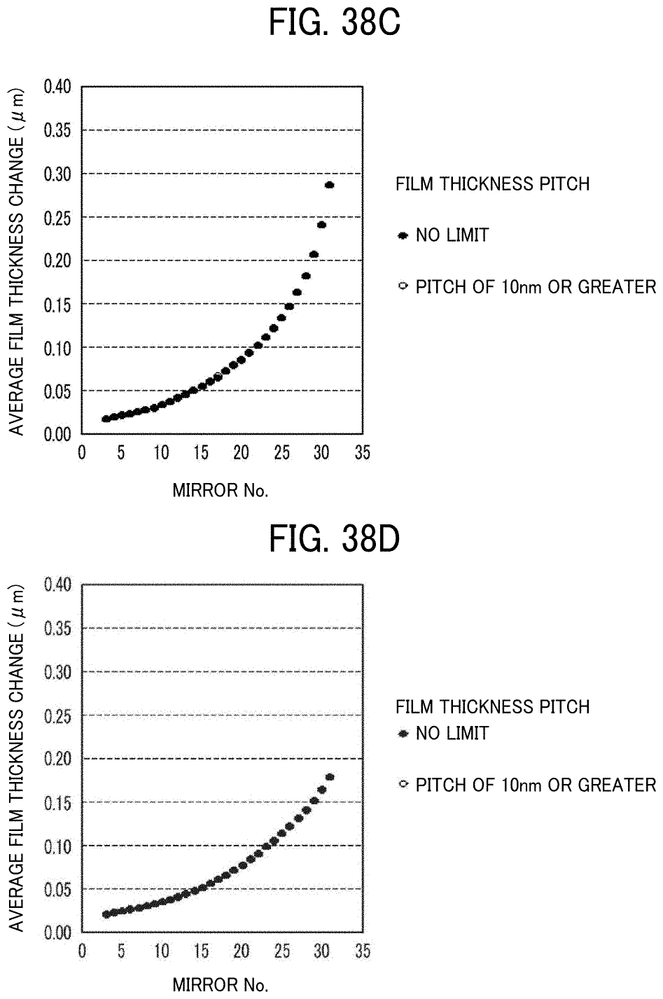

FIGS. 38A to 38D present the moving average of thickness of the partial reflection layer 320 in the range of 1.5 mm. In FIGS. 38A to 38D, the vertical axis represents the moving average (μm), and the horizontal axis represents the number (mirror No.) of the partial reflection layer 320. FIG. 38A is a graph of the moving average (denoted as “NO LIMIT”) of each thickness presented in FIG. 15A and the moving average (denoted as “PITCH OF 10 NM OR GREATER”) of each thickness presented in FIG. 15B, according to Comparative Example 1. FIG. 38B is a graph of the moving average of each thickness presented in FIG. 21A and the moving average of each thickness presented in FIG. 21B, first embodiment. FIG. 38C is a graph of the moving average of each thickness presented in FIG. 27A and the moving average of each thickness presented in FIG. 27B, second embodiment. FIG. 38D is a graph of the moving average of each thickness presented in FIG. 33A and the moving average of each thickness presented in FIG. 33B, third embodiment.

As presented in FIGS. 38A to 38D, only in Comparative Example 1, the difference in the moving average between the thickness set at a pitch of several nanometers and the thickness set at a pitch of 10 nm or greater is significant. Comparative Example 1 with such a significant difference in moving average causes more significant luminance unevenness than those in the first embodiment to the third embodiment with a slight difference in the moving average between the thickness set at a pitch of several nanometers and the thickness set at a pitch of 10 nm or greater (see FIG. 17B).

### Example 4

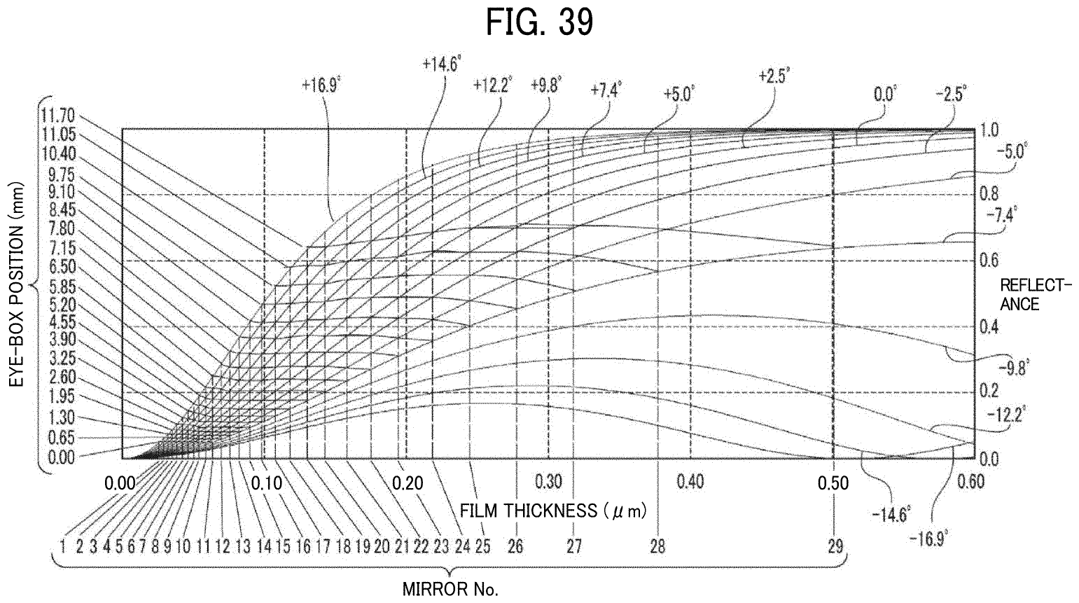

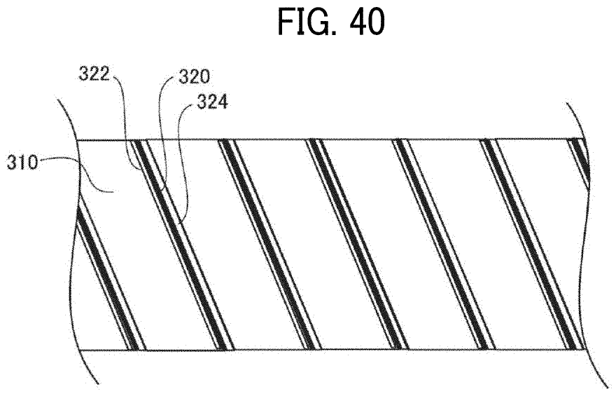

FIG. 39, which is similar to FIG. 31, is a graph of the relation between the thickness of the partial reflection layer 320 and an image-light reflectance for each angle of view in a range of −16.9° to +16.9°, according to the fourth embodiment. The image light is assumed to be mixed light in which S-polarized light and P-polarized light are uniformly mixed and whose center wavelength λ is 550 nm.

Notably, the light guide 30 according to the fourth embodiment has the same configuration as that of the light guide 30 of the first embodiment except that the fourth embodiment uses 29 partial reflection layers 320 of No. 1 to No. 29 and that the partial reflection layer 320 has the respective thickness presented in FIG. 39.

With the partial reflection layers 320 of No. 1 to No. 29 having the thicknesses as presented in FIG. 39, differences in light intensity between the light rays with the angles of view reaching the respective positions in the eye box is reduced unlike with the partial reflection layers 320 have the same thickness. Specifically, with increasing distance from a partial reflection layer 320 to the optical entrance 315, the thickness of the partial reflection layer 320 is increased to allow an increase in the image-light reflectance for the angles of view close to −18°. Thus, the difference in light intensity between the light rays having the respective angles of view can be reduced. This further corrects a reduction in light intensity due to the gradual reduction in the amount of the light ray R₁ passing through the light guide board 310 and thus reduces a difference in luminance at each position within the eye box.

In the fourth embodiment, the mixed light of the S-polarized light and the P-polarized light, as the image light, allows image-light reflectances substantially equal to each other for the angles of view in a range of −7.4° to +16.9°. In at least the range of −7.4° to +16.9°, a luminance image with a high luminance can be obtained at each position within the eye box.

Adhesive Layer and Primer Layer

Examples of a method of manufacturing the light guide 30 include the following. First, a primer layer is formed over the entire surface of an optical block forming the light guide board 310. Next, the partial reflective layer 320 is formed over the primer layer formed over the entire surface of the optical block. The optical blocks on which the partial reflection layers 320 are formed are joined together with an adhesive to produce the light guide 30 including the light guide board 310 in which multiple partial reflection layers 320 are arranged.

FIG. 40 is an enlarged view of such a produced light guide 30. As illustrated in FIG. 40, the partial reflection layer 320 is between a primer layer 322 and an adhesive layer 324. Forming the partial reflection layer 320 after forming the primer layer 322 allows a higher adhesion of the partial reflection layer 320.

The primer layer 322 may not be included depending on materials of the light guide board 310 and the partial reflection layer 320. The configuration with the primer layer 322 eliminated from FIG. 40 is within the scope of the present invention.

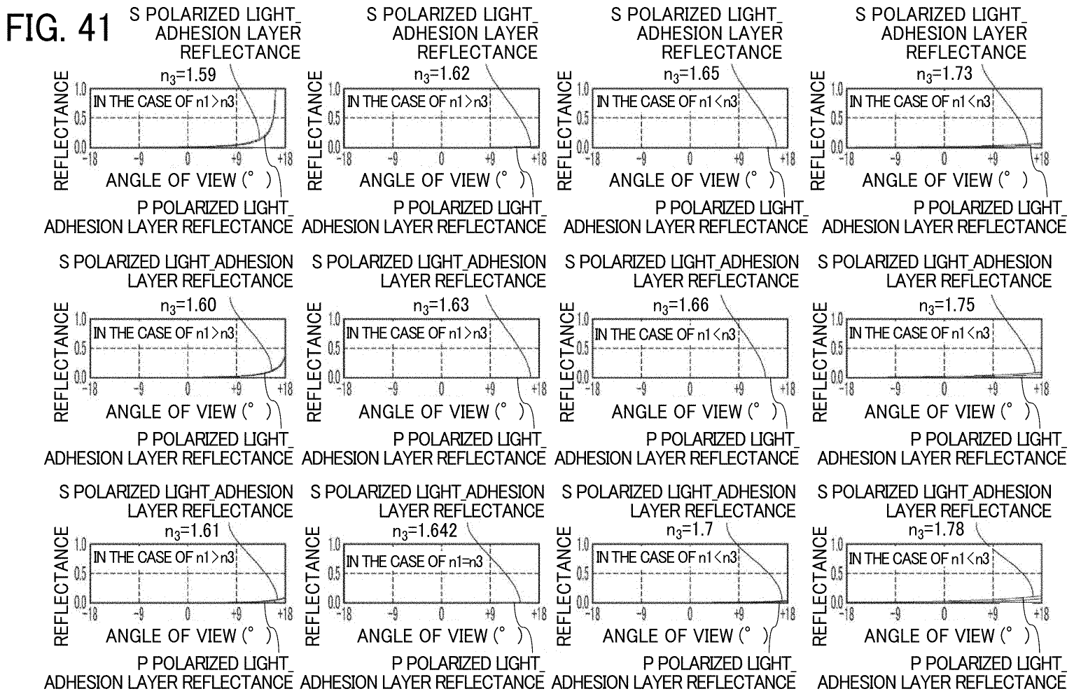

FIG. 41 is a collection of graphs of the relation between the refractive index n₃ of an adhesive layer 324 and the reflectance of light having each angle of view at the interface between the light guide board 310 and the adhesive layer 324. FIG. 41 presents reflectance of each of P-polarized light and S-polarized light. In FIG. 41, the reflectance of the P-polarized light at the interface is referred to as P-polarized light_adhesive layer reflectance, and the reflectance of the S-polarized light at the boundary surface is referred to as S-polarized light_adhesive layer reflectance. In FIG. 41, the vertical axis of each graph represents the reflectance (normalized by 1), and the horizontal axis represents the angle of view (°). In FIG. 41, the light guide 30 according to the first embodiment further includes the adhesive layer 324. The refractive index n₁ of the light guide board 310 is 1.642.

FIG. 41 demonstrates that, with a refractive index n₃ of 1.61 or less, the reflectance on the interface between the light guide board 310 and the adhesive layer 324, for each angle of view close to −18° and +18°, is large.

The relation between the refraction index n₃ of the adhesive layer 324 and the reflectance of each of P-polarized light and S-polarized light for an angle of view of +18° is as follows.

n₃=1.62:

Reflectance of P-polarized light=0.024, Reflectance of S-polarized light=0.028

n₃=1.63:

Reflectance of P-polarized light=0.0051, Reflectance of S-polarized light=0.0062

n₃=1.65:

Reflectance of P-polarized light=0.00136, Reflectance of S-polarized light=0.00174

n₃=1.66:

Reflectance of P-polarized light=0.0056, Reflectance of S-polarized light=0.0073

n₃=1.627:

Reflectance of P-polarized light=0.0088, Reflectance of S-polarized light=0.011

n₃=1.664:

Reflectance of P-polarized light=0.0078, Reflectance of S-polarized light=0.010

With the refraction index n₃ of the adhesive layer 324 in the range of 1.627 to 1.664, the reflectivity of the P-polarized light for the angle of view +18° at the interface between the light guide board 310 and the adhesive layer 324 can be set to 0.88% or less, and the reflectivity of the S-polarized light therefor can be set to 1.1% or less. Further, with the refraction index n₃ of the adhesive layer 324 in the range of 1.627 to 1.664, the average of the reflectivity of the P-polarized light and the S-polarized light for the angle of view +18° at the interface between the light guide board 310 and the adhesive layer 324 can be set to 0.99% or less. When the reflectance at the interface between the light guide board 310 and the adhesive layer 324 exceeds 1%, multiple reflection occurs between the partial reflection layer 320 and the boundary surface between the light guide board 310 and the adhesive layer 324, possibly causing a significant change in the characteristics of the light guide board 30. To avoid such a significant change in the characteristics of the light guide board 30, the refractive index n₃ of the adhesive layer 324 is preferably greater than or equal to 1.627 and less than or equal to 1.664. Since the refractive index n₁ of the light guide board 310 is 1.642, the absolute value of the difference between n₁ and n₃ is preferably smaller than 0.015.

With an increasing difference between the refractive index n₁ and the refractive index n₃, reflection of light more likely occur at the interface between the light guide board 310 and the adhesive layer 324. Further, with an increasing difference between the refractive index n₁ and the refractive index n₃, variations in reflectance and transmittance of light incident on the partial reflection layer 320 due to the difference between the refractive indices n₁ and n₃ increases. In such a case as well, the characteristics of the light guide 30 may be significantly changed. In view of this, the difference between the refractive index n₁ and the refractive index n₃ is to be reduced. Specifically, the absolute value of the difference in refractive index being less than 0.015, which satisfies formula (5), reduces the occurrence of reflection of light and the variations in reflectance and transmittance as described above.

The same applies to the primer layer 322 as to the adhesive layer 324.

However, the primer layer 322 or the adhesive layer 324 having a higher thickness causes a variation in the angle at which the light ray R₂ exits the light guide board 310 through the first surface 311 and thus possibly causes ghost or degrades the resolution. To deal with such circumstances, the primer layer 322 and the adhesive layer 324 each have a thickness of 10 μm or less, for example. With such a certain layer, the occurrence of ghost or a reduction in resolution is prevented or reduced.

### Fifth Embodiment

In the above-described embodiments, the angle of views of virtual images for the respective positions in the eye box are symmetrical in the horizontal direction. In the fifth embodiments, however, the angle of views of virtual images for the respective positions in the eye box are asymmetrical in the horizontal direction. Notably, the symmetrical angles of views refer to angles of view in which whose an absolute value of the maximum angle of view in the negative direction is equal to an absolute value of the minimum angle of view in the positive direction (e.g., −18°, +18°), whereas the asymmetrical angles of view refer to angles of view in which an absolute value of the maximum angle of view in the negative direction differs from an absolute value of the minimum angle of view in the positive direction.

FIG. 42 is an illustration of the light rays having the angles of view converging at a position of 11.7 mm in the eye box, according to the fifth embodiment. The light rays having the angles of view in FIG. 42 have exited the light guide board 310 through the first surface 311 after reflecting off the partial reflection layers 320 of No. 19 to No. 33, respectively. The partial reflection layers 320 of No. 19 to No. 33 correspond to the angles of view of the light rays converging at the position of 11.7 mm as follows.

No. 19: +19.1°

No. 20: +16.9°

No. 21: +14.6°

No. 22: +12.20

No. 23: +9.8°

No. 24: +7.4°

No. 25: +5.0°

No. 26: +2.5°

No. 27: +0.0°

No. 28: −2.5°

No. 29: −5.0°

No. 30: −7.4°

No. 31: −9.8°

No. 32: −12.2°

No. 33: −14.6°

In the fifth example embodiment, among the light rays exiting the light guide board 310 from the respective positions on the first surface 311 to reach the eyes (the eye box) of the observer (the wearer or the user), a first light ray R_{2N} exits the light guide board 310 from a position closest to the optical entrance 315 toward the eyes. A second light ray R_{2F} exists the light guide board 310 from a position farthest from the optical entrance 315 toward the eyes. More specifically, the first light ray R_{2N} has exited the light guide board 310 through the first surface 311 after reflecting off the partial reflection layer 320 of No. 19. Further, the second light ray R_{2F} has exited the light guide board 310 through the first surface 311 after reflecting off the partial reflection layer 320 of No. 33. The first angle θ_{3N} is an angle between the first light ray R_{2N} and the normal to the first surface 311, and the second angle θ_{3F} is an angle between the second light ray R_{2F} and the normal to the first surface 311.

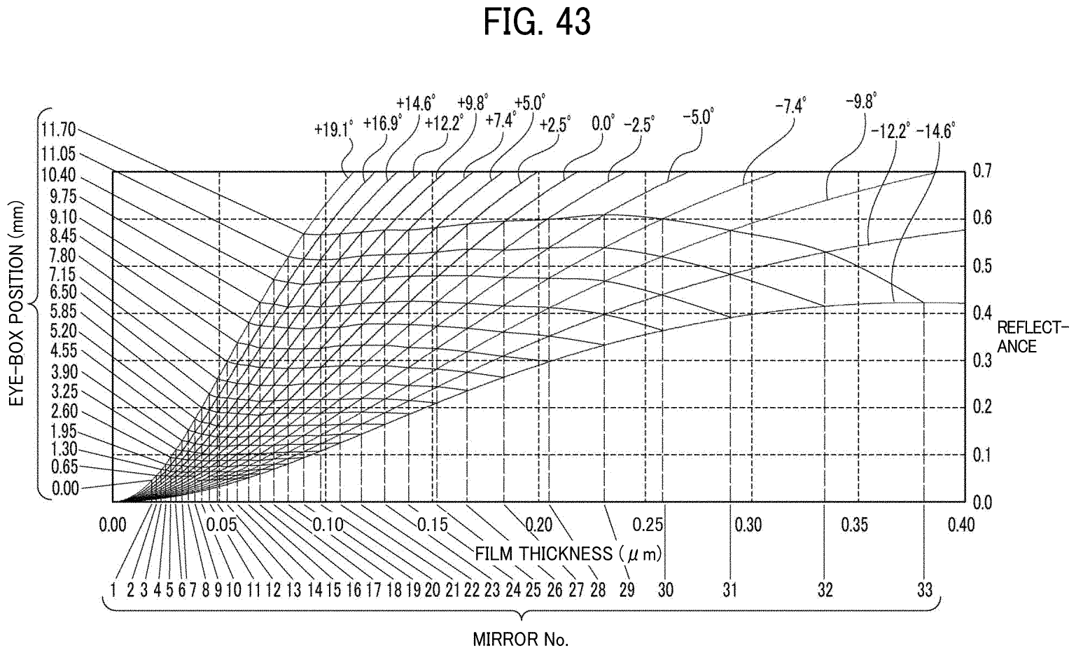

FIG. 43, which is similar to FIG. 39, is a graph of the relation between the thickness of the partial reflection layer 320 and an image-light reflectance for each angle of view in a range of −14.6° to +19.1°, according to the fifth embodiment. The image light is assumed to be mixed light in which S-polarized light and P-polarized light are uniformly mixed and whose center wavelength λ is 550 nm.

Notably, the light guide 30 according to the fifth embodiment has the same configuration as that of the light guide 30 of the first embodiment except that in the fifth embodiment, the angles of view are asymmetrical in the horizontal direction; the refractive index n₁ of the light guide board 310 is 1.680; and the partial reflection layers 320 have the thicknesses presented in FIG. 43. The light guide board 310 according to the fifth embodiment is composed of, for example, Yupizeta (registered trademark) EP-10000 (Mitsubishi Gas Chemical Co., Ltd.).

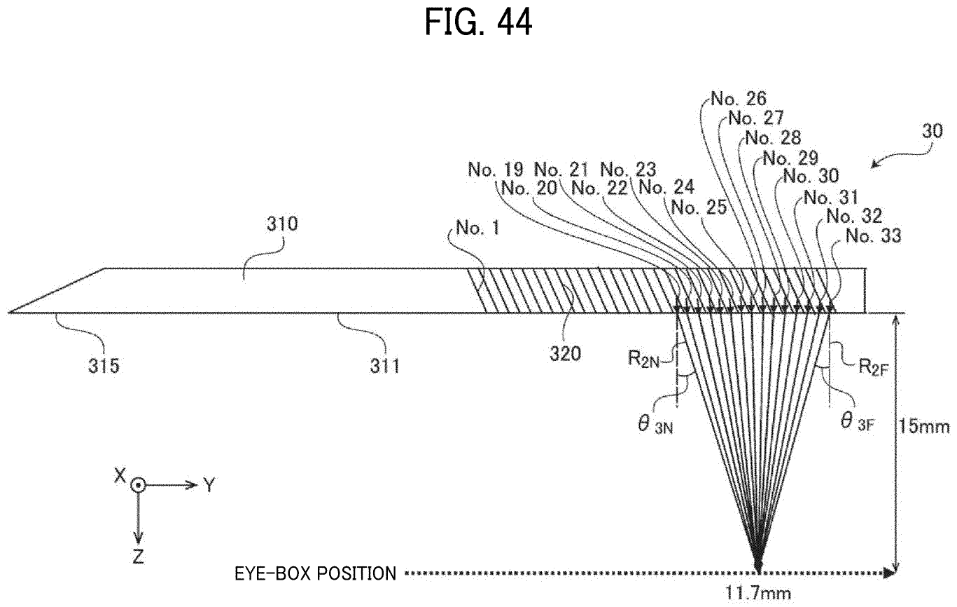

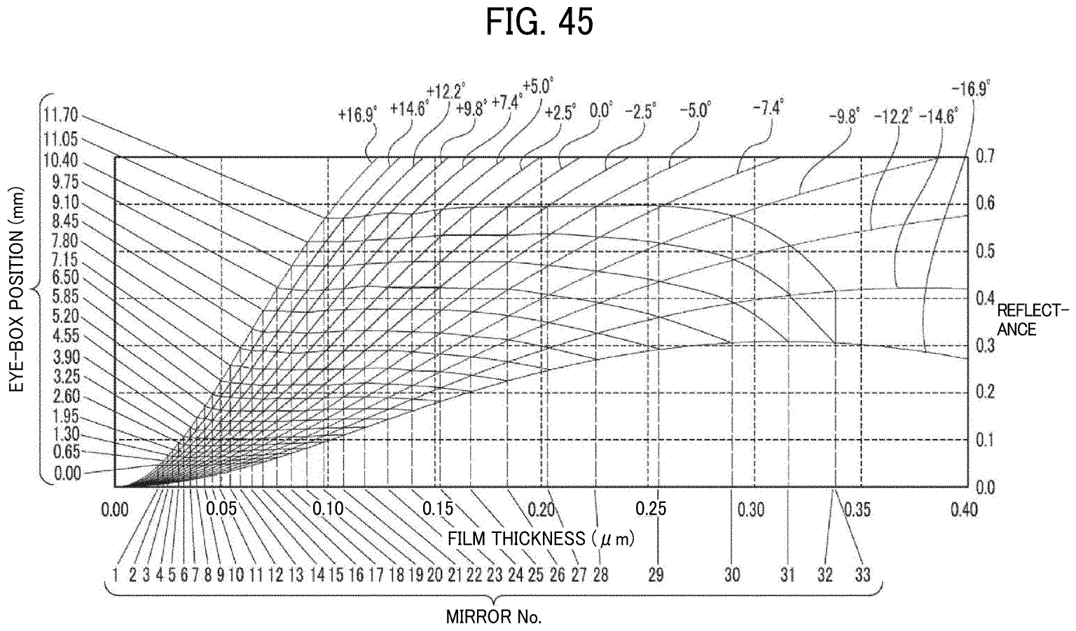

FIGS. 44 and 45 are illustrations of a configuration of a reference embodiment for explaining effects obtained by the angles of view of the virtual images corresponding to the positions in the eye box being asymmetrical in the horizontal direction. FIGS. 44 and 45 are similar to FIGS. 42 and 43, respectively.

The light guide 30 according to the reference embodiment has a configuration in which the angles of view of the virtual images corresponding to the positions in the eye box are symmetrical in the horizontal direction, similarly to the first embodiment. The width of the angle of view is substantially the same between the fifth embodiment and the reference embodiment.

As illustrated in FIG. 44, the partial reflection layers 320 of No. 19 to No. 33 correspond to the angles of view of the light rays converging at the position of 11.7 mm as follows.

No. 19: +16.9°

No. 20: +14.6°

No. 21: +12.2°

No. 22: +9.8°

No. 23: +7.4°

No. 24: +5.0°

No. 25: +2.5°

No. 26: +0.0°

No. 27: −2.5°

No. 28: −5.0°

No. 29: −7.4°

No. 30: −9.8°

No. 31: −12.2°

No. 32: −14.6°

No. 33: −16.9°

FIG. 45 is a graph of the relation between the thickness of the partial reflection layer and an image-light reflectance for each angle of view in a range of −16.9° to +16.9°, according to a reference embodiment. The image light is assumed to be mixed light in which S-polarized light and P-polarized light are uniformly mixed and whose center wavelength) is 550 nm.

Notably, the light guide 30 according to the reference embodiment has the same configuration as that of the light guide 30 of the fifth embodiment except that in the fifth embodiment, the angles of view are symmetrical in the horizontal direction; and the partial reflection layers 320 have the thicknesses presented in FIG. 45.

With the partial reflection layers 320 having the thicknesses as presented in FIGS. 43 and 45, similarly to the above-described embodiments, differences in light intensity between the light rays with the angles of view reaching the respective positions in the eye box is reduced, and the luminance differences between the positions in the eye box is also reduced.

The following describes the image-light reflectances corresponding to the light rays having the angles of view converging at the position of 11.7 mm in the eye box. In the reference embodiment as illustrated in FIG. 45, the image-light reflectance varies by about 27% at the maximum. In the fifth example embodiment as illustrated in FIG. 43, however, the image-light reflectance varies by about 20% at the maximum.

This means that the fifth embodiment using the asymmetrical angles of view (i.e., the first angle θ_{3N} corresponding to the maximum angle of view in the positive direction is greater than the second angle θ_{3F} corresponding to the maximum angle of view in the negative direction) allows a reduction in differences between the image-light reflectances corresponding to the angles of view. This further allows a reduction in luminance differences between the angles of view within a luminance image and luminance differences between the positions in the eye box.

Further, in the fifth embodiment in which the angles of view are asymmetrical, the angle of view of the virtual image reaching the left eye and the angle of view of the virtual image reaching the right eye differs from the angle of view of the virtual image reaching the left eye. The wearer perceives a virtual image having a wider angle of view by binocular vision of the virtual image having angles of view that differ between the left and right. Thus, the fifth embodiment allows enlargement of the angle-of-view range satisfying the image quality.

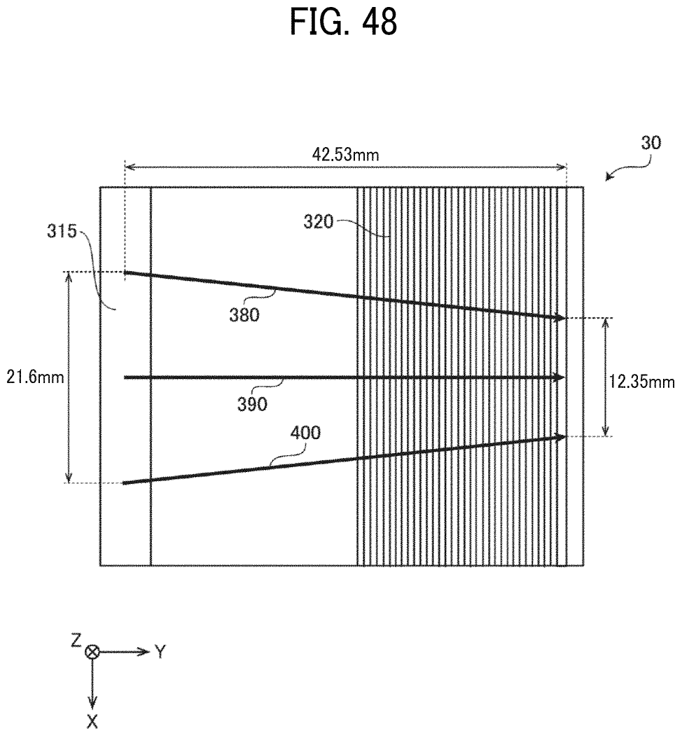

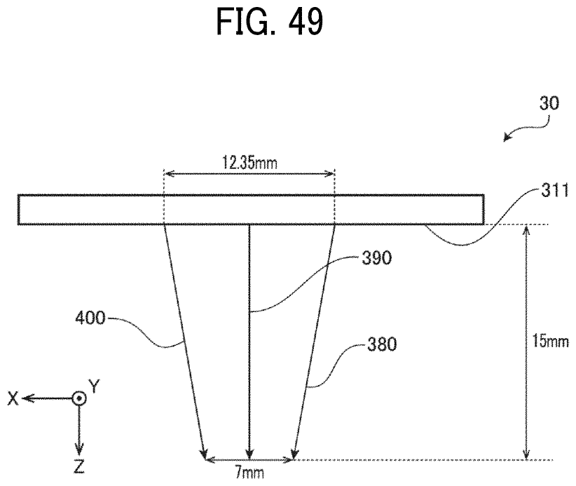

Additional description of the first embodiment is given below. FIG. 48 is a side view of the light guide 30 first embodiment when viewed in the −Z-direction. FIG. 49 is a side view of the light guide 30 first embodiment when viewed in the +Y-direction. In FIGS. 48 and 49, image light includes a light ray 380, a light ray 390, and a light ray 400.

In FIGS. 48 and 49, a distance (i.e., eye relief) between the first surface 311 of the light guide board 310 and the virtual image is 15 mm, at the position of which the pupil diameter is assumed to be 3 mm. In this case, the image light is to be incident on an area of 12.35 mm in the X-direction on a partial reflection layer 320 at the +Y-side outermost position of the partial reflection layers 320 to allow the eye box of 2 mm in the X-direction. To allow the image light to be incident on such an area, the image light (collimated light) is to be incident on an area of 21.6 mm in the X-direction on the optical entrance 315, 42.53 mm away from the partial reflection layer 320 at the +Y-side outermost position of the partial reflection layers 320. This, however, causes upsizing of the propagation optical system 20.

### Sixth Embodiment

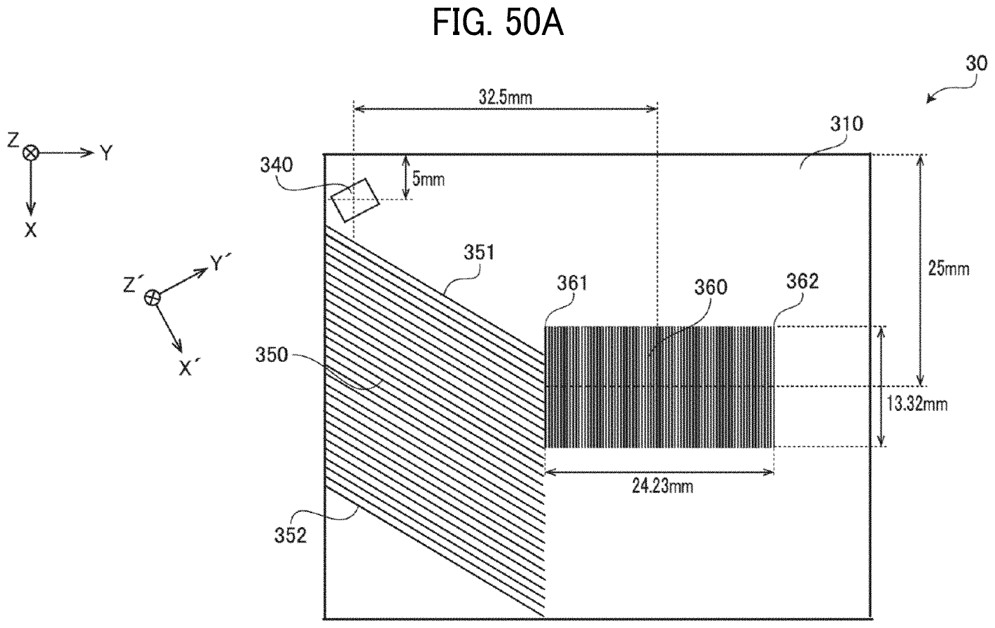

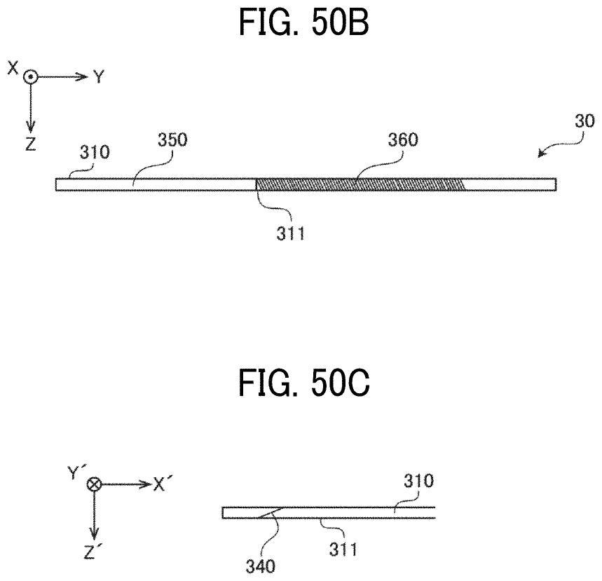

FIG. 50A is a side view of the light guide 30 according to the sixth embodiment when viewed in the −Z-direction. FIG. 50B is a side view of the light guide 30 according to the sixth embodiment when viewed in the +X-direction. To avoid the upsizing of the propagation optical system 20 as described with reference to FIGS. 48 and 49 (i.e., to allow downsizing of the propagation optical system 20), the light guide 30 may be configured as illustrated in FIGS. 50A and 50B.

In the sixth embodiment, the light rays have a wavelength of 526 nm. The light guide board 310 according to the sixth embodiment is composed of, for example, Yupizeta EP-10000 (Mitsubishi Gas Chemical Co., Ltd.). In the sixth embodiment, he light guide board 310 has a refractive index n₁ of 1.695 and a thickness t of 1.26 mm.

The light guide 30 includes partial reflection layers 350 and 360.

The partial reflection layer 360 is an example of at least one first partial reflection layer. The light guide 30 according to the sixth embodiment includes 76 partial reflection layers 360. The partial reflection layers 360 (i.e., 76 partial reflection layers 360) are arranged parallel to each other. In FIG. 50A, the partial reflection layers 360 includes a partial reflection layer 361 at the −Y-side outermost position of the seventy-six partial reflection layers 360 and a partial reflection layer 362 at the +Y-side outermost position of the seventy-six partial reflection layers 360.

The partial reflection layers 360 (i.e., 76 partial reflection layers 360) are disposed with their center at a position 32.5 mm away from a reflecting surface 340 in the Y-direction and 25 mm away from the −X-side edge of the light guide board 310 in the +X-direction. The seventy-six partially reflective layers 360 are arranged in a rectangular area having a length of 13.32 mm in the X-direction and a length of 24.23 mm in the Y-direction.

Each partial reflection layer 360 is, for example, a single-layer deposited film of SiO₂. The partial reflection layers 360 each have a refraction index n₂ of 1.461 an angle Φ₁ of 23.7° relative to the normal to the first surface 311. The partial reflection layers 360 are arranged at an interval d of 0.318 mm.

The light guide 30 according to the sixth embodiment includes the reflecting surface 340 instead of the external mirror 330 or the first edge face 313 serving as a reflector. An X′Y′Z′ coordinate system in FIG. 50A is a coordinate system obtained by rotating the XYZ coordinate system by 28.4° around the Z-axis. FIG. 50C is a side view of the reflecting surface 340 as viewed in the −Y′-direction.

The reflecting surface 340 is disposed at a position 32.5 mm away from the center of the rectangular area of the seventy-six partial reflection layers 360 in the −Y-direction and 5 mm away from the −X-side edge of the light guide board 310 in the +X-direction (see FIG. 50A). The reflecting surface 340 has a width of 2.85 mm in the X′-direction and a width of 4 mm in the Y′-direction. The reflecting surface 340 and the first surface 311 of the light guide board 310 form an angle Φ₀ of 23.7°.

The light guide board 310 in FIG. 50A further includes a partial reflection layer 350, which is an example of at least one second partial reflection layer. The light guide 30 according to the sixth embodiment includes 29 partial reflection layers 350. The twenty-nine partial reflection layer 350 are arranged parallel to each other and not parallel to the partial reflection layers 360. In FIG. 50A, the twenty-nine partial reflection layers 350 includes a partial reflection layer 351 at the −X-side outermost position of the twenty-nine partial reflection layers 350 and a partial reflection layer 353 at the +X-side outermost position of the twenty-nine partial reflection layers 350.

Each partial reflection layer 350 is, for example, a single-layer deposited film of SiO₂. The partial reflection layer 350, which is an example of at least one second partial reflection layer, has a refractive index n₄. The partial reflection layers 350 each are parallel to the normal to the first surface 311 and each have a refraction index n₄ of 1.461. Each of the partial reflection layer 350 and the Y-axis form an angle of 30.8°.

In the sixth embodiment, the image light is collimated by the propagation optical system 20 to obtain a horizontal angle of view in the X′-direction and a vertical angle of view in the Y′-direction, and thus reaches an X′Y′ plane with an area of 4 mm×2.85 mm in the reflecting surface 340. The horizontal angle of view is ±17.6°, and the vertical angle of view is ±10.12°.

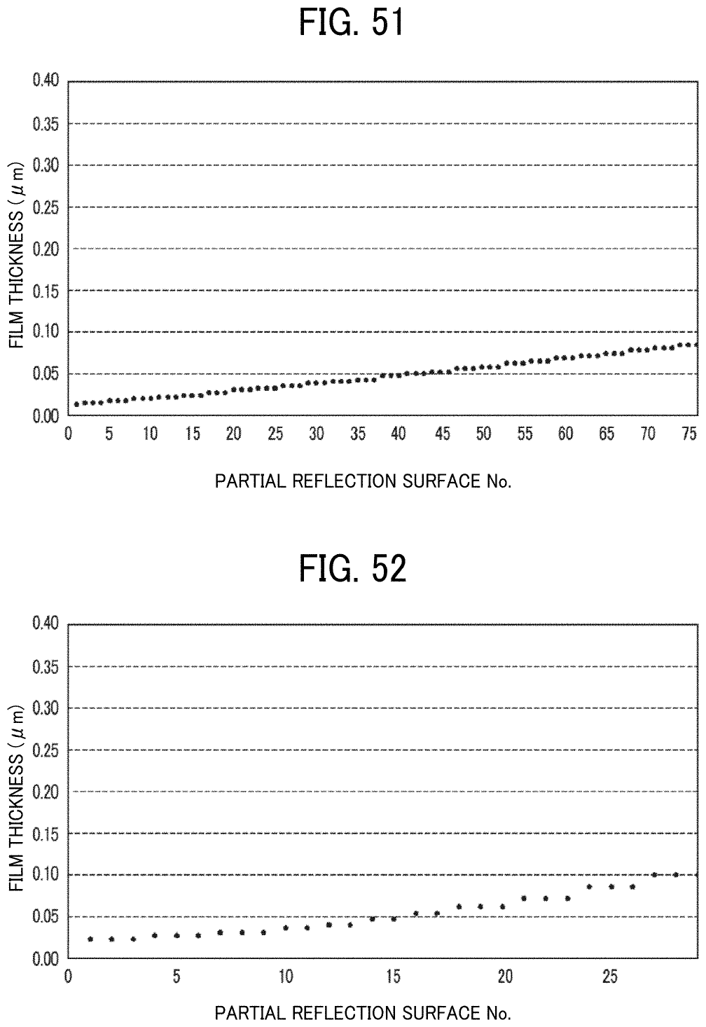

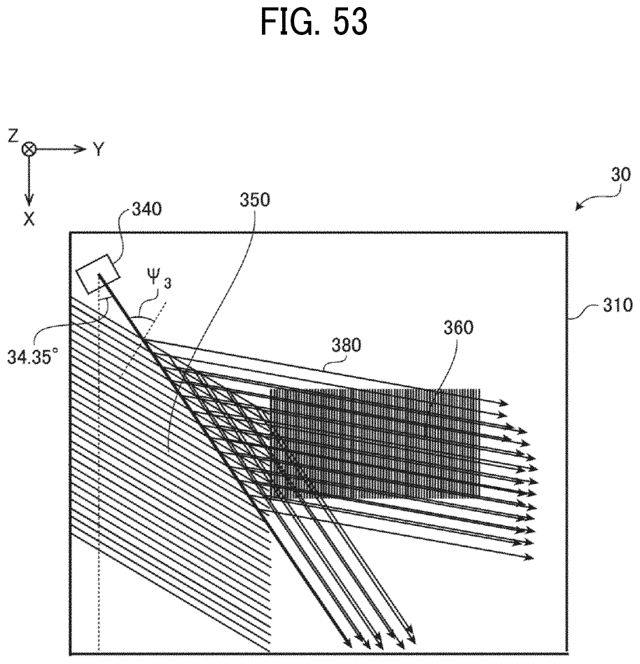

FIG. 51 is a graph in which the thicknesses of the seventy-six partial reflection layers 360 are plotted, which is similar to FIG. 15A. FIG. 52 is a graph in which the thicknesses of the twenty-nine partial reflection layers 350 are plotted, which is similar to FIG. 15A.

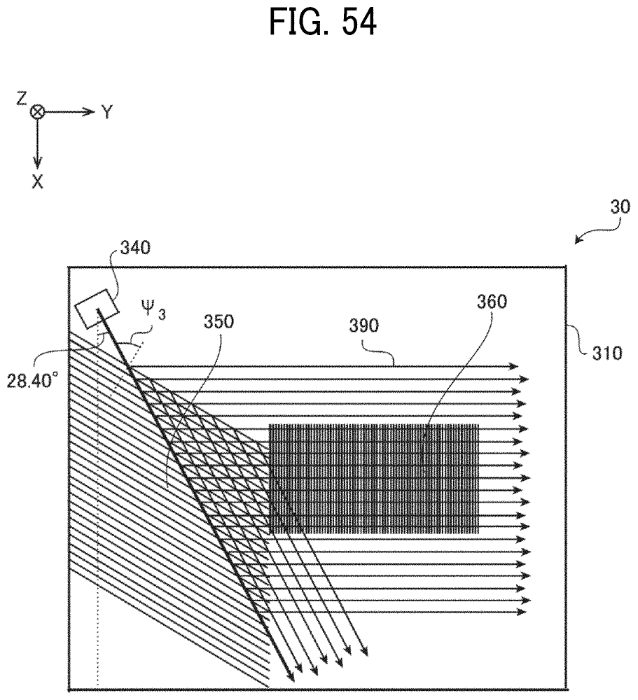

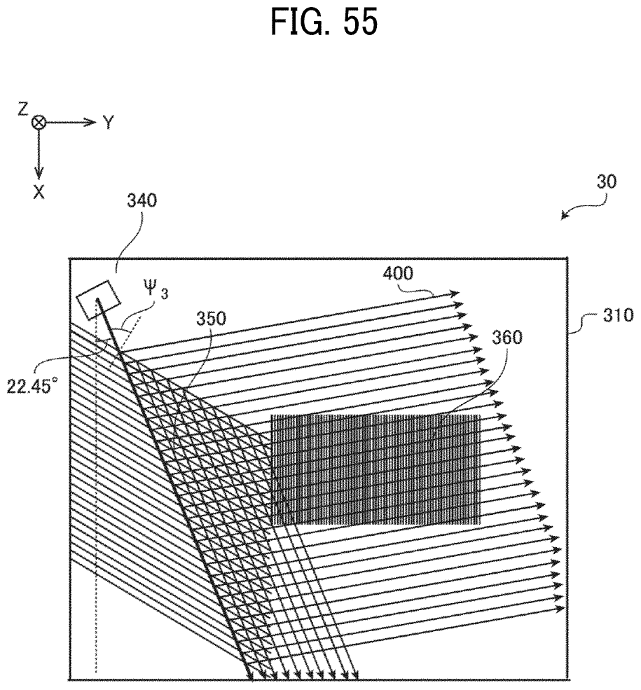

FIG. 53 is a ray tracing diagram of light rays having a vertical angle of view of +10.120 incident on the reflecting surface 340. FIG. 54 is a ray tracing diagram of light rays having a vertical angle of view of 0° incident on the reflecting surface 340. FIG. 55 is a ray tracing diagram of light rays having a vertical angle of view of −10.12° incident on the reflecting surface 340.

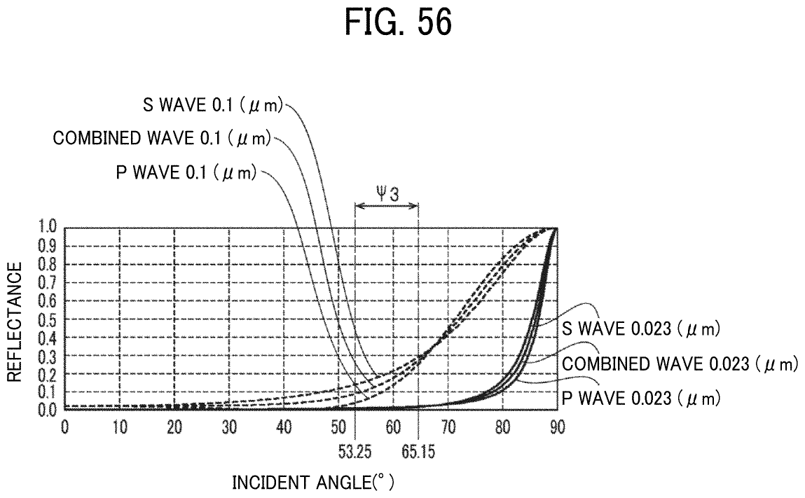

FIG. 56, which is similar to FIG. 14, is a graph of the relation between incident angle (°) on the partial reflection layer 350 and reflectance (normalized by 1) thereof, according to the sixth embodiment. FIG. 56 presents reflectance of each of the p-wave, the s-wave, and the combined wave thereof, incident on the partial reflection layer 351 (see FIG. 50A) having a minimum thickness of 0.023 μm and reflectance of each of the p-wave, the s-wave, and the combined wave, incident on the partial reflection layer 352 (see FIG. 50A) having a maximum thickness of 0.1 μm. As presented in FIG. 56, the incident angle Ψ₃ at which a light ray with an angle of view of −10.12° has struck the partial reflection layer 350 is 53.25°. As also presented in FIG. 56, the incident angle Ψ₃ at which a light ray with an angle of view of +10.12° has struck the partial reflection layer 350 is 65.15°.

FIG. 53 demonstrates that a light ray 380 having a vertical angle of view of +10.12° propagates through the light guide board 310 in a direction with an angle of 34.35° relative to the X-direction while undergoing repeated total reflection within the light guide board 310, after striking the reflecting surface 340. The light ray 380 as the combined light of the p-wave and the s-wave strikes the partial reflection layer 350 at an incident angle Ψ₃ of 65.15°.

A critical angle θᵣ₂ refers to an angle on the interface between the light guide board 310 and the partial reflection layer 350. The critical angle θᵣ₂ is given by sin⁻¹(n₄/n₁). The concrete value of critical angle θᵣ₂ is 59.54°.

The incident angle Ψ₃ at which a light ray with an angle of view of +10.120 has struck the partial reflection layer 350 is greater than the critical angle θᵣ₂. Such a light ray of the incident angle Ψ₃ satisfies the total reflection condition. As presented in FIG. 56, a part of evanescent light entering the partial reflection layer 350 passes through the partial reflection layer 350. More specifically, a part of light corresponding to an angle of view of +10.12° reflects off the partial reflection layer 350 and strikes the partial reflection layer 360, whereas the remainder of the light passes through the partial reflection layer 350.

As illustrated in FIG. 53, light rays reflecting off the partial reflection layer 350 may be all incident on the partial reflection layer 360, whereas light rays reflecting off the partial reflection layer 350 may further strike another partial reflection layer 350 and thus strike the partial reflection layer 360 after undergoing repeated separation into reflected light and transmitted light.

Through such separation, the light rays propagate through the light guide board 310. With this configuration, a bundle of light rays having a small width at each angle of view on the reflecting surface 340 has its width in the vertical angle of view enlarged through the partial reflection layers 350. This allows a wider eye box in the vertical direction.

FIG. 54 demonstrates that a light ray 390 having a vertical angle of view of 0° propagates through the light guide board 310 in a direction with an angle of 28.400 relative to the X-direction while undergoing repeated total reflection within the light guide board 310, after striking the reflecting surface 340. The light ray 390 as the combined light of the p-wave and the s-wave strikes the partial reflection layer 350 at an incident angle Ψ₃ of 59.20°.

FIG. 55 demonstrates that a light ray 400 having a vertical angle of view of −10.12° propagates through the light guide board 310 in a direction with an angle of 22.450 relative to the X-direction while undergoing repeated total reflection within the light guide board 310, after striking the reflecting surface 340. The light ray 400 as the combined light of the p-wave and the s-wave strikes the partial reflection layer 350 at an incident angle Ψ₃ of 53.25°.

The incident angle Ψ₃ at which a light ray with an angle of view of +0° and a light ray with an angle of view of −10.12° have struck the partial reflection layer 350 is less than or equal to the critical angle θᵣ₂. However, as presented in FIG. 56, a part of each of light corresponding to the angle of view of +0° and light corresponding to the angle of view of −10.12° reflects off the partial reflection layer 350 and strikes the partial reflection layer 360, whereas the remainder passes through the partial reflection layer 350. As illustrated in FIGS. 54 and 55, light rays reflecting off the partial reflection layer 350 may be all incident on the partial reflection layer 360, whereas light rays reflecting off the partial reflection layer 350 may further strike another partial reflection layer 350 and thus strike the partial reflection layer 360 after undergoing repeated separation into reflected light and transmitted light.

In other words, light corresponding to each of the angle of view of +0° and the angle of view of −10.12° can have its width in the vertical angle of view enlarged. This allows a wider eye box in the vertical direction.

In other words, the partial reflection layer 350 as an example of at least one second partial reflection layer is not parallel to the partial reflection layer 360 an example of at least one first partial reflection layer. The partial reflection layer 350 reflects a part of light striking the partial reflection layer 350 at an incident angle equal to or greater than the critical angle θᵣ₂ (sin⁻¹(n₄/n₁)) to allow the reflected part of the light to be incident on the partial reflection layer 360 and also transmits the remainder of the light striking the partial reflection layer 350.

FIG. 57 is an illustration of the behavior of light rays 381 incident on the partial reflection layers 360, for the horizontal angle of view of −17.6°. This light rays 381 exit the first surface 311 at an exit angle θ₃ (=−17.6°).

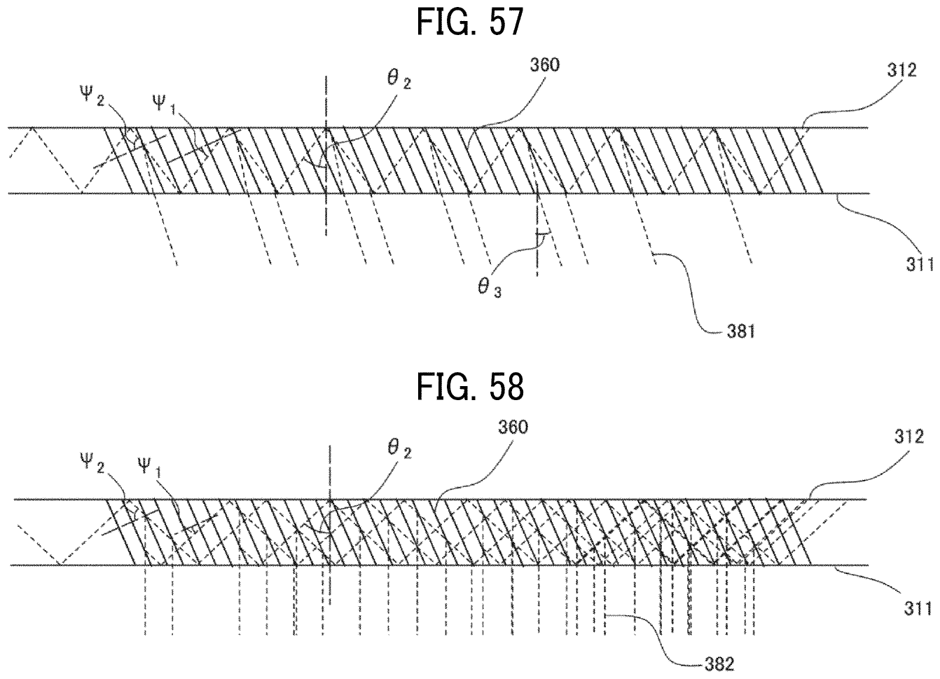

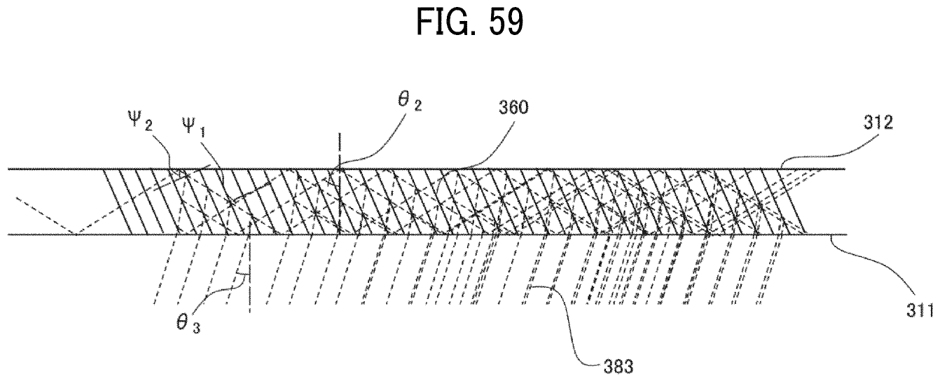

FIG. 58 is an illustration of the behavior of light rays 382 incident on the partial reflection layers 360, for the horizontal angle of view of 0°. The light rays 382 exit the first surface 311 at an exit angle θ₃ (=00).

FIG. 59 is an illustration of the behavior of light rays 383 incident on the partial reflection layers 360, for the horizontal angle of view of +17.6°. This light rays 383 exit the first surface 311 at an exit angle θ₃ (=+17.6°).

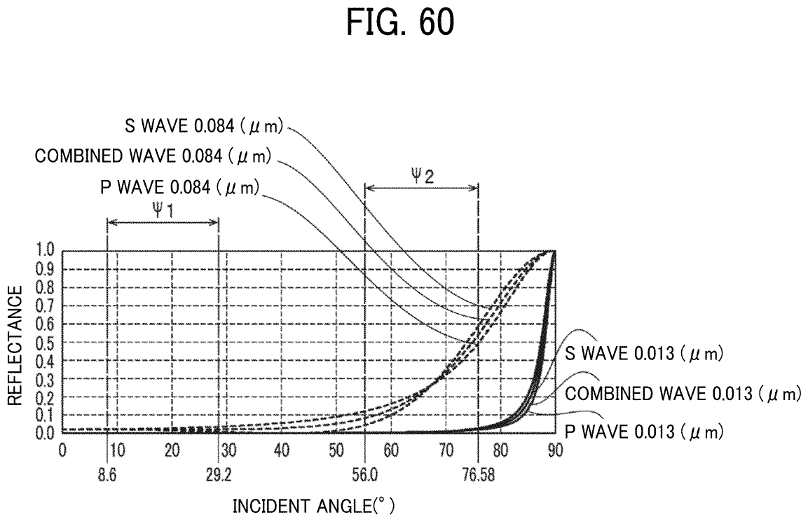

FIG. 60, which is similar to FIG. 20, is a graph of the relation between incident angle (°) on the partial reflection layer 360 and reflectance (normalized by 1) thereof, according to the sixth embodiment. FIG. 60 presents reflectance of each of the p-wave, the s-wave, and the combined wave thereof, incident on the partial reflection layer 361 having a minimum thickness of 0.013 μm and reflectance of each of the p-wave, the s-wave, and the combined wave, incident on the partial reflection layer 362 having a maximum thickness of 0.084 m.

The light rays 381 in FIG. 57 propagate through the light guide board 310 while totally reflecting off the first surface 311 and the second surface 312 at the incident angle θ₂ of 37.12°. The light ray 381 is incident on the partial reflection layer 360 at an incident angle Ψ₁ of 29.2° or an incident angle Ψ₂ of 76.58°.

The incident angle Ψ₂ of the light rays 381 satisfies the total reflection condition because the critical angle θᵣ is 59.54°. However, as presented in FIG. 60, a part of evanescent light entering the partial reflection layer 360 passes through the partial reflection layer 360. More specifically, a part of the light rays 381 reflects off the partial reflection layer 360 and exits the first surface 311 at an exit angle θ₃ of −17.6°, whereas the remainder of the light rays 381 passes through the partial reflection layer 360.

The light rays 382 in FIG. 58 propagate through the light guide board 310 while totally reflecting off the first surface 311 and the second surface 312 at the incident angle θ₂ of 47.4°. The light ray 381 is incident on the partial reflection layer 360 at an incident angle Ψ₁ of 18.9° or an incident angle Ψ₂ of 66.3°.

The incident angle Ψ₂ of the light rays 382 satisfies the total reflection condition because the critical angle θᵣ is 59.54°. However, as presented in FIG. 60, a part of evanescent light entering the partial reflection layer 360 passes through the partial reflection layer 360. More specifically, a part of the light rays 382 reflects off the partial reflection layer 360 and exits the first surface 311 at an exit angle θ₃ of 0°, whereas the remainder of the light rays 382 passes through the partial reflection layer 360.

The light rays 383 in FIG. 59 propagate through the light guide board 310 while totally reflecting off the first surface 311 and the second surface 312 at the incident angle θ₂ of 57.68°. The light ray 381 is incident on the partial reflection layer 360 at an incident angle Ψ₁ of 8.6° or an incident angle Ψ₂ of 56.0°.

The incident angle Ψ₂ of the light rays 383 satisfies the total reflection condition because the critical angle θᵣ is 59.54°. More specifically, as presented in FIG. 60, a part of the light rays 383 reflects off the partial reflection layer 360 and exits the first surface 311 at an exit angle θ₃ of +17.6°, whereas the remainder of the light rays 383 passes through the partial reflection layer 360.

As illustrated in FIGS. 58 and 59, light rays reflecting off the partial reflection layer 360 after striking the partial reflection layer 360 at an incident angle Ψ₂ of 66.3° or 56.0° may all exit the first surface 311, whereas some light rays reflecting off the partial reflection layer 360 after such striking on the partial reflection layer 360 may further strike another partial reflection layer 360 at the incident angle Ψ₃ and thus exits the first surface 311 after undergoing repeated separation into reflected light and transmitted light.

Through such separation of the propagating light rays, the width of the light rays in the vertical angle of view can be enlarged, and thus a wider eye box in the horizontal direction is achieved.

The luminance distribution of the virtual image observed by the observer at each position in the eye box is determined according to the reflectance of each of the multiple partial reflection layers 350 and the reflectance of each of the multiple partial reflection layers 360.

The light guide 30 according to the sixth embodiment is configured to satisfy formula (6) where θ_{c} denotes an incident angle, which is greater than or equal to the critical angle θᵣ, of light incident on the partial reflection layer 360 when light rays (a part) of which reflect off the partial reflection layer 360 in a direction normal to the first surface 311; R denotes a reflectance of the light incident on the partial reflection layer 360 at the incident angle θc, normalized to values of 0 to 1 (i.e., the reflectance of 100% is normalized to 1); λ (m) denotes the center wavelength of light (image light); and h (m) denotes the thickness of the partial reflection layer 360.

$$\frac{log ( F ( 0.001 ) + \sqrt{{F ( 0.001 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \leq h \leq \frac{log ( F ( 0.99 ) + \sqrt{{F ( 0.99 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \qquad Formula ( 6 )$$

$$where$$

$$F ( R ) = 0.5 * ( \frac{( cos ( Φ {n}_{12} - Φ {n}_{23} ) - R \cdot cos ( Φ {n}_{12} + Φ {n}_{23} ) )}{( R - 1 )} + \frac{( cos ( Φ {h}_{12} - Φ {h}_{23} ) - R \cdot cos ( Φ {h}_{12} + Φ {h}_{23} ) )}{( R - 1 )} )$$

$$Φ {n}_{12} = - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {n}_{23} = π - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {h}_{12} = - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

$$Φ {h}_{23} = π - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

Such a light guide 30 enables light incident on the partial reflection layer 360 at an incident angle greater than or equal to the critical angle θᵣ to have a reflectance appropriate to achieve the intended performance. This achieves a higher light use efficiency for the above-described reasons for formula (2).

In the eighth embodiment to be described below, for example, when the wavelength λ is 469 nm, the refractive index n₁ is 1.716, the refractive index n₂ is 1.464, the incident angles θ_{c} is 66.3°, the critical angle θᵣ is 58.56°, formula (6) gives 0.004 μm<h<0.340 μm. Further, the eighth embodiment to be described below, for example, when the wavelengths λ is 628 nm, the refractive index n₁ is 1.674, the refractive index n₂ is 1.457, the incident angles θ_{c} is 66.3°, and the critical angles θᵣ is 60.52°, formula (6) gives 0.006 μm<h<0.623 μm.

The sixth embodiment further incorporates the partial reflection layer 350, which is an example of at least one second partial reflection layer, and eliminates the need for causing image light with a wider width to enter the light guide board 310. This allows downsizing of the propagation optical system 20 and achieves a reduction in the weight of a virtual image display device (e.g., the HMD 1).

### Seventh Embodiment

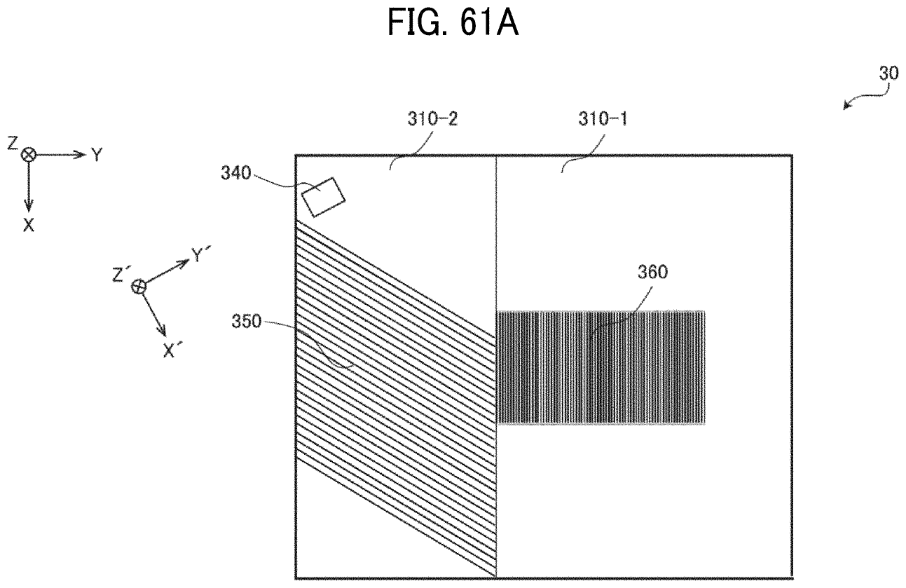

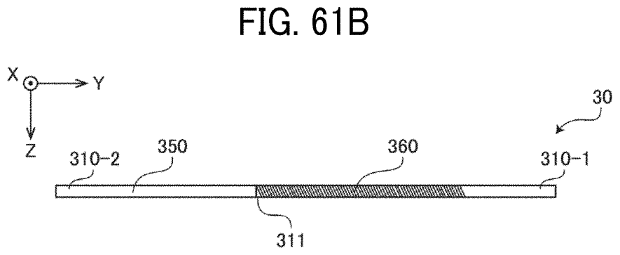

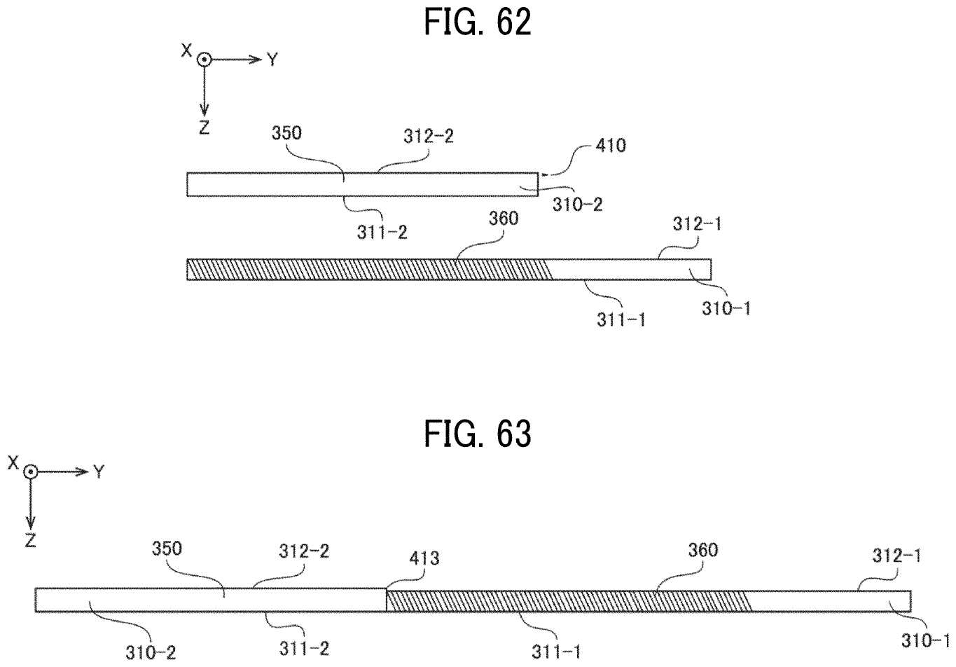

FIG. 61A is a side view of the light guide 30 according to the seventh embodiment when viewed in the −Z-direction. FIG. 61B is a side view of the light guide 30 according to the seventh embodiment when viewed in the +X-direction. FIGS. 62 to 63 are illustrations for describing a method of manufacturing the light guide 30 according to the seventh embodiment.

Similarly to the sixth embodiment, the light guide 30 according to the seventh embodiment includes the light guide 30, the partial reflection layers 350, and the partial reflection layers 360. One example method of manufacturing the light guide 30 having such a configuration may involve separately manufacturing a light guide board 310-1 including the partial reflection layers 360 and a light guide board 310-2 including the partial reflection layers 350 and joining the manufactured light guide board 310-1 and light guide board 310-2 together by an adhesive (see FIGS. 62 and 63).

In the seventh embodiment, the light guide board 310-2 has a higher thickness (i.e., a distance between a first surface 311-2 and a first surface 312-2) than that of the light guide board 310-1. The light guide board 310-1 has a thickness equal to a distance between the first surface 311-1 and the first surface 312-1. The light guide board 310-2 is thicker than the light guide board 310-1 in FIG. 62. This allows an allowable region 410 on a bonding surface of the light guide board 310-2 to allow the adhesive to squeeze out during boding. Such an allowable region 410 achieves a higher manufacturing efficiency of the light guide 30.

However, bonding together the light guide board 310-1 and the light guide board 310-2 having different thicknesses from each other forms a step 413 on at least one of the first surface 311 and the second surface 312, both of which totally reflect light. The step 413 may cause luminance unevenness in a virtual image.

However, with the light guide board 310-2 having a higher thickness than the light guide board 310-1, if the light guide board 310-2 is filled with light of each angle of view passing through the light guide board 310-2, the light guide board 310-1 is also filled with light of each angle of view passing through the light guide board 310-1. In such a case, the step 413 less likely causes the luminance unevenness.

To deal with the occurrence of the luminance differences, an absorbent may be applied to the allowable region 410 corresponding to the step 413. The application of the absorbent reduces the occurrence of flare due to light scattering on the step 413 and thus reduces deterioration in image quality.

As described above, the light guide 30 according to the seventh embodiment includes the light guide board 310-1 (an example of a first region including at least one first partial reflection layer) including at least one partial reflection layer 360 and the light guide board 310-2 (an example of a second region including at least one second partial reflection layer) including at least one partial reflection layer 350. The light guide board 310-1 and the light guide board 310-2 have different thicknesses. A step 413 is present at the interface between the light guide board 310-1 and the light guide board 310-2 on least one of the first surface 311 and the second surface 312.

### Eighth Embodiment

The above-described third embodiment presents the simulated illuminance distribution of light rays (a wavelength of 450 nm in FIG. 36A, a wavelength of 550 nm in FIG. 34A, a wavelength of 650 nm in FIG. 36B) converging onto positions ±4 mm from the center of the eye box with a certain width in the horizontal direction (the Y-direction), using ray tracing software. Hereinafter, blue light (or a blue light ray) of 450 nm is also referred to as B light, green light (or a green light ray) of 550 nm is also referred to as G light, and red light (or a red light ray) of 650 nm is also referred to as R light.

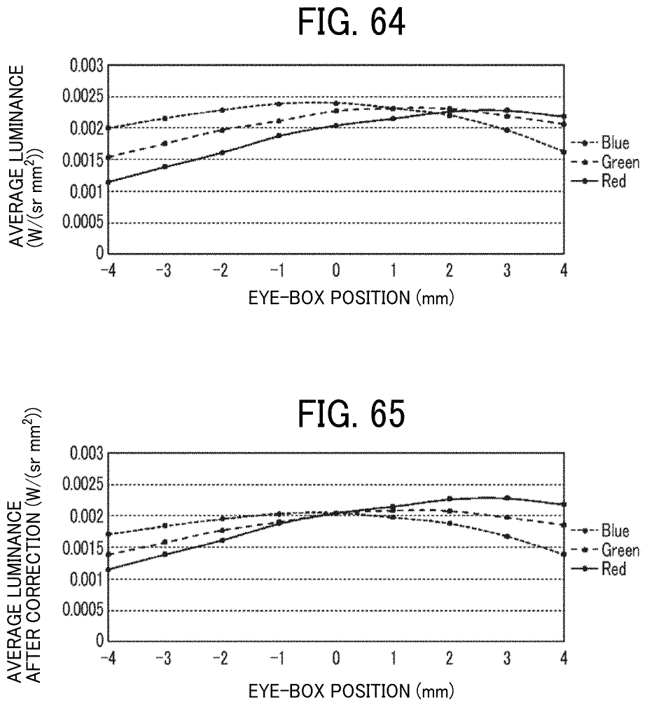

FIG. 64 is a graph in which the average values of radiance at the positions (y=7 to 13 mm) in a virtual image at each eye-box position (±4 mm from the center of the eye box) are plotted for each wavelength (R, G, B), according to the third embodiment.

As presented in FIG. 64, the average radiance of the blue light has a peak in the vicinity of the eye-box position of −0.5 mm in the horizontal direction. The average radiance of the green light has a peak in the vicinity of the eye-box position of +1 mm in the horizontal direction. The average radiance of the red light has a peak in the vicinity of the eye-box position of +2.5 mm in the horizontal direction.

The luminance differences between the wavelengths (i.e., the red light, the blue light, and the green light) are small in the vicinity of the eye-box position of +1.5 mm. In other words, color unevenness is small in the vicinity of this position. However, the luminance differences between the wavelengths are small in the vicinity of the eye-box position of +4 mm. In other words, color unevenness is large in the vicinity of this position.

FIG. 65 presents the average luminances obtained by multiplying the luminance distribution in FIG. 64 by a correction coefficient to allow the luminances of the red light, the blue light, and the green light to be equal to each other at the eye-box position of 0 mm (the center position). As presented in FIG. 65, the color unevenness is reduced in the vicinity of the center of the eye-box position, whereas with an increasing distance from the center position, the luminance difference between the wavelengths increases, and the color unevenness increases as well. This means that, such a simple correction is difficult to successfully correct the color unevenness over the entire range of the eye box in the horizontal direction.

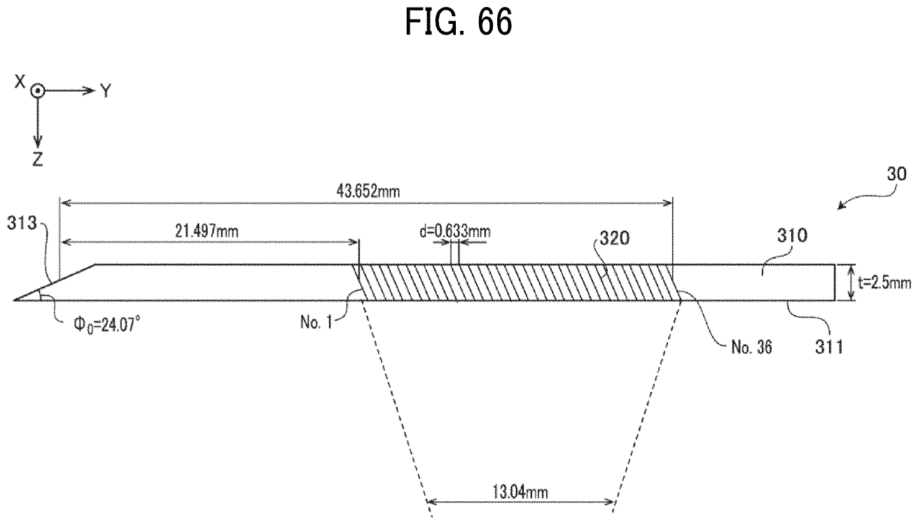

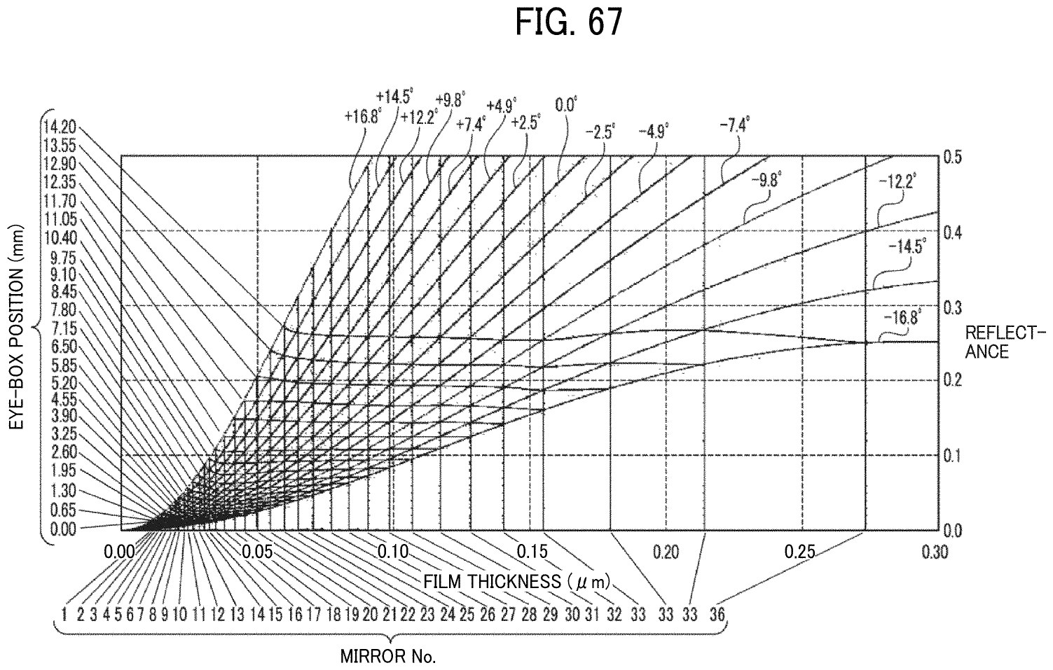

FIG. 66 is a side view of the light guide 30 according to the eighth embodiment when viewed in the +X-direction. FIG. 67, which is similar to FIG. 31, is a graph of the relation between the thickness of the partial reflection layer 320 and an image-light reflectance for each angle of view in a range of −16.8° to +16.8°, according to the eighth embodiment. The image light is assumed to be mixed light in which S-polarized light and P-polarized light are uniformly mixed and whose center wavelength λ is 526 nm.

The light guide 30 according to the eighth embodiment includes 36 partial reflection layers 320 (No. 1 to No. 36). The angle Φ₀ between the first surface 311 and each of the first edge face 313 and the reflecting surface is 24.07°. The light guide 30 according to the eighth embodiment may include an external mirror instead of the first edge face 313 serving as a reflector.

The partial reflection layer 320 of No. 1 is oriented with an angle Φ₁ of 24.07° to the normal to each of the first surface 311 and the second surface 312, located at a position 21.497 mm away from the first edge face 313. The partial reflection layers 320 of No. 1 to No. 36 are arranged with an interval d of 0.633 mm. In this arrangement, the interval (distance) between the partial reflection layer 320 of No. 1 and the partial reflection layer 320 of No. 36 is 22.155 mm. This allows light rays with all the horizontal angles of view to enter a range of 13.04 mm extending in the horizontal direction at a position 15 mm away from the first surface 311 in the +Z-direction. The pupil diameter of the eye of the wearer is assumed to be 3 mm.

The light guide board 310 according to the eighth embodiment is composed of, for example, OKP-A2 (Osaka Gas Chemical Co., Ltd.). In the eighth embodiment, the light guide board 310 has a wavelength of 526 nm, a refraction index n₁ of 1.673, a depth t of 2.5 mm. The partial reflection layer 320 according to the eighth embodiment is a single-layer deposited film of, for example, SiO₂, having a wavelength of 526 nm and a refractive index n₂ of 1.461.

When FIG. 67 of the eighth embodiment is compared with FIG. 31 of the third embodiment, it is found that the reflectance of the partial reflection layer 320 is low as a whole in the eighth embodiment.

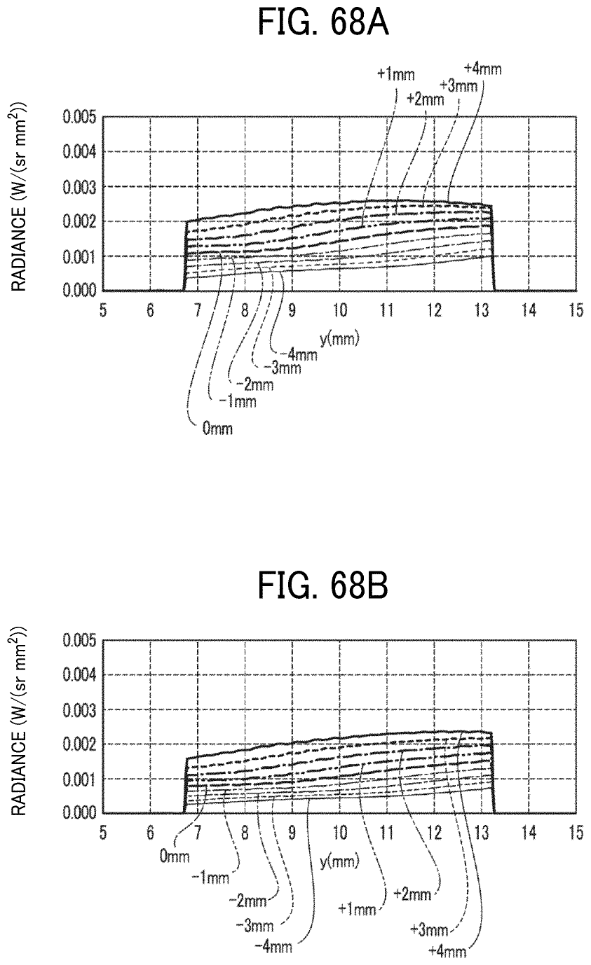

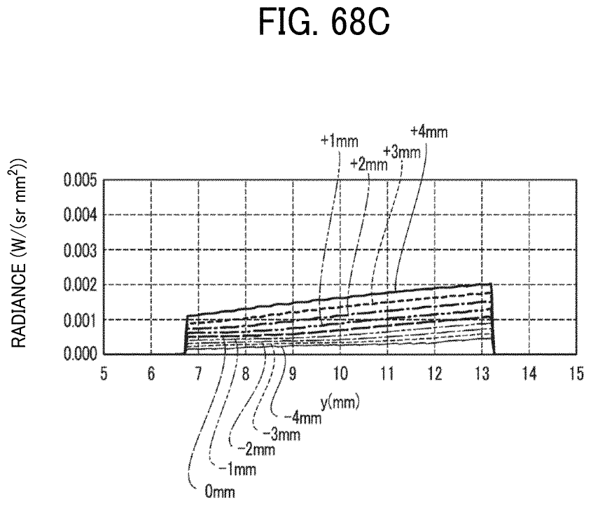

FIGS. 68A to 68C, which are similar to FIG. 34A, are graphs of a simulated luminance distribution of light rays converging onto positions ±4 mm from the center of the eye box with a certain width in the horizontal direction (the Y-direction), using ray tracing software, according to the eighth embodiment. The pupil diameter of the eye of the wearer is assumed to be 3 mm. FIGS. 68A, 68B, and 68C each present simulation results for the blue light having a wavelength of 469 nm, the green light having a wavelength 526 nm, and the red light having a wavelength of 628 nm.

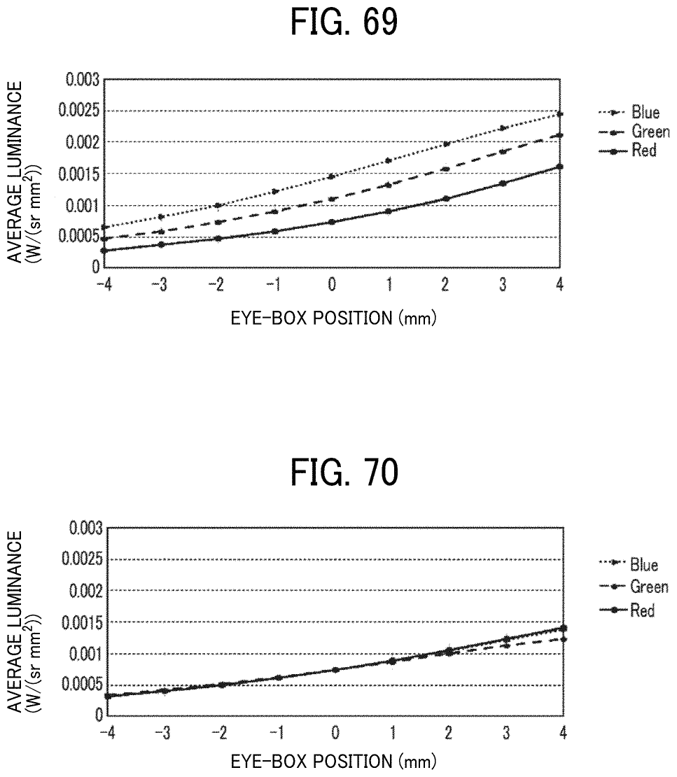

FIG. 69, which is similar to FIG. 64, is a graph in which the average values of radiances at the positions (y=7 to 13 mm) in a virtual image at each eye-box position (±4 mm from the center of the eye box) are plotted for each wavelength (R, G, B), according to the eighth embodiment.

As presented in FIG. 69 according to the eight embodiment, the average luminance for each wavelength is low in the vicinity of an eye-box position of −4 mm in the horizontal direction and high in the vicinity of an eye-box position of +4 mm in the horizontal direction. The blue light, the green light, and the red light are ranked in descending order of the average luminance over the entire range of the eye box in the horizontal direction.

FIG. 70 presents the average luminances obtained by multiplying the luminance distribution in FIG. 69 by a correction coefficient to allow the luminances of the red light, the blue light, and the green light to be equal to each other at the eye-box position of 0 mm (the center position). Such a correction allows a reduction in the luminance differences between the wavelengths and the color unevenness over the entire range of the eye box in the horizontal direction. However, similarly to the luminance distribution in FIG. 69, the luminance unevenness in the eye box is large in the horizontal direction.

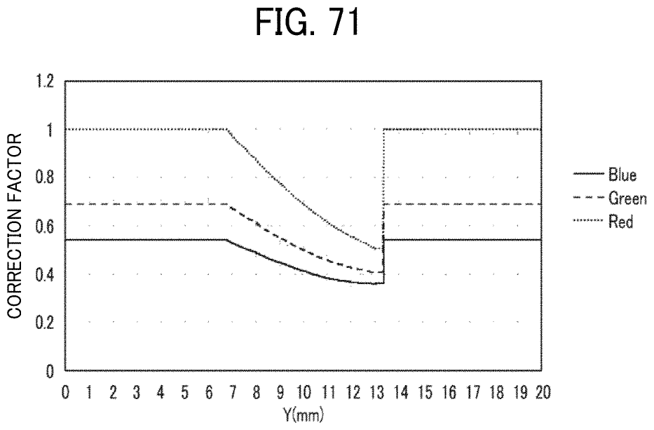

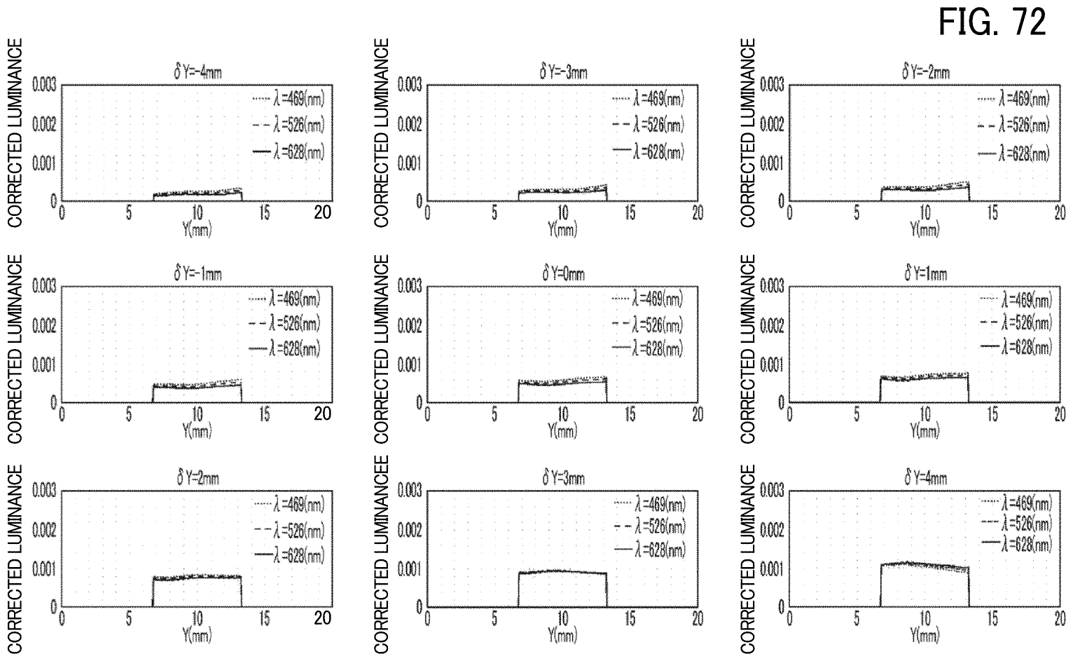

FIG. 71 is a diagram of correction coefficients for each virtual image position with respect to the light beams of having the wavelengths of red (R), green (G), and blue (B). FIG. 72 is a collection of diagrams of a luminance distribution obtained by correcting the illuminance distribution in FIGS. 68A to 68C with the correction coefficients in FIG. 71. FIG. 72 presents a luminance distribution for each eye-box position (−4 mm to +4 mm) in the horizontal direction.

As presented by FIG. 72, applying the correction coefficients in FIG. 71 allows a reduction in color unevenness at each eye-box position in the horizontal direction.

To deal with the issue of the luminance changes with the eye-box position in the horizontal direction, for example, the movement of the pupil is detected by an eye-tracking sensor, the amount of luminance change perceived by the observer is calculated from the detected amount of movement of the pupil in the horizontal direction, and the luminance value of the image display element 10 is adjusted based on the calculation result. This allows the luminance of the virtual image perceived by the observer to be maintained constant.

### Ninth Embodiment

The ninth embodiment provides another method for dealing with the issue of the luminance changes with the eye-box position in the horizontal direction, as an alternative to the method according to the eighth embodiment.

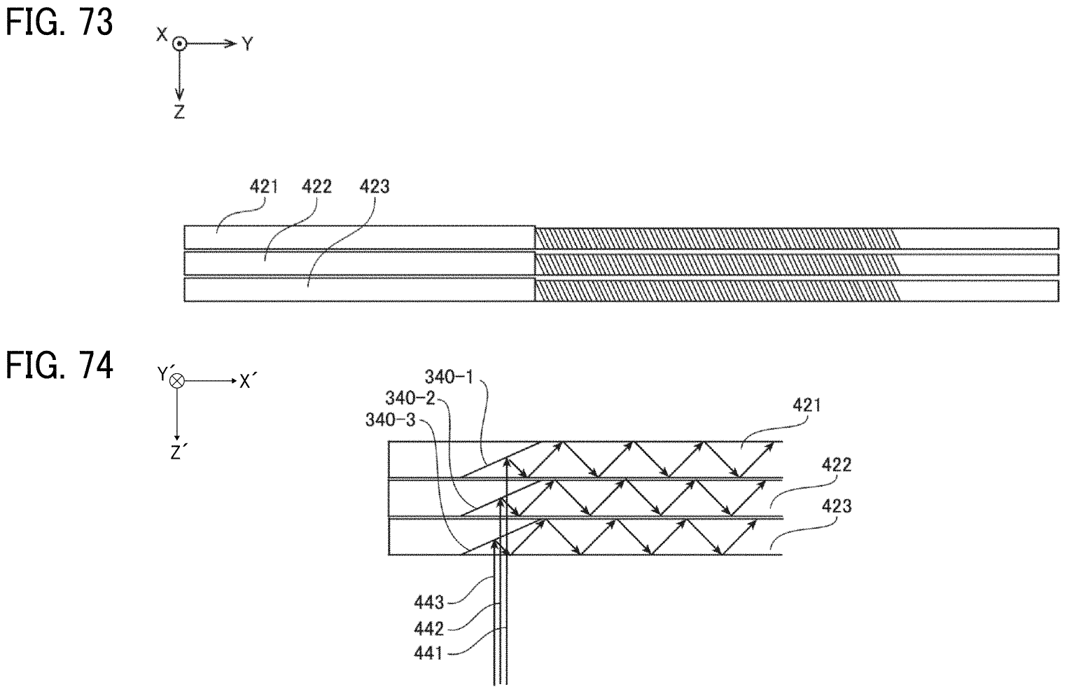

In the ninth embodiment, three light guide boards 310 according to the sixth embodiment are placed on top of one another in the Z-direction. As illustrated in FIG. 73, the three light guide boards are a light guide board 421 on the top (in the −Z-direction), a light guide board 422 under the light guide board 421, and a light guide board 423 on the bottom (at the +Z-side of the light guide board 422. The light guide boards 421, 422, and 423 correspond to the red light, the green light, and the blue light, respectively.

As illustrated in FIG. 74, the light guide board 421 includes a reflecting mirror 340-1 therein, the light guide board 422 includes a reflecting surface 340-2 therein, and the light guide board 423 includes a reflecting surface 340-3 therein.

FIG. 73 is a side view of the light guide boards 421 to 423 according to the ninth embodiment when viewed in the +X-direction.

FIG. 74 is a side view of the vicinity of an optical entrance of the light guide boards 421 to 423 according to the ninth embodiment when viewed in the Y′-direction.

The reflecting surface 340-3 transmits the red light 441 and the green light 442 therethrough and reflects the blue light 443. The blue light 443 reflected by the reflecting surface 340-3 propagates through the light guide board 423. The reflecting surface 340-2 transmits the red light 441 therethrough and reflects the green light 442. The green light 442 reflected by the reflecting surface 340-2 propagates through the light guide board 422. The reflecting surface 340-1 reflects the red light 441. Thus, the red light 441 reflected by the reflecting surface 340-1 propagates through the light guide board 421.

In the light guide boards 422 and 423, each partial reflection layer 350 and each partial reflection layer 360 have the same thickness as those in the sixth embodiment, respectively. However, the partial reflection layers 350 and the partial reflection layers 360 in the light guide board 421 have thicknesses different from those in the sixth embodiment.

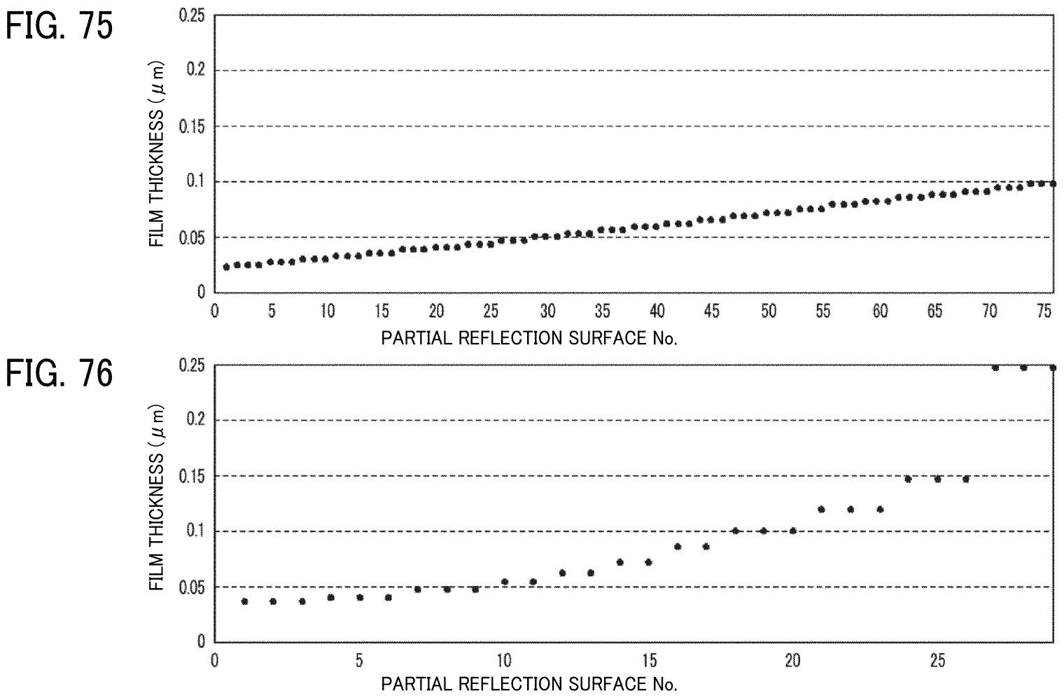

FIG. 75 is a graph in which the thicknesses of seventy six partial reflection layers 360 in the light guide board 421 according to the ninth embodiment are plotted, which is similar to FIG. 15A. FIG. 76 is a graph in which the thicknesses of twenty nine partial reflection layers 350 in the light guide board 421 according to the ninth embodiment are plotted, which is similar to FIG. 15A.

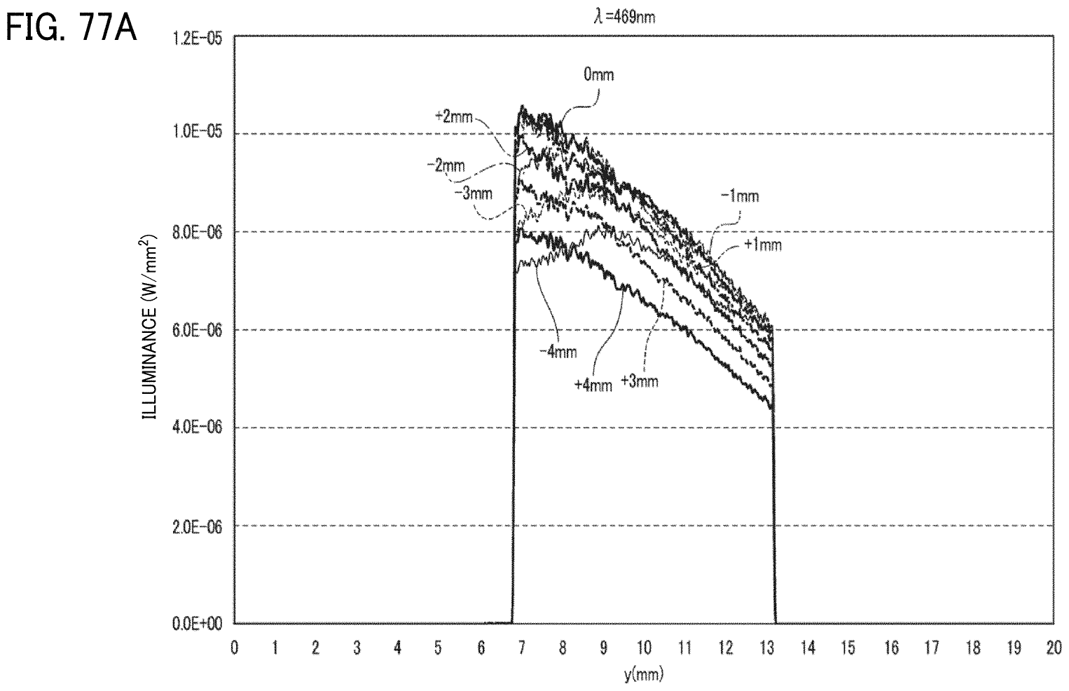

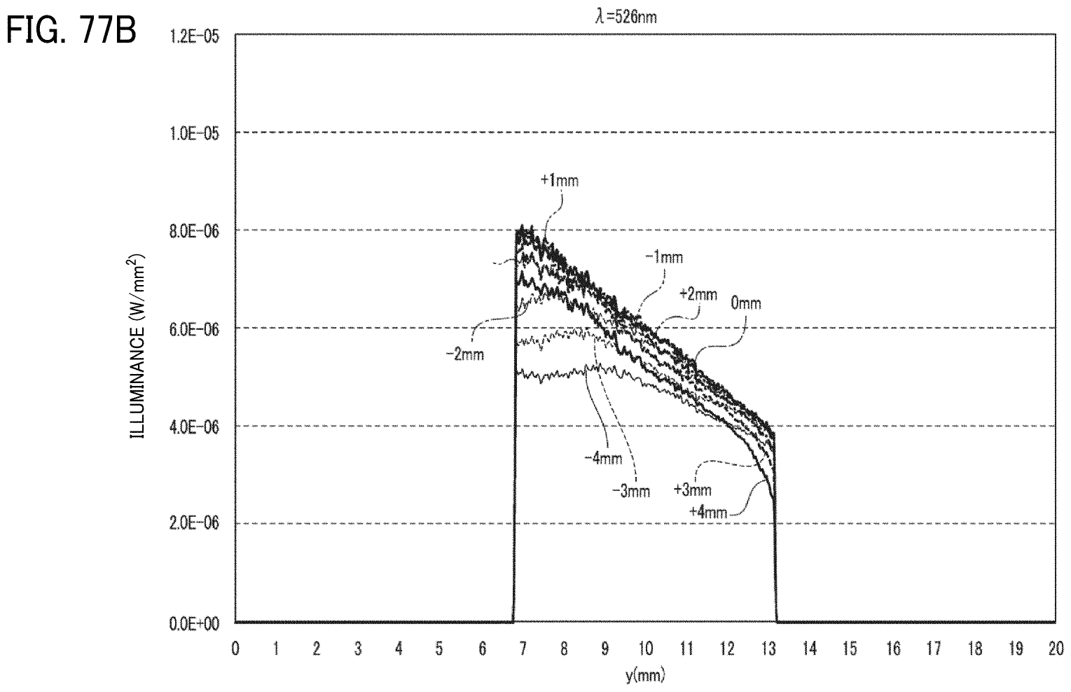

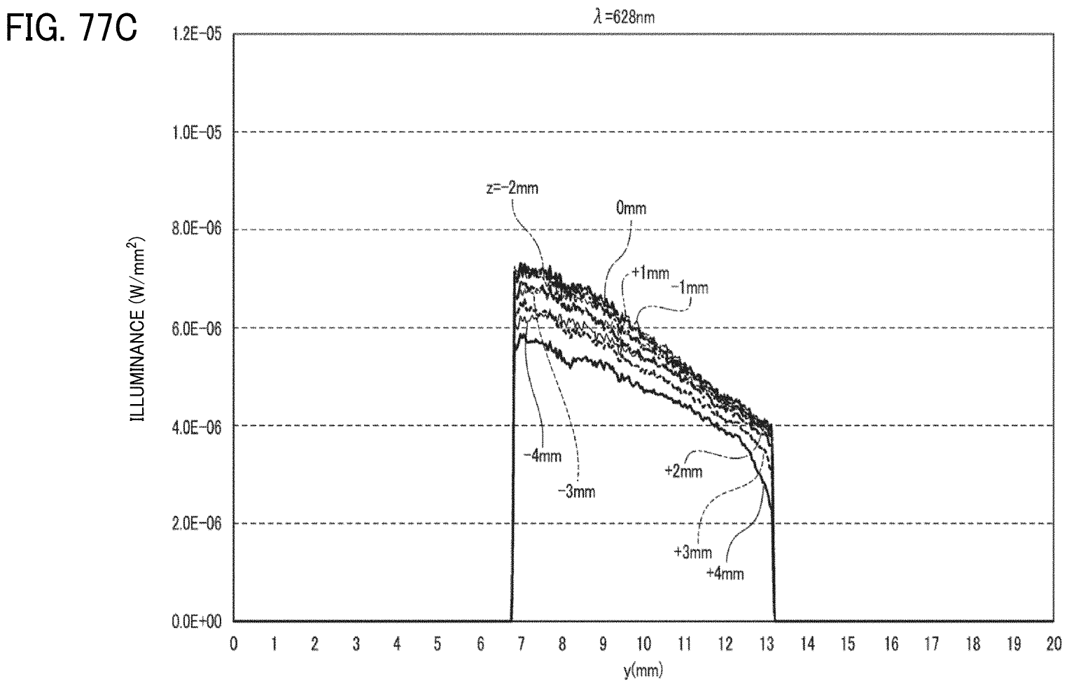

FIGS. 77A to 77C are graphs of a simulated illuminance distribution of light rays converging onto positions ±4 mm from the center of the eye box with a certain width in the horizontal direction (the Y-direction), using ray tracing software, according to the ninth embodiment. In FIGS. 77A to 77C, the vertical axis represents illuminance (Wmm⁻²), and the horizontal axis represents position y (mm) of a virtual image in the horizontal direction (the Y-direction) with an ideal lens having an effective diameter of 3 mm and a focal length of 10 mm, located at each position ±4 mm from the center of the eye box, within the eye box. The pupil diameter of the eye of the wearer is assumed to be 3 mm.

FIGS. 77A, 77B, and 77C each present simulation results for the blue light having a wavelength of 469 nm, the green light having a wavelength 526 nm, and the red light having a wavelength of 628 nm.

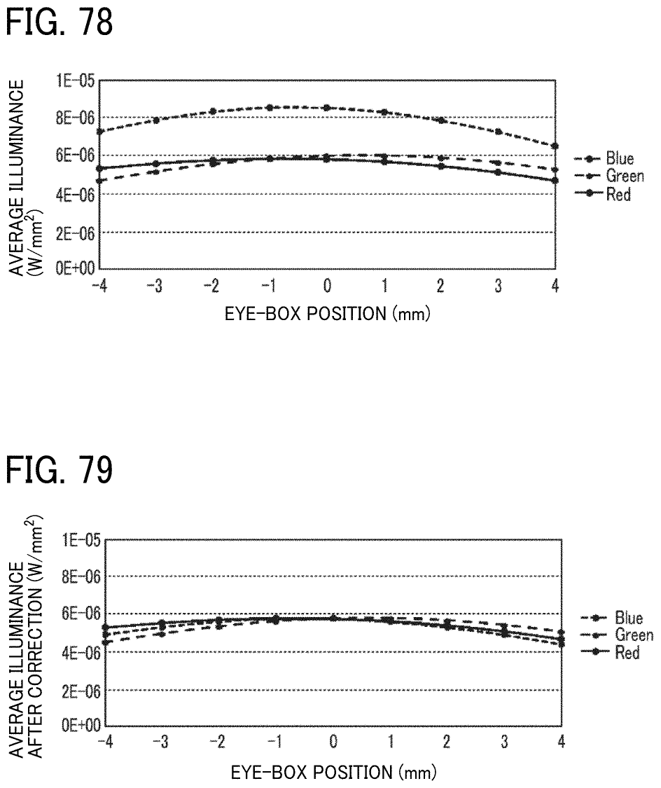

FIG. 78 is a graph in which the average values of illuminance at the positions (y=7 to 13 mm) in a virtual image at each eye-box position (±4 mm from the center of the eye box) are plotted for each wavelength (R, G, B), according to the ninth embodiment. As presented in FIG. 78, in the ninth embodiment, the average illuminance of the blue light is high over the entire range of the eye box in the horizontal direction, and the average illuminance of the green light and the average illuminance of the red light are substantially the same.

FIG. 79 presents the average illuminances obtained by multiplying the illuminance distribution in FIG. 78 by a correction coefficient to allow the illuminances of the red light, the blue light, and the green light to be equal to each other at the eye-box position of 0 mm (the center position).

As presented in FIG. 79, the color unevenness and the illuminance differences between the wavelengths are small over the entire range of the eye box in the horizontal direction.

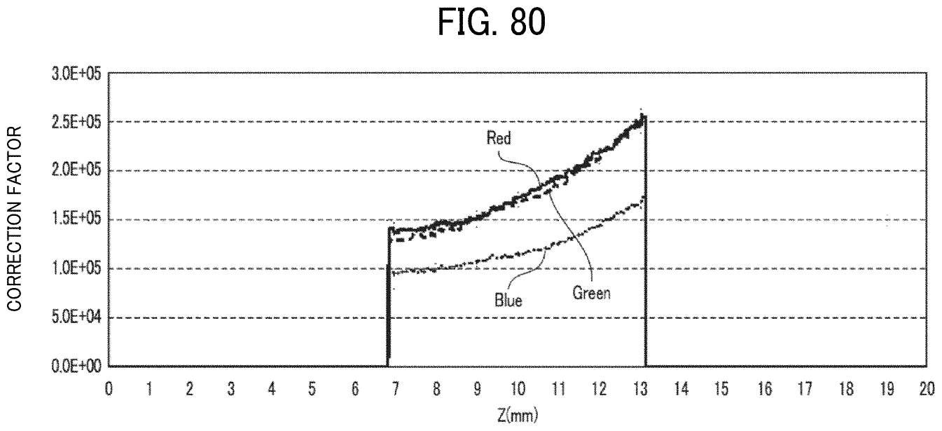

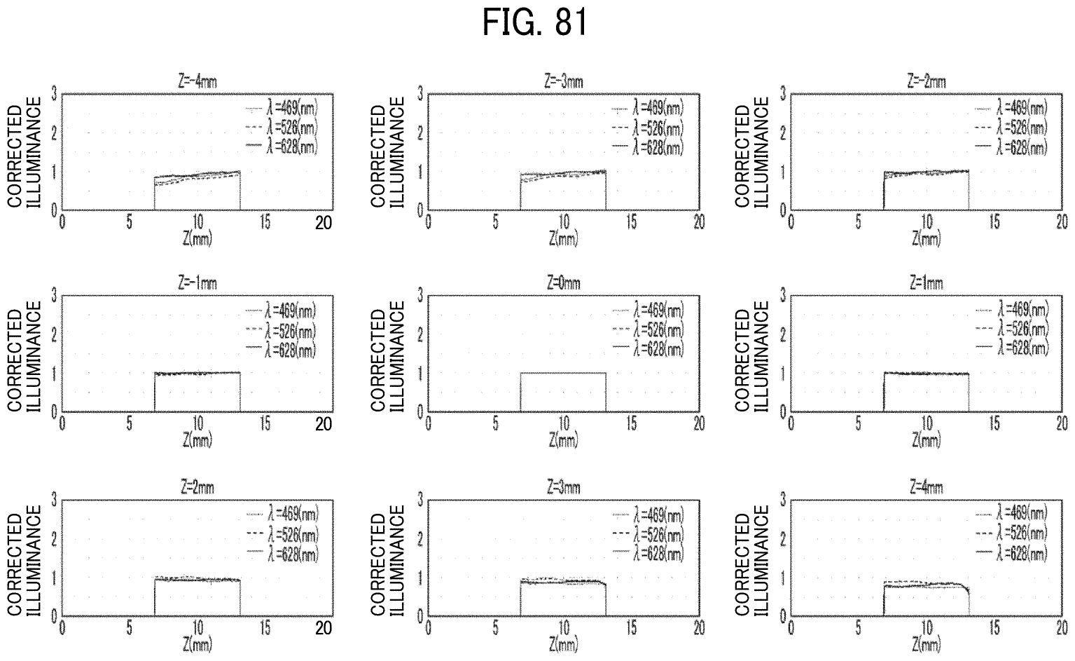

FIG. 80 is a diagram of correction coefficients for each virtual image position with respect to the light beams of having the wavelengths of the red light, the green light, and the blue light. FIG. 81 is a collection of diagrams of an illuminance distribution obtained by correcting the illuminance distribution in FIGS. 77A to 77C with the correction coefficients in FIG. 80. FIG. 81 presents an illuminance distribution for each eye-box position (−4 mm to +4 mm) in the horizontal direction.

As presented by FIG. 81, applying the correction coefficients in FIG. 80 allows a reduction in color unevenness at each eye-box position in the horizontal direction and also a reduction in illuminance differences between the wavelengths.

In the light guide boards 422 and 423 according to the ninth embodiment, each partial reflection layers 350 has the same thickness, and each partial reflection layer 360 also has the same thickness. However, the color unevenness at each eye-box position in the horizontal direction can be further reduced by changing the thickness of each partial reflection layer 350 to be different from each other and also changing the thickness of each partial reflection layer 360 to be different from each other.

Although three light guide boards 421 to 423 corresponding to the red light, the green light, and the blue light, respectively, are used in the ninth embodiment, two light guide boards may be used in another embodiment. In one example, one light guide board is shared by the green light and the blue light (i.e., the green light and the blue light are caused to propagate through one light guide board, and the red light is caused to propagate through another light guide board.

This configuration with two light guide boards allows a lower thickness as a whole than the use of three light guide boards. This allows downsizing of the propagation optical system and achieves a reduction in the weight of a virtual image display device (e.g., the HMD 1).

As described above, the light guide 30 according to the ninth embodiment includes three light guide boards 421, 422, and 423 (an example of at least two light guide boards) arranged in the Z-direction (i.e., a direction perpendicular to the first surface 311) and the reflecting surfaces 340-1, 340-2, and 340-3 incorporated in the light guide boards 421, 422, and 423 to reflect light rays incident on the optical entrance to allow the light rays to propagate through the light guide boards 421, 422, and 423, respectively. The reflecting surfaces 340-1, 340-2, and 340-3 include wavelength selective filters to selectively reflect the light rays incident on the optical entrance to allow each of the light guide boards 421, 422, and 423 to guide light rays having a corresponding wavelength (light rays having a wavelength different from wavelength of the remainder of the light rays incident on the optical entrance) (e.g., any one of the red light, the green light, and the blue light).

In other words, a light ray (the blue light) reflected by the reflecting surface 340-3 (an example of a reflecting surface in a light guide board that external light first enters) in the light guide board 423 has a wavelength shorter than that of a light ray (the red light or the green light) reflected by a reflecting surface (the reflecting surface 340-1 or 340-2) in another light guide board of the light guide boards 421, 422, and 423.

### Additional Description of Embodiments

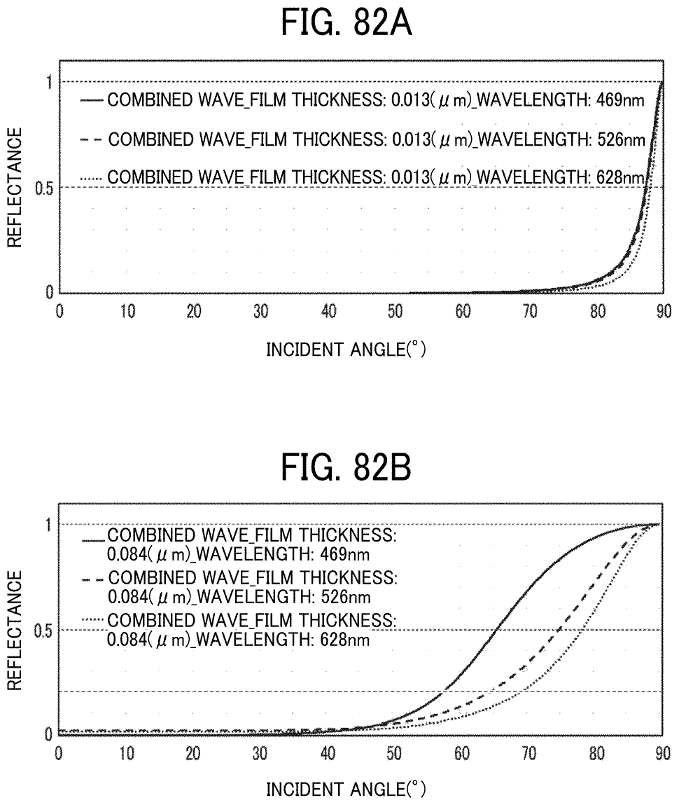

FIG. 82A is a graph of the relation between the incident angle on each partial reflection layer and the reflectance corresponding thereto, which is calculated for wavelengths (a wavelength of 469 nm, a wavelength of 526 nm, and a wavelength of 638 nm) where the light guide board 310 is formed by Yupizeta EP-10000 (Mitsubishi Gas Chemical Co., Ltd.), and each partial reflection layer is vapor-deposited as a single layer film having a thickness of 0.013 μm. Similarly to FIG. 82A, FIG. 82B present calculation results of the reflectances and incident angles where each partial reflection layer has a thickness of 0.084 μm. FIGS. 82A and 82B present the reflectance of the combined wave of the p-wave and the s-wave.

As presented in FIGS. 82A and 82B, for the partial reflection layers having the same thickness and at high incident angles corresponding to high reflectances, the reflectance increases as the wavelength decreases. This means that, for image light incident on the partial reflection layer under the total reflection conditions, the image light having a shorter wavelength causes less amount of evanescent light entering the partial reflection layer. To reduce the effects of reflectance differences due to the wavelengths, a partial reflection layer having a higher thickness is incorporated in a light guide board 310 to propagate longer-wavelength light.

For example, in the ninth embodiment, among three light guide boards 421 to 423, the partial reflection layer of the light guide board 421 for R light is formed thick as a whole. This configuration reduces the effects of the partial reflection layers 360 of the light guide boards 422 and 423 (the influence of the reflectance difference due to the wavelength) when R light (red light) exits the first surface 311 after reflecting off the partial reflection layer 360 in the light guide board 421. Thus, a light use efficiency is increased.

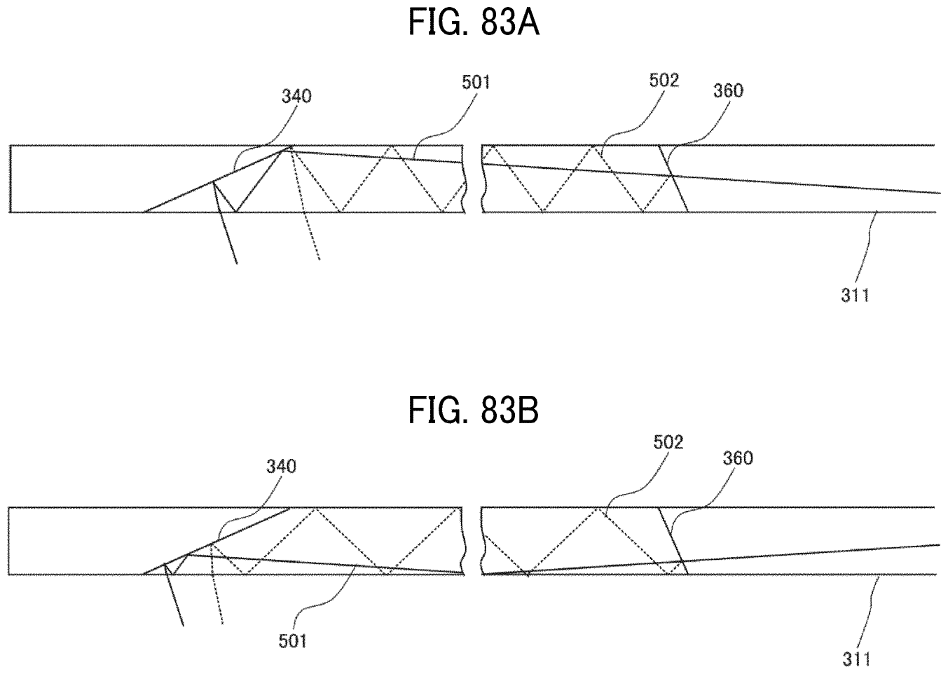

FIGS. 83A and 83B are diagrams of cases in which light rays corresponding to angles of view in the positive direction reflect off the reflecting surface 340 twice and thus change their propagation angles for propagating through the light guide board 310.

The light rays reflected twice by the reflecting surface 340 further reflect off the partial reflection layer 360 and exit the first surface 311, thus possibly turning ghost or undesired flare. This degrades image quality.

However, the sixth embodiment prevents twice-reflected light rays 501 and 502 from exiting through the first surface 311 while turning ghost or flare, but allows the light rays 501 and 502 to return toward the optical entrance as illustrated in FIGS. 83A and 83B.

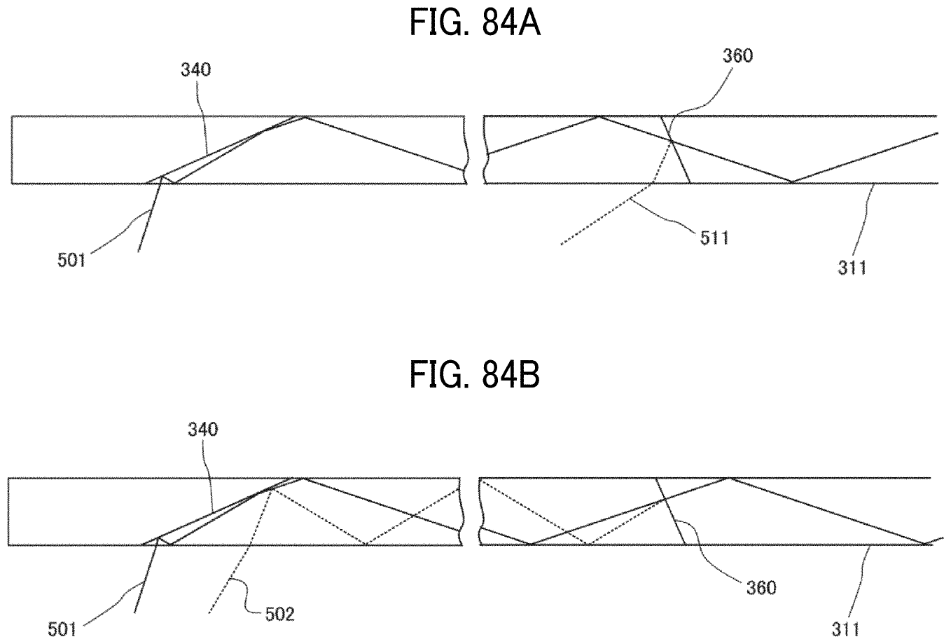

FIGS. 84A and 84B are diagrams of cases in which light rays corresponding to angles of view in the negative direction reflect off the reflecting surface 340 twice and thus change their propagation angles for propagating through the light guide board 310.

Also in this case, the light rays reflected twice may turn ghost light or flare light. As illustrated in FIG. 84A, for example, the twice-reflected light rays reflect off the partial reflection layer 360 and exit through the first surface 311, thus turning flare light 511.

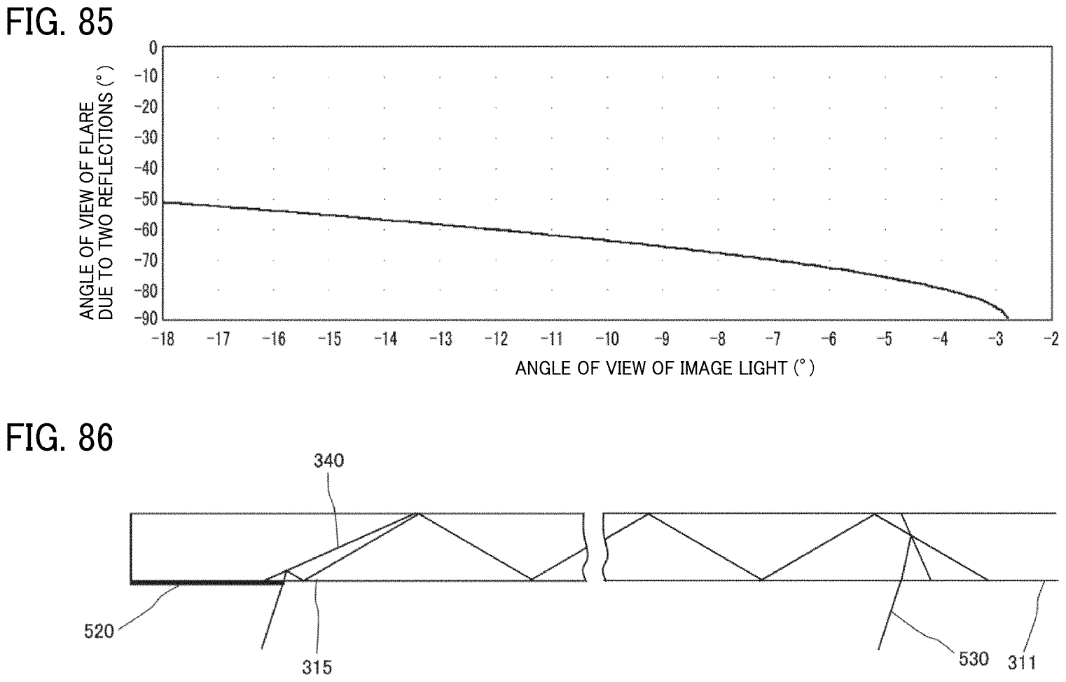

FIG. 85 is a graph of the relation between the angle of view (°) of the image light and the angle of view (°) of flare light resulting from twice-reflection on the reflecting surface 340.

In FIG. 85, flare light occurs when the angle of view of image light is −2.8° or less. With a horizontal angle of view of 60° in human binocular vision, image light having an angle of view of −12° to −18° is perceived by an observer as flare light having an angle of view in a range of −60° to −51°. To deal with this, the angle of view in the positive direction is widened, and the angle of view in the negative direction is narrowed as illustrated in FIG. 42. This reduces the effects of flare light on the image quality.

FIG. 86 is an illustration for describing how to reduce the effects of flare light on image quality.

As illustrated in FIG. 86, a light shield 520 is disposed in the vicinity of the optical entrance 315. The light shield 520 in the vicinity of the optical entrance 315 blocks a part of the image light from entering the light guide board 310. This reduces the amount of image light entering the light guide board 310 and thus reduces the amount of image light propagating through the light guide board 310 after reflecting off the reflecting surface 340 twice. As a result, the flare light 530 in FIG. 86 is reduced and deterioration in image quality dule to flare light id reduced.

Using the light shield 520 with the asymmetrical angles of view as illustrated in FIG. 42 further reduces the effects of flare light on image quality.

For example, the angle of view in the positive direction is narrowed, and the angle of view in the negative direction is widened. This allows a change in convergence angle in binocular vision. The distance to the virtual image can be set to a desired value by changing the convergence angle as appropriate.

The above is a description of exemplary embodiments of the present invention. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

In the embodiments described above, the light guide included in the virtual image display device has been described. However, no limitation is intended therein. Hereinafter, a light guide according to another embodiment is described.

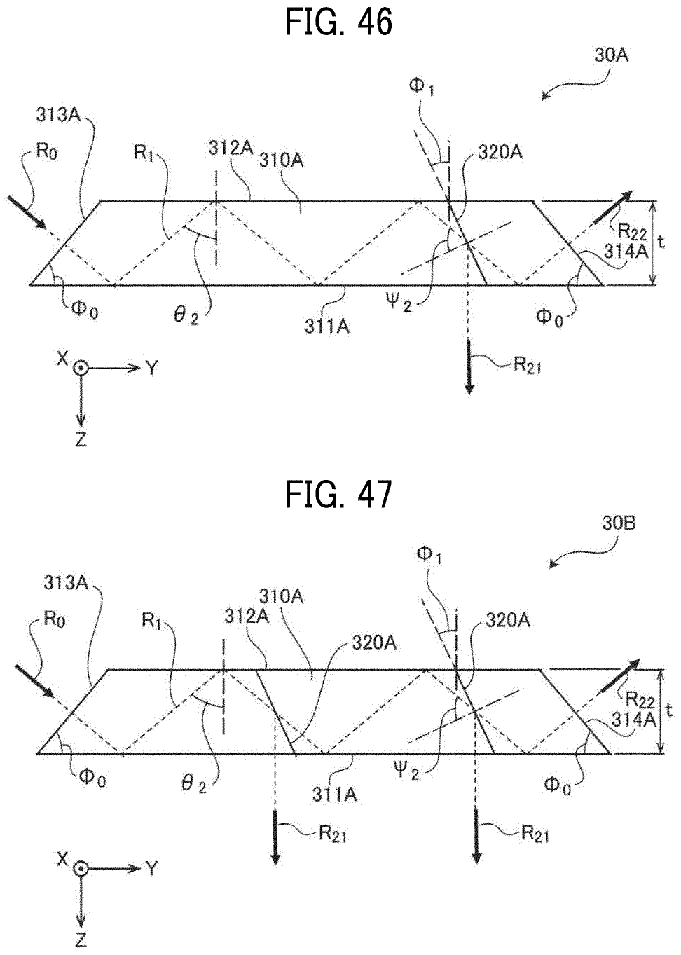

FIG. 46 is an illustration of a configuration of a light guide 30A according to a modification of the first embodiment.

In this embodiment, the light guide 30A is an optical branching element. As illustrated in FIG. 46, the light guide 30A includes a light guide board 310A and a partial reflection layer 320A. As illustrated in FIG. 46, the light guide 30A includes a light guide board 310A and a partial reflection layer 320A.

The light guide board 310A has a first edge face 313A (−Y-side edge of the light guide board 310) connects the first surface 311A and the second surface 312A at the −Y-side of the light guide board 310. The first edge face 313A and the first surface 311A form an angle (Do. The light guide board 310A has a second edge face 314A (+Y-side edge of the light guide board 310) connects the first surface 311A and the second surface 312A at the +Y-side of the light guide board 310. The first edge face 313A and the first surface 311A form an angle Do. In such a configuration, the light guide board 310A forms a symmetrical trapezoidal shape in a plan view.

The light guide board 310A has a refractive index n₁ of 1.642 and a thickness t of 2.5 mm. The first surface 311A and the first edge face 313A (or the first surface 311A and the second edge face 314A) form an angle Φ₀ of 41.5°. The partial reflection layer 320A and the normal to each of the first surface 311A and the second surface 312A form an angle Φ₁ of 24.25°. The partial reflection layer 320A has a refractive index n₂ of 1.457. The partial reflection layer 320A has a thickness of 0.1 μm.

In this modification of the first embodiment, external light (light having a center wavelength λ of 550 nm) perpendicularly enters the first edge face 313A at an incident angle of 0°. The light ray R₁ entered into the light guide board 310A through the first edge face 313A is incident on each of the first surface 311A and the second surface 312A at an incident angle θ₂ of 48.5°, which is greater than the critical angle of 37.52°. In such a configuration, the light ray R₁ is guided through the light guide board 310A in the +Y-direction while repeatedly totally reflecting off each of the first surface 311A and the second surface 312A.

The light ray R₁ is incident on the partial reflection layer 320A at an incident angle Ψ₂. The angle of incidence Ψ₂ is 65.75°, which is greater than or equal to the critical angle θᵣ at the partial reflection layer 320A. Specifically, a part of evanescent light entering the partial reflection layer 320 among the light ray R₁ passes through the partial reflection layer 320, and the remainder reflects off the partial reflection layer 320A. In other words, the partial reflection layer 320A separates the light ray R₁ into reflected light and transmitted light. The light ray R₂₁ reflected by the partial reflection layer 320A exits the first surface 311A in a direction perpendicular to the first surface 311A. A light ray R₂₂ in FIG. 46 transmitted through the partial reflection layer 320A exits the second edge face 314A in a direction perpendicular to the first surface 311A after reflecting off the first surface 311A.

The reflectance of the light ray R₁ incident on the partial reflection layer 320A at the incident angle Ψ₂ is 0.16 (16%) when the light ray R₁ is P-polarized light, 0.20 (20%) when the light ray R₁ is S-polarized light, and 0.18 (18%) when the light ray R₁ is combined light in which S-polarized light and P-polarized light are uniformly combined.

The modification of the first embodiment uses an optical branching element as the light guide 30A, to separate a single light into multiple light rays.

FIG. 47 is an illustration of the configuration of a light guide 30B according to a modification of the second embodiment. In this embodiment, a light guide 30B is an optical branching element. As illustrated in FIG. 47, the light guide 30B has the same configuration as that of the light guide 30A in FIG. 46 except that the light guide 30B includes two partial reflection layers 320A.

In the modification of the second embodiment, three light rays in total are separated by adding an additional partial reflection layer 320A to the modification of the first embodiment. With a further increase in the number of partial reflection layers 320A, the number of light rays to be separated further increases. By appropriately setting the number of the partial reflection layers 320A, for example, externally incident light may be separated into a desired number of light rays.

In Aspect 1, a light guide includes: a light guide board configured to allow light incident on an optical entrance to propagate through the light guide board, the light guide board including: the optical entrance; a first face; and at least one partial reflection layer within the light guide board and tilted to the first face. The at least one partial reflection layer is configured to reflect a part of light incident on the at least one partial reflection layer at an incident angle of greater than or equal to a critical angle θᵣ to allow the reflected light to exit the light guide board through the first surface while transmitting therethrough a remainder of the light incident on the at least one partial reflection layer. Formula below is satisfied:

θᵣ=sin⁻¹(n₂/n₁) (1)

where

n₁ is a refractive index of the light guide board; and

n₂ is a refractive index of the at least one partial reflection layer.

According to Aspect 2, in the light guide according to Aspect 1, formula below is satisfied:

$$\frac{log ( F ( 0.02 ) + \sqrt{{F ( 0.02 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \leq h \leq \frac{log ( F ( 0.9 ) + \sqrt{{F ( 0.9 )}^{2} - 1} )}{( \frac{4 π}{λ} ) \sqrt{{( {n}_{1} )}^{2} {( sin ( {θ}_{c} ) )}^{2} - {( {n}_{2} )}^{2}}}$$

$$where$$

$$F ( R ) = 0.5 * ( \frac{( cos ( Φ {n}_{12} - Φ {n}_{23} ) - R \cdot cos ( Φ {n}_{12} + Φ {n}_{23} ) )}{( R - 1 )} + \frac{( cos ( Φ {h}_{12} - Φ {h}_{23} ) - R \cdot cos ( Φ {h}_{12} + Φ {h}_{23} ) )}{( R - 1 )} )$$

$$Φ {n}_{12} = - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {n}_{23} = π - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$

$$Φ {h}_{12} = - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

$$Φ {h}_{23} = π - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$

θ_{c} is an incident angle of the light incident on the at least one partial reflection layer when the part of the light reflects off the at least one partial reflection layer in a direction normal to the first surface to exit the light guide board, the incident angle θ_{c} being greater than or equal to the critical angle θᵣ;

R is a reflectance of the light incident on the at least one partial reflection layer at the incident angle θ_{c} on the at least one partial reflection layer, the reflectance being normalized by values of 0 to 1;

λ (m) is a center wavelength of the light incident on the at least one partial reflection layer at the incident angle θ_{c}; and

h (m) is a thickness of the partial reflection layer.

According to Aspect 3, in the light guide according to Aspect 1, the at least one partial reflection layer includes multiple partial reflection layers parallel to each other.

According to Aspect 4, in the light guide according to Aspect 3, the multiple partial reflection layers include: a first partial reflection layer; and a second partial reflection layer closer to the optical entrance than the first partial reflection layer and having a thickness smaller than a thickness of the first partial reflection layer.

According to Aspect 5, in the light guide according to Aspect 3, the light guide board further includes a second surface parallel to the first surface. Each of the multiple partial reflection layers reflects the light incident on a corresponding partial reflection layer of the multiple partial reflection layers, at an angle of ±θ₃ₘₐₓ with reference to a normal to the first surface within a plane perpendicular to each of the first surface and the multiple partial reflection layers. Formula below is satisfied:

$$d \leq t ( tan ( {Φ}_{1} ) - tan ( {sin}^{- 1} ( \frac{1}{{n}_{1}} sin {θ}_{3 max} ) ) )$$

where

d is a distance between adjacent partial reflection layers of the multiple partial reflection layers in a direction parallel to the first surface within the plane;

Φ₁ is an angle between a normal to the first surface and each of the multiple partial reflection layers within the plane; and

t is a distance between the first surface and the second surface.

According to Aspect 6, in the light guide according to Aspect 1, the at least one partial reflection layer has a thickness of less than or equal to a center wavelength of the light incident on the at least one partial reflection layer.

According to Aspect 7, in the light guide according to Aspect 1, the light guide board further includes a certain layer on or over the at least one partial reflection layer. The certain layer includes an adhesive layer or a primer layer. Formula below is satisfied:

|n₃−n₁|<0.015 (5)

where

n₃ is a refractive index of the certain layer.

According to Aspect 8, in the light guide according to Aspect 7, the certain layer has a thickness of 10 μm or less.

According to Aspect 9, in the light guide according to Aspect 1, light rays exiting the light guide board through the first surface have undergone entering the at least one partial reflection layer at an angle greater than the critical angle θᵣ and reflection thereon.

According to Aspect 10, in the light guide according to Aspect 1, the light guide board is composed of synthetic resin.

According to Aspect 11, in the light guide according to Aspect 1, the light guide board further includes: a third surface adjacent to the optical entrance; and an external mirror having a reflecting surface parallel to the third surface. The light incident on the optical entrance strikes the third surface and reflects off the external mirror to propagate through the light guide board.

According to Aspect 12, in the light guide according to Aspect 1, the light guide board further includes a reflector to reflect the light incident on the optical entrance to allow the light reflected by the reflector to propagate through the light guide board.

According to Aspect 13, in the light guide according to Aspect 1, light rays exiting from positions on the first surface of the light guide board to reach the eyes of an observer include: a first light ray exiting from a position closest to the optical entrance among the positions on the first surface to reach the eyes; and a second light ray exiting from a position farthest from the optical entrance among the positions on the first surface to reach the eyes. A first angle between the first light ray and a normal to the first surface differs from a second angle between the second light ray and the normal to the first surface.

According to Aspect 14, in the light guide according to Aspect 13, the first angle is greater than the second angle.

According to Aspect 15, in the light guide according to Aspect 1, the light guide board further includes a shield in vicinity of the optical entrance, the shield being configured to block a part of the light incident on the optical entrance from entering the light guide board.

According to Aspect 16, in the light guide according to Aspect 1, the at least one partial reflection layer includes at least one first partial reflection layer and at least one second partial reflection layer not parallel to the at least one first partial reflection layer. The at least one second partial reflection layer reflects a part of light incident thereon at an incident angle of greater than or equal to a critical angle (θᵣ₂) to allow the part of the light to be incident on the at least one first partial reflection layer, while transmitting a remainder of the light therethrough. Formula below is satisfied:

θᵣ=sin⁻¹(n₄/n₁) (1)

where

n₄ is a refractive index of the at least one second partial reflection layer.

According to Aspect 17, in the light guide according to Aspect 16, formula below is satisfied:

$$\frac{log ( F ( 0.001 ) + \sqrt{{F ( 0.001 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \leq h \leq \frac{log ( F ( 0.99 ) + \sqrt{{F ( 0.99 )}^{2} - 1} )}{( \frac{4 π}{λ} ) \sqrt{{( {n}_{1} )}^{2} {( sin ( {θ}_{c} ) )}^{2} - {( {n}_{2} )}^{2}}}$$

$$where$$

$$F ( R ) = 0.5 * ( \frac{( cos ( \text{?} ) - R \cdot cos ( \text{?} ) )}{( R - 1 )} + \frac{( cos ( \text{?} ) - R \cdot cos ( \text{?} ) )}{( R - 1 )} )$$

$$Φ {n}_{12} = - 2 \cdot arctan ( \frac{\sqrt{\text{?} \cdot ( sin ( θ \text{?} ) ) \text{?}}}{\text{?} \cdot cos \text{?}} )$$

$$Φ {n}_{23} = π - 2 \cdot arctan ( \frac{\sqrt{\text{?} \cdot ( sin ( θ \text{?} ) ) \text{?}}}{\text{?} \cdot cos \text{?}} )$$

$$Φ {h}_{12} = - 2 \cdot arctan ( \frac{\text{?} \sqrt{\text{?}}}{\text{?} \cdot cos \text{?}} )$$

$$Φ {h}_{23} = π - 2 \cdot arctan ( \frac{\text{?} \sqrt{\text{?} \cdot ( sin ( θ \text{?} ) ) \text{?}}}{\text{?} \cdot cos \text{?}} )$$

$$\text{?} \text{indicates text missing or illegible when filed}$$

θ_{c} is an incident angle of light incident on the at least one first partial reflection layer when a part of the light reflects off the at least one first partial reflection layer in a direction normal to the first surface to exit the light guide board, the incident angle θ_{c} being greater than or equal to the critical angle θᵣ;

R is a reflectance of the light incident on the at least one first partial reflection layer at the incident angle θ_{c} on the at least one first partial reflection layer, the reflectance being normalized by values of 0 to 1;

λ (m) is a center wavelength of the light incident on the at least one first partial reflection layer at the incident angle θ_{c}; and

h (m) is a thickness of the at least one first partial reflection layer.

According to Aspect 18, in the light guide according to Aspect 16, the light guide board further includes a second surface facing the first surface. A distance between the first surface and the second surface differs between a first region including the at least one first partial reflection layer and a second region including the at least one second partial reflection layer. A step is at an interface between the first region and the second region on at least one of the first surface and the second surface.

According to Aspect 19, in the light guide according to Aspect 1, the light guide board includes at least two light guide boards arranged in a direction perpendicular to the first surface. Each of the at least two light guide boards includes a reflector including a wavelength selective filter, the reflector configured to selectively reflect the light incident on optical entrance to allow each of the at least two light guide boards to guide light rays having a wavelength different from a wavelength of a remainder of the light incident on optical entrance.

According to Aspect 20, in the light guide of Aspect 19, light rays reflected by a reflecting surface in a light guide board into which light from an outside of the light guide first enters has a wavelength shorter than a wavelength of light reflected by another reflecting surface in another light guide board.

According to Aspect 21, a virtual image display device includes the light guide according to Aspect 1; an image display element configured to display an image; and an optical system configured to propagate light containing information on the image from the image display element to the light guide.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A light guide comprising:
a light guide board configured to allow light incident on an optical entrance to propagate through the light guide board, the light guide board including:
the optical entrance;
a first face; and
at least one partial reflection layer within the light guide board and tilted to the first face, the at least one partial reflection layer is configured to reflect a part of light incident on the at least one partial reflection layer at an incident angle of greater than or equal to a critical angle θᵣ to allow the reflected light to exit the light guide board through the first surface while transmitting therethrough a remainder of the light incident on the at least one partial reflection layer,
wherein formula below is satisfied:
θᵣ=sin⁻¹(n₂/n₁)
where
n₁ is a refractive index of the light guide board; and
n₂ is a refractive index of the at least one partial reflection layer.

2. The light guide according to claim 1,
wherein formula below is satisfied:
$$\frac{log ( F ( 0.02 ) + \sqrt{{F ( 0.02 )}^{2} - 1} )}{( \frac{4 π}{λ} ) \sqrt{{( {n}_{1} )}^{2} {( sin ( {θ}_{c} ) )}^{2} - {( {n}_{2} )}^{2}}} \leq h \leq \frac{log ( F ( 0.9 ) + \sqrt{{F ( 0.9 )}^{2} - 1} )}{( \frac{4 π}{λ} ) \sqrt{{( {n}_{1} )}^{2} {( sin ( {θ}_{c} ) )}^{2} - {( {n}_{2} )}^{2}}}$$
$$where$$
$$F ( R ) = 0.5 * ( \frac{( cos ( Φ {n}_{12} - Φ {n}_{23} ) - R \cdot cos ( Φ {n}_{12} + Φ {n}_{23} ) )}{( R - 1 )} + \frac{( cos ( Φ {h}_{12} - Φ {h}_{23} ) - R \cdot cos ( Φ {h}_{12} + Φ {h}_{23} ) )}{( R - 1 )} )$$
$$Φ {n}_{12} = - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$
$$Φ {n}_{23} = π - 2 \cdot arctan ( \frac{\sqrt{{( {n}_{1} )}^{2} \cdot {( sin ( {θ}_{c} ) )}^{2} - {( {n}_{2} )}^{2}}}{{n}_{1} \cdot cos ( {θ}_{c} )} )$$
$$Φ {h}_{12} = - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$
$$Φ {h}_{23} = π - 2 \cdot arctan ( \frac{{n}_{1} \sqrt{{( {n}_{1} )}^{2} \cdot {( sin ( {θ}_{c} ) )}^{2} - {( {n}_{2} )}^{2}}}{{( {n}_{2} )}^{2} \cdot cos ( {θ}_{c} )} )$$
θ_{c} is an incident angle of the light incident on the at least one partial reflection layer when the part of the light reflects off the at least one partial reflection layer in a direction normal to the first surface to exit the light guide board, the incident angle θ_{c} being greater than or equal to the critical angle θᵣ;
R is a reflectance of the light incident on the at least one partial reflection layer at the incident angle θ_{c} on the at least one partial reflection layer, the reflectance being normalized by values of 0 to 1;
λ (m) is a center wavelength of the light incident on the at least one partial reflection layer at the incident angle θ_{c}; and
h (m) is a thickness of the at least one partial reflection layer.

3. The light guide according to claim 1,
wherein the at least one partial reflection layer includes multiple partial reflection layers parallel to each other.

4. The light guide according to claim 3,
wherein the multiple partial reflection layers include:
a first partial reflection layer; and
a second partial reflection layer closer to the optical entrance than the first partial reflection layer and having a thickness smaller than a thickness of the first partial reflection layer.

5. The light guide according to claim 3,
wherein the light guide board further includes a second surface parallel to the first surface, and
wherein each of the multiple partial reflection layers reflects the light incident on a corresponding partial reflection layer of the multiple partial reflection layers, at an angle of ±θ₃ₘₐₓ with reference to a normal to the first surface within a plane perpendicular to each of the first surface and the multiple partial reflection layers
wherein formula below is satisfied:
$$d \leq t ( tan ( Φ \text{?} ) - tan ( {sin}^{- 1} ( \text{?} sin {θ}_{3 max} ) ) )$$
$$\text{?} \text{indicates text missing or illegible when filed}$$
where
d is a distance between adjacent partial reflection layers of the multiple partial reflection layers in a direction parallel to a normal to the first surface within the plane;
Φ₁ is an angle between a normal to the first surface and each of the multiple partial reflection layers within the plane; and
t is a distance between the first surface and the second surface.

6. The light guide according to claim 1,
wherein the at least one partial reflection layer has a thickness of less than or equal to a center wavelength of the light incident on the at least one partial reflection layer.

7. The light guide according to claim 1,
wherein the light guide board further includes a certain layer on or over the at least one partial reflection layer,
wherein the certain layer includes an adhesive layer or a primer layer, and
wherein formula below is satisfied:

|n₃−n₁|<0.015
where
n₃ is a refractive index of the certain layer.

8. The light guide according to claim 7,
wherein the certain layer has a thickness of 10 μm or less.

9. The light guide according to claim 1,
wherein light rays exiting the light guide board through the first surface have undergone entering the at least one partial reflection layer at an angle greater than the critical angle θᵣ and reflection thereon.

10. The light guide according to claim 1,
wherein the light guide board is composed of synthetic resin.

11. The light guide according to claim 1,
wherein the light guide board further includes:
a third surface adjacent to the optical entrance, and
an external mirror having a reflecting surface parallel to the third surface,
wherein the light incident on the optical entrance strikes the third surface and reflects off the external mirror to propagate through the light guide board.

12. The light guide according to claim 1,
wherein the light guide board further includes a reflector to reflect the light incident on the optical entrance to allow the light reflected by the reflector to propagate through the light guide board.

13. The light guide according to claim 1,
wherein light rays exiting from positions on the first surface of the light guide board to reach the eyes of an observer include:
a first light ray exiting from a position closest to the optical entrance among the positions on the first surface to reach the eyes; and
a second light ray exiting from a position farthest from the optical entrance among the positions on the first surface to reach the eyes,
wherein a first angle between the first light ray and a normal to the first surface differs from a second angle between the second light ray and the normal to the first surface.

14. The light guide according to claim 13,
wherein the first angle is greater than the second angle.

15. The light guide according to claim 1,
wherein the light guide board further includes a shield in vicinity of the optical entrance, the shield being configured to block a part of the light incident on the optical entrance from entering the light guide board.

16. The light guide according to claim 1,
wherein the at least one partial reflection layer includes at least one first partial reflection layer and at least one second partial reflection layer not parallel to the at least one first partial reflection layer,
wherein the at least one second partial reflection layer reflects a part of light incident thereon at an incident angle of greater than or equal to a critical angle θᵣ₂ to allow the part of the light to be incident on the at least one first partial reflection layer while transmitting a remainder of the light therethrough,
wherein formula below is satisfied:
θᵣ₂=sin⁻¹(n₄/n₁)
where
n₄ is a refractive index of the at least one second partial reflection layer.

17. The light guide according to claim 16,
wherein formula below is satisfied:
$$\frac{log ( F ( 0.001 ) + \sqrt{{F ( 0.001 )}^{2} - 1} )}{( \frac{4 π}{λ} ) \sqrt{{( {n}_{1} )}^{2} ( sin ( θ \text{?} - {( {n}_{2} )}^{2}}} \leq h \leq \frac{log ( F ( 0.99 ) + \sqrt{{F ( 0.99 )}^{2} - 1} )}{( \frac{4 π}{λ} ) \sqrt{{( {n}_{1} )}^{2} ( sin ( θ \text{?} - {( {n}_{2} )}^{2}}}$$
$$where$$
$$F ( R ) = 0.5 * ( \frac{( cos ( \text{?} ) - R \cdot cos ( \text{?} ) )}{( R - 1 )} + \frac{( cos ( \text{?} ) - R \cdot cos ( \text{?} ) )}{( R - 1 )} )$$
$$Φ {n}_{12} = - 2 \cdot arctan ( \frac{\sqrt{\text{?} \cdot ( sin ( θ \text{?} ) ) \text{?}}}{\text{?} \cdot cos \text{?}} )$$
$$Φ {n}_{23} = π - 2 \cdot arctan ( \frac{\sqrt{\text{?} \cdot ( sin ( θ \text{?} ) ) \text{?}}}{\text{?} \cdot cos \text{?}} )$$
$$Φ {h}_{12} = - 2 \cdot arctan ( \frac{\text{?} \sqrt{\text{?} \cdot ( sin ( θ \text{?} ) ) \text{?}}}{\text{?} \cdot cos \text{?}} )$$
$$Φ {h}_{23} = π - 2 \cdot arctan ( \frac{\text{?} \sqrt{\text{?} \cdot ( sin ( θ \text{?} ) ) \text{?}}}{\text{?} \cdot cos \text{?}} )$$
$$\text{?} \text{indicates text missing or illegible when filed}$$
θ_{c} is an incident angle of light incident on the at least one first partial reflection layer when a part of the light reflects off the at least one first partial reflection layer in a direction normal to the first surface to exit the light guide board, the incident angle θ_{c} being greater than or equal to the critical angle θᵣ;
R is a reflectance of the light incident on the at least one first partial reflection layer at the incident angle θ_{c} on the at least one first partial reflection layer, the reflectance being normalized by values of 0 to 1;
λ (m) is a center wavelength of the light incident on the at least one first partial reflection layer at the incident angle θ_{c}; and
h (m) is a thickness of the at least one first partial reflection layer.

18. The light guide according to claim 16,
wherein the light guide board further includes a second surface facing the first surface,
wherein a distance between the first surface and the second surface differs between a first region including the at least one first partial reflection layer and a second region including the at least one second partial reflection layer, and
wherein a step is at an interface between the first region and the second region on at least one of the first surface and the second surface.

19. The light guide according to claim 1,
wherein the light guide board includes at least two light guide boards arranged in a direction perpendicular to the first surface,
wherein each of the at least two light guide boards includes a reflector including a wavelength selective filter, the reflector configured to selectively reflect the light incident on optical entrance to allow each of the at least two light guide boards to guide light rays having a wavelength different from a wavelength of a remainder of the light incident on optical entrance.

20. A virtual image display device comprising:
the light guide according to claim 1;
an image display element configured to display an image; and
an optical system configured to propagate light containing information on the image from the image display element to the light guide.
